(19) United States
(12) Patent Application Publication
(10) Pub. No.: US 2015/0224959 A1
(43) Pub. Date: Aug. 13, 2015

(54) SEAT BELT RETRACTOR

(71) Applicant: ASHIMORI INDUSTRY CO., LTD., Osaka (JP)

(72) Inventors: Satoshi SUMINAKA, Settsu-shi (JP); Takayoshi IJIRI, Settsu-shi (JP)

(73) Assignee: ASHIMORI INDUSTRY CO., LTD., Osaka (JP)

(21) Appl. No.: 14/616,861

(22) Filed: Feb. 9, 2015

(30) Foreign Application Priority Data
Feb. 10, 2014 (JP) 2014-023573

(51) Int. Cl. B60R 22/405

(52) U.S. Cl. CPC B60R 22/405; B60R 2022/468

(57) ABSTRACT

Problems to be Solved

A control member controlling a state of a retractor is rotated by correctly interlocking with rotation of a winding drum, with the use of an eccentric member rotating eccentrically together with the winding drum.

Solution

A rotational gear 82 rotates at a decelerated speed than that of a winding drum 10 by rotation of an eccentric member 81. A transmission mechanism 85 includes a plurality of transmission round holes 86 and a plurality of transmission protrusions 87 and transmits rotation of the rotational gear 82 to a control member 70. The plurality of transmission round holes 86 is formed in one of the rotational gear 82 and the control member 70 with 180 degrees or less intervals. The plurality of transmission protrusions 87 is formed on the other of the rotational gear 82 and the control member 70 with 180 degrees or less intervals, and respectively moves in the transmission round hole 86 when the rotational gear 82 rotates. An inner circumference of the transmission round hole 86 and an outer circumference of the transmission protrusion 87 come into contact with each other to thereby transmit the rotation of the rotational gear 82 to the control member 70.

### BACKGROUND OF THE INVENTION

1. Field of the Invention

The present invention relates to a seat belt retractor capable of winding a webbing of a seat belt on a rotatable winding drum.

2. Related Background of the Invention

A seat belt device including a retractor is generally mounted in a vehicle such a car in order to protect an occupant seated on a seat. The occupant wears a webbing (seat belt) drawn out from a winding drum of the retractor and is restrained on the seat with the use of the webbing when the vehicle encounters an emergency (e.g., at the time of crash). At this time, the retractor detects an acceleration of the vehicle or an acceleration of drawing-out of the webbing and a locking mechanism stops rotation of the winding drum in a drawing-out direction. With this mechanism, the drawing-out of the webbing is stopped and thus the occupant is restrained with the use of the webbing. As to the seat belt retractor, conventionally, a retractor (seat-belt device) switching a state of the locking mechanism (drawing-out stopping mechanism) by a control member (cam ring) that rotates by interlocking with the winding drum is known (refer to Patent Literature 1).

According to the conventional retractor described in the Patent Literature 1, a control wheel rotates at a decelerated speed than that of the winding drum while rolling in a state where a rotational center of the control wheel is eccentric with respect to an axis of the winding drum, by an eccentric member (eccentric disk) rotating together with the winding drum. The control wheel includes a rectangular drive hole, and the control member includes a drive pin arranged in the drive hole. By rolling and rotation of the control wheel, the drive pin moves in a radial direction of the control wheel in the drive hole, and at the same time, the control wheel moves the drive pin in a rotational direction. By the moving drive pin, the control member rotates about the axis of the winding drum by interlocking with the winding drum. The locking mechanism is switched between an operation state and a waiting state by the rotating control member, and thus a state of the retractor is switched. When the locking mechanism is switched to the operation state, the state of the retractor is switched to an automatic locking retractor (ALR) state in which only winding of the webbing is possible. When the locking mechanism is switched to the waiting state, the state of the retractor is switched to an emergency locking retractor (ELR) state in which the locking mechanism is operated when the vehicle encounters an emergency.

As described above, according to the conventional retractor, the control member rotated by the control wheel switches the state of the locking mechanism, to thereby control the state of the retractor. However, since the control wheel and the control member rotate in a state where their axes are out of alignment with each other, the drive pin of the control member moves in the radial direction of the control wheel in the drive hole during the rotation of the control wheel and the control member. For the movement of the drive pin, the drive hole is formed in a rectangular shape so that the drive pin can move in the radial direction of the control wheel. However, since the drive pin cannot move in a circumferential direction of the control wheel in the drive hole, corresponding to a position of the drive hole displaced in a complicated manner due to the rotation and the rolling of the control wheel, the drive pin is displaced in the circumferential direction of the control wheel. As a result, the rotation of the control member does not correctly interlock with the rotation of the winding drum, and thus the control member is likely to rotate irregularly. Furthermore, the control member does not control the state of the retractor in a stable manner, and thus it is difficult to correctly switch the state of the retractor.

Here, a retractor (webbing winding device) that rotates the control member (first cam plate) by interlocking with the rotation of the winding drum (spool) without using the eccentric member to thereby control the state of the retractor by the control member is also known (refer to Patent Literature 2). According to the conventional retractor described in the Patent Literature 2, a pinion rotates together with the winding drum and a large-diameter gear of a two-stage gear is rotated by the pinion. Moreover, an inner circumferential gear of the control member is rotated by a small-diameter gear of the two-stage gear, and the control member rotates at a decelerated speed than that of the winding drum. By the rotating control member, the state of the retractor is switched between an emergency locking retractor state in which the locking mechanism is operated by an acceleration detection mechanism and a blocking state in which an operation of the locking mechanism by the acceleration detection mechanism is blocked.

According to the conventional retractor, the acceleration detection mechanism includes a V sensor for detecting an acceleration of the vehicle to thereby operate the locking mechanism and a W sensor for detecting an acceleration of the drawing-out of the webbing to thereby operate the locking mechanism. When an entire amount of the webbing is wound on the winding drum, the state of the retractor is switched to the blocking state to thereby block the operation of the locking mechanism. However, according to the conventional retractor, the control member is rotated at a decelerated speed than that of the winding drum by a deceleration mechanism including only a plurality of gears, and thus the structure of the deceleration mechanism is complicated in comparison with the retractor using the eccentric member. Furthermore, each gear needs to be formed with high accuracy in order to correctly mesh the plurality of gears with each other. Additionally, it is difficult to thin the plurality of gears in order to securely mesh the plurality of gears with each other or to secure strength of each gear, and thus the deceleration mechanism tends to be thick.

### PRIOR ART

### Patent Literatures

Patent Literature 1: Japanese Patent Application Laid-Open No. 2001-213275

Patent Literature 2: Japanese Patent Application Laid-Open No. 2004-90672

### SUMMARY OF THE INVENTION

### Problems to be Solved by Invention

The present invention has been made in view of the above described, conventional problems, and an object thereof is to rotate a control member controlling a state of a retractor by correctly interlocking with rotation of a winding drum, with the use of an eccentric member rotating together with the winding drum of the retractor.

### Means of Solving Problems

The present invention is a seat belt retractor including a winding drum configured to wind a webbing; a support body configured to rotatably support the winding drum in a winding direction and a drawing-out direction of the webbing; a control member configured to rotate relative to the winding drum about an axis of the winding drum; and a deceleration mechanism configured to transmit rotation of the winding drum to the control member so as to rotate the control member at a decelerated speed than that of the winding drum. The deceleration mechanism includes an eccentric member configured to rotate eccentrically together with the winding drum; a plurality of fixed teeth arranged in a circular shape concentric with the axis of the winding drum and fixed to the support body; a rotational gear provided inside of the plurality of fixed teeth and configured to rotate at a decelerated speed than that of the winding drum by the eccentric member and the plurality of fixed teeth; and a transmission mechanism configured to transmit rotation of the rotational gear to the control member. The rotational gear includes outer circumferential teeth having a smaller number of teeth than that of the plurality of fixed teeth, and is rotatably supported by the eccentric member in a state where a rotational center of the rotational gear is eccentric with respect to the axis of the winding drum, and sequentially meshes with each of the fixed teeth and rotates, while being moved along the plurality of fixed teeth by rotation of the eccentric member. The transmission mechanism includes a plurality of transmission round holes formed in one of the rotational gear and the control member with 180 degrees or less intervals in a circumferential direction thereof, and a plurality of transmission protrusions in a post-like shape formed on the other of the rotational gear and the control member with 180 degrees or less intervals in a circumferential direction thereof, and respectively moving in the transmission round hole when the rotational gear rotates. An inner circumference of the transmission round hole and an outer circumference of the transmission protrusion come into contact with each other to transmit the rotation of the rotational gear to the control member.

### Advantages of Invention

According to the present invention, the control member controlling the state of the retractor can be rotated by correctly interlocking with the rotation of the winding drum with the use of the eccentric member rotating together with the winding drum of the retractor.

### BRIEF DESCRIPTION OF THE DRAWINGS

FIG. 1 is a perspective view of a seat belt retractor of a first embodiment.

FIG. 2 is a perspective view of the seat belt retractor that is exploded.

FIG. 3 is a perspective view of the seat belt retractor that is exploded.

FIG. 4 is a perspective view of the seat belt retractor that is completely exploded.

FIG. 5 is a perspective view of a housing unit that is exploded.

FIG. 6 is a side view schematically illustrating a movable pawl and a ratchet gear.

FIG. 7 is a perspective view of a winding drum unit that is exploded.

FIG. 8 is a cross-sectional view of the winding drum unit.

FIG. 9 is a cross-sectional view of the winding drum unit taken along a line X1-X1 illustrated in FIG. 8, viewed in an arrow direction.

FIG. 10 is a cross-sectional view illustrating an inner configuration of a pretensioner unit.

FIG. 11 is a side view of the seat belt retractor viewed in an arrow W3 direction illustrated in FIG. 1.

FIG. 12 is a cross-sectional view of the seat belt retractor taken along a line X2-X2 illustrated in FIG. 11, viewed in an arrow direction.

FIG. 13 is a perspective view of a mechanism cover unit and a winding spring unit that are exploded.

FIG. 14 is a perspective view of the mechanism cover unit and the winding spring unit that are exploded.

FIG. 15 is a perspective view of a locking gear and a locking arm.

FIG. 16 is a cross-sectional view of the mechanism cover unit.

FIGS. 17A and 17B are perspective views of a clutch.

FIGS. 18A and 18B illustrate actions of a locking mechanism.

FIGS. 19A and 19B illustrate actions of the locking mechanism.

FIG. 20 is a perspective view of a meshing pawl.

FIGS. 21A and 21B schematically illustrate a periphery of the meshing pawl.

FIGS. 22A and 22B illustrate actions of the locking mechanism.

FIG. 23 is a perspective view of an eccentric member, a rotational gear, and a control member.

FIG. 24 is a side view of the mechanism cover unit.

FIG. 25 illustrates a pair of transmission round hole and transmission protrusion.

FIGS. 26A and 26B illustrate relationships between the rotational gear and a transmission mechanism.

FIGS. 27A and 27B illustrate actions of a deceleration mechanism.

FIG. 28 is a perspective view of an operation member, an arrangement member, and urging means.

FIGS. 29A to 29C are perspective views of the mechanism cover unit.

FIG. 30 is a side view of the mechanism cover unit.

FIGS. 31A and 31B are cross-sectional views of a Y1 portion illustrated in FIG. 30.

FIGS. 32A to 32C illustrate actions of a switch mechanism by rotation of a control member.

FIGS. 33A and 33B illustrate actions of the switch mechanism by the rotation of the control member.

FIGS. 34A and 34B illustrate actions of the switch mechanism by the rotation of the control member.

FIGS. 35A and 35B illustrate modifications of the transmission mechanism.

FIGS. 36A and 36B illustrate modifications of the transmission mechanism.

FIGS. 37A and 37B illustrate modifications of the transmission mechanism.

FIGS. 38A and 38B illustrate modifications of the transmission mechanism.

FIGS. 39A and 39B illustrate modifications of the transmission mechanism.

FIGS. 40A and 40B illustrate comparison examples of the transmission mechanism.

FIGS. 41A and 41B illustrate comparison examples of the transmission mechanism.

FIGS. 42A and 42B illustrate comparison examples of the transmission mechanism.

FIGS. 43A and 43B illustrate comparison examples of the transmission mechanism.

FIGS. 44A and 44B illustrate an acceleration sensor provided in a seat belt retractor of a second embodiment.

FIG. 45 is a perspective view of a sensor lever of the acceleration sensor.

FIGS. 46A and 46B are side views of the mechanism cover unit.

FIGS. 47A and 47B are side views of the mechanism cover unit.

### DESCRIPTION OF THE PREFERRED EMBODIMENTS

With reference to drawings, an embodiment of a seat belt retractor (hereinafter, referred to as a retractor) according to the present invention will be described.

The retractor of the present embodiment is a webbing winding device for winding a webbing of a seat belt and is provided in a seat belt device for a vehicle. The seat belt device including the retractor is mounted in the vehicle and protects an occupant seated on a seat with the webbing (seat belt).

### First Embodiment

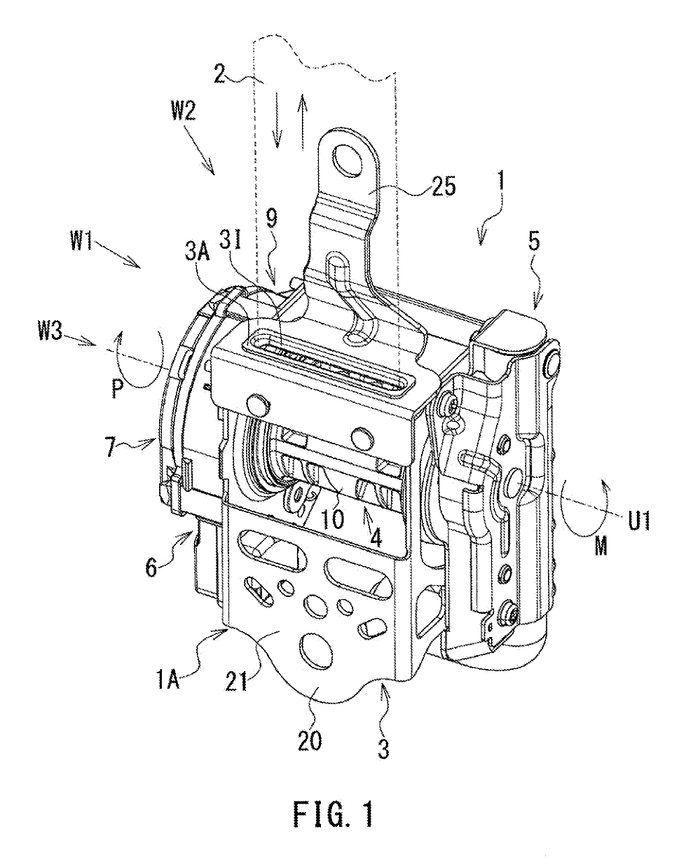

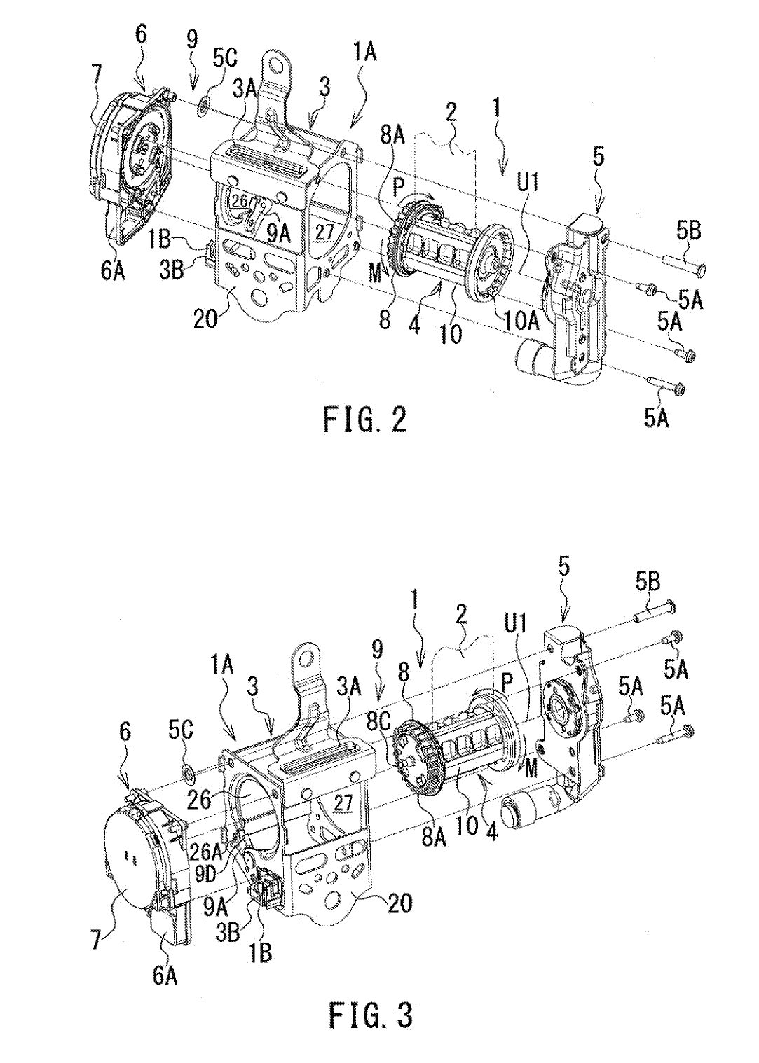

FIG. 1 is a perspective view of a retractor 1 of the first embodiment. FIGS. 2 and 3 are perspective views of the retractor 1 that is exploded into a plurality of units, and illustrate the retractor 1 viewed in the different directions from each other. FIG. 2 illustrates the retractor 1 viewed in the same direction as that illustrated in FIG. 1, and FIG. 3 illustrates the retractor 1 viewed in a W1 direction illustrated in FIG. 1. FIGS. 1 to 3 show, by dotted lines, a webbing 2 in a band-like shape.

As illustrated in FIGS. 1 to 3, the retractor 1 includes a housing unit 3, a winding drum unit 4 including a winding drum 10, a pretensioner unit 5, a mechanism cover unit 6, and a winding spring unit 7. An end portion of the webbing 2 is mounted to the winding drum 10 and the webbing 2 is wound on an outer circumference of the winding drum 10. The winding drum 10 is formed of aluminum alloy and the like.

In a state where the winding drum 10 is arranged in the housing unit 3, the pretensioner unit 5 and the mechanism cover unit 6 are arranged outside of the winding drum 10 in a drum shaft direction, and fixed onto a side face of the housing unit 3. The drum shaft direction is a direction of an axis U1 of the winding drum 10, and the outside in the drum shaft direction is the outside with reference to the winding drum 10 in the drum shaft direction. The pretensioner unit 5 and the mechanism cover unit 6 cover both end portions of the winding drum unit 4 in the drum shaft direction on the outside of the housing unit 3, and rotatably support the winding drum unit 4. The winding spring unit 7 is fixed onto the mechanism cover unit 6, and covers an end face of the mechanism cover unit 6 on the outside in the drum shaft direction.

The retractor 1 includes the housing unit 3, the pretensioner unit 5, and a support body 1A including the mechanism cover unit 6. The support body 1A is mounted to the vehicle, and rotatably supports the winding drum 10 in the winding direction “M” and the drawing-out direction “P” of the webbing 2. The winding direction “M” is a rotational direction of the winding drum 10 when the webbing 2 is wound, and the drawing-out direction “P” is a rotational direction thereof when the webbing 2 is drawn out.

By winding and drawing-out of the webbing 2, the winding drum 10 rotates in the winding direction “M” and the drawing-out direction “P” around the axis U1 in a state of being supported by the support body 1A. The winding drum unit 4 includes a ratchet gear 8 formed of steel or zinc alloy and, normally, rotates integrally with the winding drum 10. The winding spring unit 7 is an urging mechanism for urging the winding drum 10 (winding drum unit 4) in the winding direction “M”, and winding means for winding the webbing 2 onto the winding drum 10. The winding spring unit 7 rotates the winding drum 10 in the winding direction “M”. The webbing 2 is wound onto the rotating winding drum 10 and is housed in the retractor 1. From the state described above, the webbing 2 is drawn out from the retractor 1 while the winding drum 10 is being rotated in the drawing-out direction “P”.

The mechanism cover unit 6 forms a locking mechanism 9 adjacent to the ratchet gear 8 of the winding drum unit 4 and for stopping the rotation of the winding drum 10 together with the ratchet gear 8. The locking mechanism 9 is locking means for locking the winding drum 10 rotating in the drawing-out direction “P”. In response to the sudden drawing-out of the webbing 2 or the sudden speed change of the vehicle, the locking mechanism 9 is operated. The locking mechanism 9 stops the rotation of the winding drum 10 in the drawing-out direction “P” to stop the drawing-out of the webbing 2. At this time, teeth 8A (ratchet teeth) of the ratchet gear 8 stop the rotation of the ratchet gear 8 to stop the rotation of the winding drum unit 4 and the winding drum 10.

The pretensioner unit 5 rotates the winding drum 10 in the winding direction “M” in the emergency (e.g., crash) of the vehicle. Therefore, the webbing 2 is wound onto the winding drum 10 and, thus, slack of the webbing 2 is removed. The pretensioner unit 5 is fixed to the housing unit 3 with a plurality of screws 5A and, further, is fixed onto the housing unit 3 with a pair of stopper pin 5B and push nut 5C.

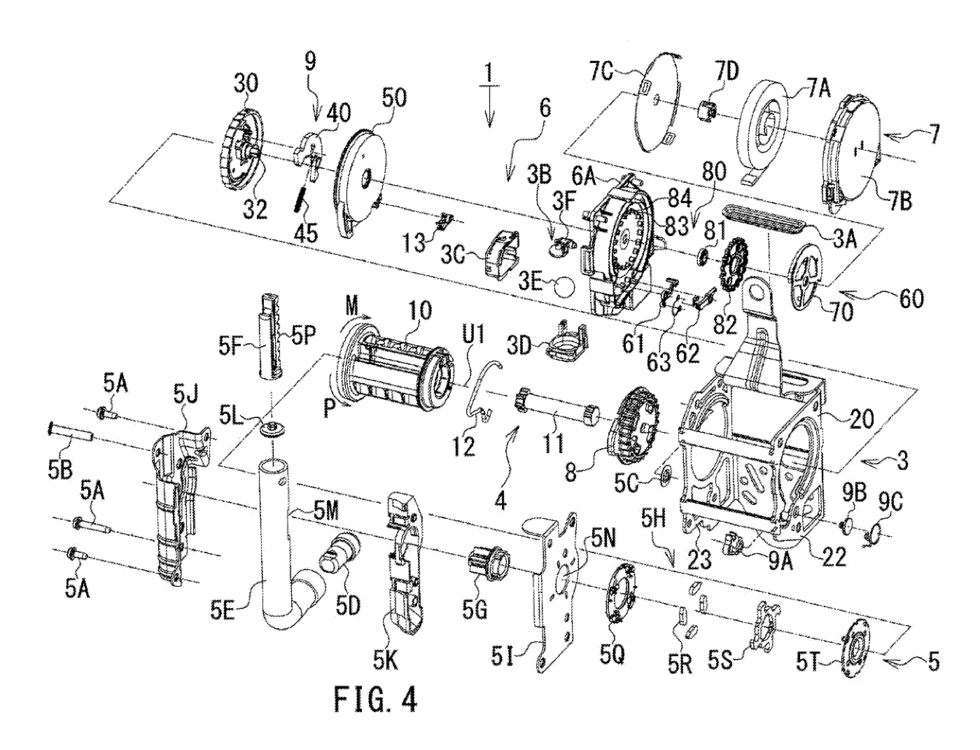

FIG. 4 is a perspective view of the retractor 1 that is completely exploded, and illustrates the retractor 1 viewed from an opposite side (in a W2 direction) of that illustrated in FIG. 1.

As illustrated in FIG. 4, when a plurality of components is combined with each other, units 3 to 7 of the retractor 1 are assembled, respectively. In addition, when a plurality of units 3 to 7 is united, the retractor 1 can be manufactured. Hereinafter, each portion of the retractor 1 will be sequentially described in detail.

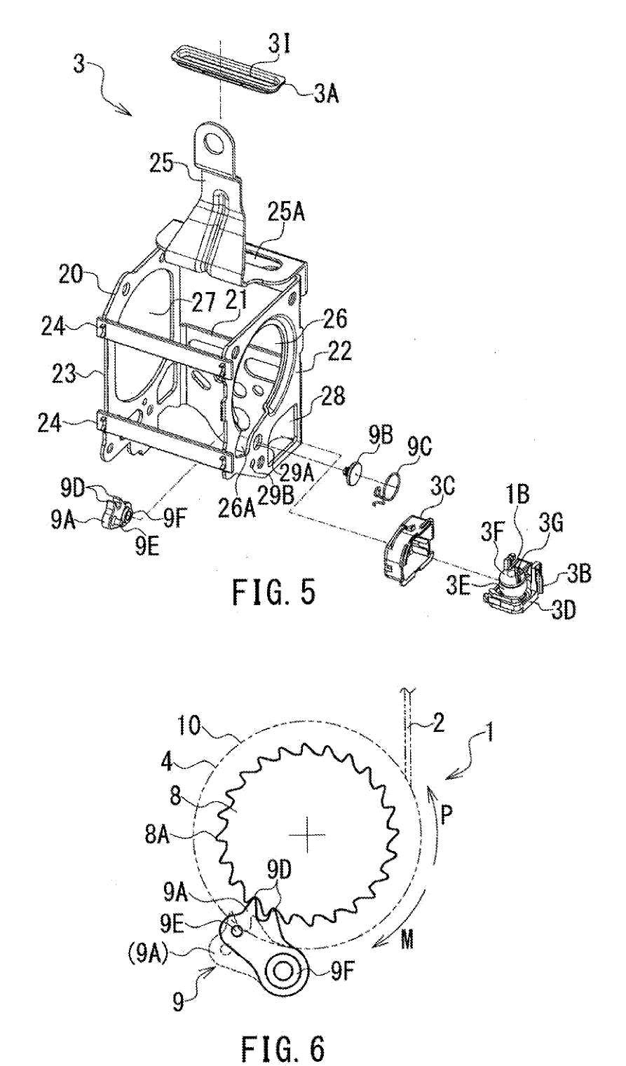

FIG. 5 is a perspective view of the housing unit 3 that is exploded, and illustrates the housing unit 3 viewed in the same direction as that illustrated in FIG. 4.

As illustrated in FIG. 5, the housing unit 3 includes a housing 20 housing the winding drum 10, a protector 3A, an acceleration sensor 3B, a sensor cover 3C for covering the acceleration sensor 3B, a movable pawl 9A for engaging with the ratchet teeth 8A of the ratchet gear 8, a pawl rivet 9B, and a return spring 9C. The housing 20 and the movable pawl 9A are formed of steel and the like, and the protector 3A is formed of a synthetic resin. The acceleration sensor 3B is a first acceleration detection mechanism 1B (acceleration detection mechanism of a vehicle) for detecting the acceleration of the vehicle.

The housing 20 includes a back-plate portion 21 to be fixed to a car body, a pair of side wall portions 22 and 23 (a first side wall portion 22 and a second side wall portion 23) protruding from each of both side edge portions of the back-plate portion 21, two fixed plates 24 fixed to the pair of side wall portions 22 and 23, and a bracket 25 mounted to the back-plate portion 21. The bracket 25 is formed of steel and the like. The protector 3A includes a passage hole 31 for the webbing 2, and is mounted to a mounting hole 25A of the bracket 25. The webbing 2 is caused to go through the passage hole 31 of the protector 3A, and passes therethrough at the time of winding or drawing-out.

The housing 20 includes a first opening portion 26 formed in the first side wall portion 22, a pawl housing portion 26A connected to the first opening portion 26, and a second opening portion 27 formed in the second side wall portion 23. When the winding drum 10 is housed in the housing 20, the ratchet gear 8 is arranged in the first opening portion 26, and one end portion of the winding drum 10 is arranged in the second opening portion 27. In the state described above, the mechanism cover unit 6 is mounted onto the first side wall portion 22, and the pretensioner unit 5 is mounted onto the second side wall portion 23.

The acceleration sensor 3B is an emergency locking operation device for detecting the acceleration of the vehicle to thereby operate the locking mechanism 9 when the vehicle encounters an emergency, and includes a sensor holder 3D, an inertia mass body 3E, and a sensor lever 3F. The sensor holder 3D and the sensor lever 3F are formed of a synthetic resin. The inertia mass body 3E includes a sphere made of metal, is arranged in a concave portion of the sensor holder 3D, and is movably held between the sensor holder 3D and the sensor lever 3F. The sensor lever 3F covers the inertia mass body 3E from above, and is movably mounted to the sensor holder 3D, in a vertical direction.

The acceleration sensor 3B is inserted into the sensor cover 3C, and the sensor holder 3D is mounted to the sensor cover 3C. The sensor cover 3C is inserted into a mounting hole 28 of the first side wall portion 22, and is mounted onto the first side wall portion 22. In the state described above, a lock claw 3G of the sensor lever 3F protrudes upward, and is positioned outside the sensor cover 3C. When the acceleration of the vehicle exceeds a predetermined acceleration in an emergency state of the vehicle (for example, crash or sudden braking), the inertia mass body 3E is moved above the sensor holder 3D by an inertia force to thereby press the sensor lever 3F upward. When the inertia mass body 3E moves, the acceleration sensor 3B detects the acceleration of the vehicle. The lock claw 3G of the sensor lever 3F is pressed by the inertia mass body 3E to thereby move upward.

The movable pawl 9A includes engagement teeth 9D for engaging with the ratchet teeth 8A, an interlocking pin 9E formed at one end portion of the movable pawl 9A, and a boss 9F in a cylindrical shape formed at other end portion of the movable pawl 9A. The boss 9F is inserted into a mounting hole 29A of the first side wall portion 22 from an inside of the housing 20, and is rotatably mounted onto the first side wall portion 22 with the use of the pawl rivet 9B. The return spring 9C includes a screw coil spring, and is arranged so as to surround a head portion of the pawl rivet 9B. One end portion of the return spring 9C is mounted to the interlocking pin 9E, and other end portion of the return spring 9C is mounted into a mounting hole 29B of the first side wall portion 22. The movable pawl 9A is urged by the return spring 9C toward the pawl housing portion 26A, and is housed in the pawl housing portion 26A. The interlocking pin 9E protrudes from the movable pawl 9A to the outside of the housing 20.

The locking mechanism 9 is coupled with the interlocking pin 9E, and the interlocking pin 9E moves the movable pawl 9A. Therefore, the movable pawl 9A rotates about the boss 9F, and moves in an inward/outward direction of the pawl housing portion 26A. By a rotational movement, the movable pawl 9A separates away from the ratchet gear 8 (refer to FIG. 3), or gets closer to the ratchet gear 8. Furthermore, the movable pawl 9A moves between a non-locking position (position inside the pawl housing portion 26A) where the engagement teeth 9D do not engage with the ratchet teeth 8A and the locking position (position outside the pawl housing portion 26A) where the engagement teeth 9D engage therewith. When the movable pawl 9A moves to the locking position, the engagement teeth 9D engage with the ratchet teeth 8A of the ratchet gear 8.

FIG. 6 is a side view schematically illustrating the movable pawl 9A and the ratchet gear 8. Furthermore, FIG. 6 illustrates, by the solid lines, the movable pawl 9A moved to the locking position, and illustrates, by the dotted lines, the movable pawl 9A moved to the non-locking position.

As illustrated in FIG. 6, when the engagement teeth 9D engage with the ratchet teeth 8A, the movable pawl 9A moves toward the locking position, and thus the engagement teeth 9D engage with the ratchet teeth 8A. Accordingly, the movable pawl 9A engages with the ratchet gear 8. The movable pawl 9A stops the rotation of the ratchet gear 8 in the drawing-out direction “P” to lock the ratchet gear 8 and the winding drum 10. Therefore, the movable pawl 9A forms a part of the locking mechanism 9 and stops the rotation of the winding drum 10 in the drawing-out direction “P”.

The movable pawl 9A and the ratchet gear 8 engage with each other only when the winding drum 10 rotates in the drawing-out direction “P”, and the ratchet teeth 8A and the engagement teeth 9D are inclined so as to stop the rotation of the ratchet gear 8 only in the drawing-out direction “P”. When the engagement teeth 9D come off the ratchet teeth 8A, the movable pawl 9A and the ratchet gear 8 are disengaged. The movable pawl 9A is always urged toward the non-locking position in the pawl housing portion 26A by the return spring 9C. Therefore, by the disengagement, the movable pawl 9A separates away from the ratchet gear 8 to move to the non-locking position, and is housed in the pawl housing portion 26A. At the same time, locks of the ratchet gear 8 and the winding drum 10 are released, and the drawing-out and winding of the webbing 2 become possible.

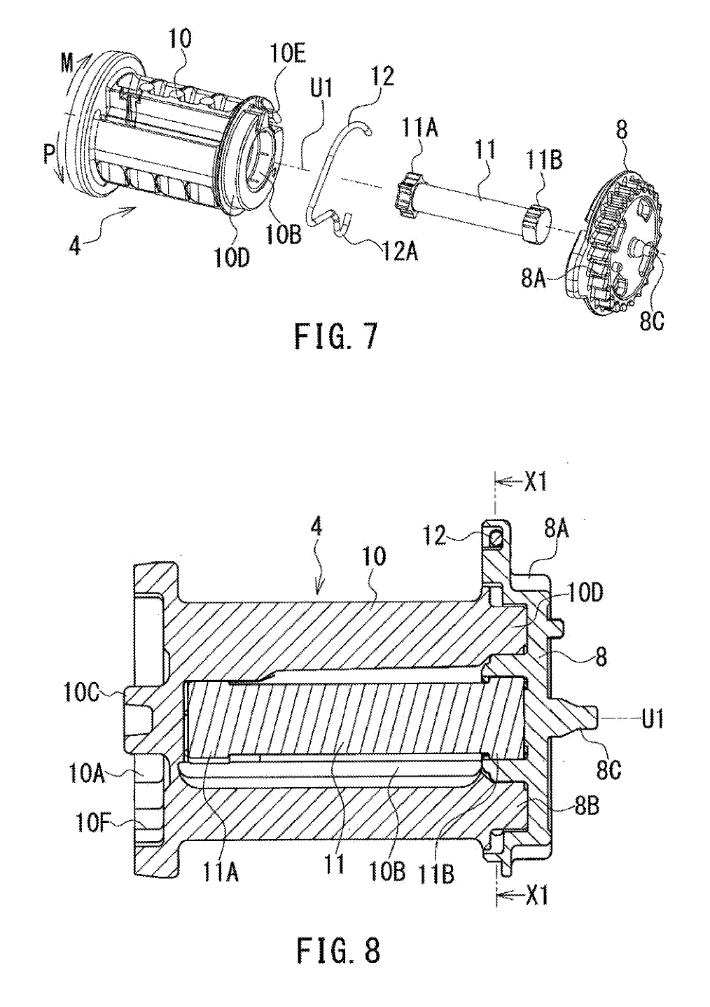

FIG. 7 is a perspective view of the winding drum unit 4 that is exploded, and illustrates a part of FIG. 4. FIG. 8 is a cross-sectional view of the winding drum unit 4, and illustrates the winding drum unit 4 taken on a face including the axis U1.

As illustrated in FIG. 8, the winding drum unit 4 includes the ratchet gear 8 in a disk-like shape, the winding drum 10 rotatable in the winding direction “M” and the drawing-out direction “P” of the webbing 2, and a torsion bar 11 in a columnar shape, and a wire 12. The ratchet gear 8 includes a plurality of ratchet teeth 8A formed over its entire outer circumference, a circular concave portion 8B formed on the winding drum 10 side, and a shaft portion (ratchet shaft portion) 8C protruding from a center portion.

The winding drum 10 includes an internal gear 10A formed at the one end portion, a shaft hole portion 10B formed along the axis U1, a boss 10C in a cylindrical shape, a circular portion 10D formed at the other end portion, and a fixed portion 10E formed on the circular portion 10D. A plurality of teeth 10F of the internal gear 10A is formed over an entire inner circumference of the internal gear 10A and protrudes inward from the internal gear 10A. The shaft hole portion 10B closes at the one end portion of the winding drum 10, and opens at the other end portion thereof. The boss 10C is formed at a center of the one end portion of the winding drum 10. The ratchet shaft portion 8C and the boss 10C are positioned at the axis U1 of the winding drum 10, and the winding drum unit 4 is rotatably supported by the ratchet shaft portion 8C and the boss 10C. The circular portion 10D is a small diameter portion that is thinner than other portions of the winding drum 10. One end portion 12A of the wire 12 is fitted into the fixed portion 10E of the circular portion 10D to be fixed to the fixed portion 10E. In the state described above, the wire 12 is arranged around the circular portion 10D.

The torsion bar 11 is inserted into the shaft hole portion 10B of the winding drum 10 to thereby be arranged in the shaft hole portion 10B. Furthermore, the torsion bar 11 is formed of steel for example, and includes splines 11A and 11B. One spline 11A is formed at the one end portion of the torsion bar 11, and is fixed to one end portion of the winding drum 10 in the shaft hole portion 10B. Other spline 11B is formed at other end portion of the torsion bar 11, and is fixed to the center portion of the ratchet gear 8. The ratchet gear 8 is fixed to the torsion bar 11, and is mounted to the winding drum 10. The circular portion 10D of the winding drum 10 is housed in the circular concave portion 8B of the ratchet gear 8. The wire 12 is a linear material (for example, linear material made of steel), and is housed together with the circular portion 10D in the circular concave portion 8B, and is arranged in the ratchet gear 8.

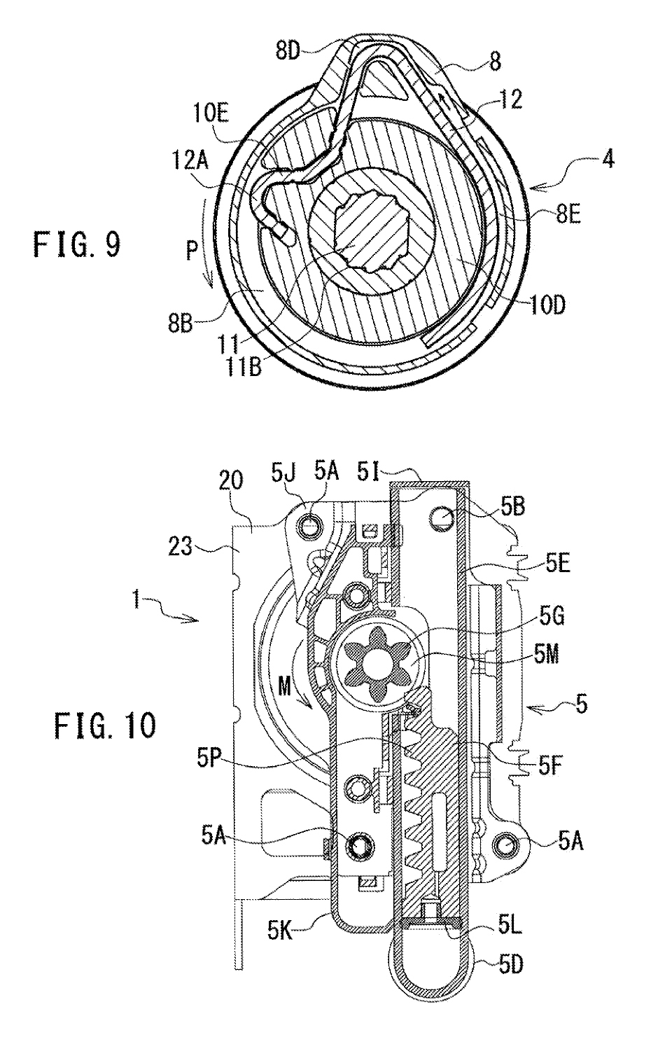

FIG. 9 is a cross-sectional view of the winding drum unit 4 taken along a line X1-X1 illustrated in FIG. 8, viewed in an arrow direction.

As illustrated in FIG. 9, the one end portion 12A of the wire 12 is fixed to the fixed portion 10E, and the wire 12 is arranged in a bending path 8D and a sliding path 8E. The bending path 8D is formed on the ratchet gear 8, and the sliding path 8E is formed between the ratchet gear 8 and the circular portion 10D.

In a state where the rotation of the ratchet gear 8 (refer to FIGS. 7, 8) is stopped by the locking mechanism 9 (movable pawl 9A), when an occupant moves forward in the vehicle, a large force (drawing-out force) acts on the webbing 2. When the webbing 2 is drawn out with the drawing-out force exceeding a predetermined value, a rotational torque in the drawing-out direction P acts on the winding drum 10, and thus the winding drum 10 rotates in the drawing-out direction P. With this rotation, the spline 11A of the torsion bar 11 is rotated, and the torsion bar 11 is twisted and deformed. The torsion bar 11 is a first energy-absorbing mechanism, and absorbs impact energy while being twisted and deformed. At the same time, the winding drum 10 rotates in the drawing-out direction P with respect to the ratchet gear 8, and the wire 12 slides in the bending path 8D and the sliding path 8E in a circular-arc shape (refer to FIG. 9). By the sliding described above, the wire 12 is forced to be sequentially bent in the bending path 8D, and is wound on the circular portion 10D of the winding drum 10. The wire 12 is a second energy-absorbing mechanism, and absorbs the impact energy with sliding resistance and bending resistance.

FIG. 10 is a cross-sectional view illustrating an inner configuration of the pretensioner unit 5.

As illustrated in FIGS. 4 and 10, the pretensioner unit 5 includes a gas generation unit 5D, a pipe cylinder 5E, a piston 5F, a pinion gear 5G, and a clutch mechanism 5H. The pipe cylinder 5E, the piston 5F, and the pinion gear 5G are formed of steal and the like. The gas generation unit 5D generates gas in one end portion of the pipe cylinder 5E responding to an operation signal received from a control unit of the vehicle. The pipe cylinder 5E is arranged among a base plate 5I, a cover plate 5J, and a base block 5K, and is fixed to the second side wall portion 23 of the housing 20. The piston 5F includes a seal plate 5L formed of rubber and the like, and is moved in the pipe cylinder 5E by gas supplied from the gas generation unit 5D. The pinion gear 5G is arranged at an opening portion 5M of the pipe cylinder 5E, and rotates in a support hole 5N of the base plate 5I. At the time of the movement of the piston 5F, the pinion gear 5G meshes with a rack 5P of the piston 5F and rotates in the winding direction M.

The clutch mechanism 5H is mounted on an outer circumference of the pinion gear 5G passing through the support hole 5N. Furthermore, the clutch mechanism 5H includes a pawl guide 5Q, a plurality of clutch pawls 5R, a pawl base 5S fixed to the pinion gear 5G, and a bearing 5T in a circular shape. The clutch pawl 5R and the pawl base 5S are formed of steal and the like, and the pawl guide 5Q and the bearing 5T are formed of a synthetic resin. The bearing 5T is fixed to the pawl guide 5Q, and the clutch pawl 5R and the pawl base 5S are sandwiched between the bearing 5T and the pawl guide 5Q. When the pawl base 5S rotates with the pinion gear 5G, the pawl base 5S relatively rotates with respect to the pawl guide 5Q to thereby press the plurality of clutch pawls 5R. By the action described above, the plurality of clutch pawls 5R is guided by the pawl guide 5Q to protrude from the clutch mechanism 5H, and rotates together with the pinion gear 5G.

The boss 10C of the winding drum 10 is inserted into an inner circumference of the bearing 5T, and is rotatably supported by the bearing 5T (refer to FIG. 8). The internal gear 10A of the winding drum 10 is arranged outside the clutch mechanism 5H. Normally, the winding drum 10 freely rotates with respect to the pinion gear 5G. On the other hand, when the vehicle encounters an emergency, the pretensioner unit 5 is operated to rotate the pinion gear 5G in the winding direction M, and the clutch pawl 5R protrudes from the clutch mechanism 5H. Subsequently, the clutch pawl 5R is engaged with the internal gear 10A (tooth 10F) to transmit rotation of the pinion gear 5G to the winding drum 10. The winding drum 10 rotates in the winding direction M to thereby wind the webbing 2. With the winding, slack of the webbing 2 is removed and thus the occupant is securely restrained on a seat. After the pretensioner unit 5 is operated, the locking mechanism 9 stops the rotation of the winding drum 10 in the drawing-out direction P, and the first and second energy-absorbing mechanisms absorb the impact energy.

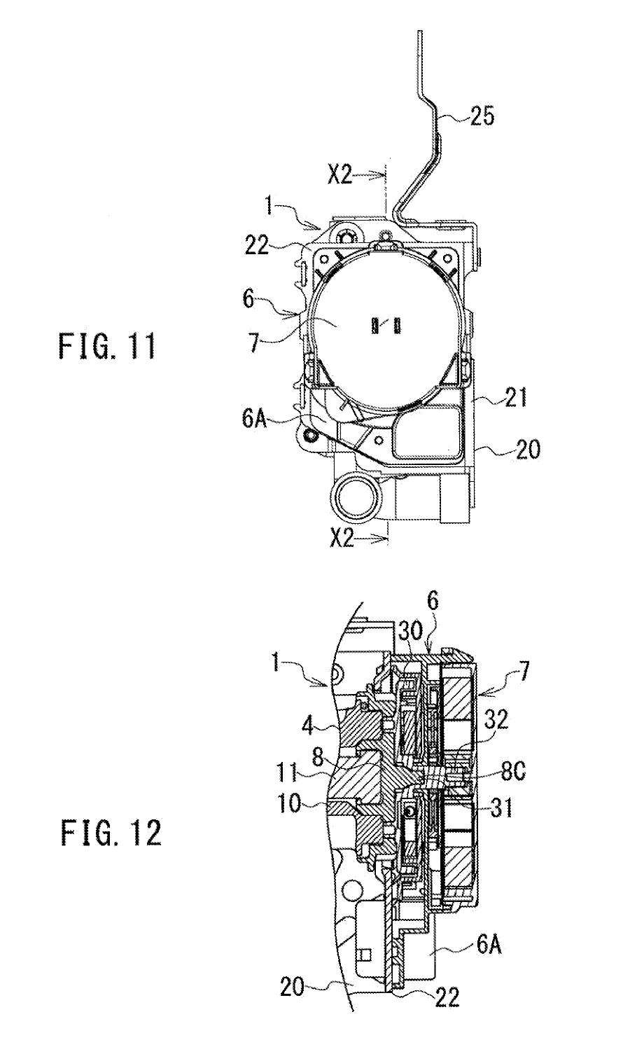

FIG. 11 is a side view of the retractor 1 viewed in an arrow W3 direction illustrated in FIG. 1. FIG. 12 is a cross-sectional view of the retractor 1 taken along a line X2-X2 illustrated in FIG. 11, viewed in an arrow direction.

As illustrated in FIGS. 11 and 12, the mechanism cover unit 6 is coupled with the ratchet gear 8 of the winding drum unit 4 to thereby rotatably support the ratchet shaft portion 8C. The winding spring unit 7 is coupled with the ratchet gear 8 by the mechanism cover unit 6.

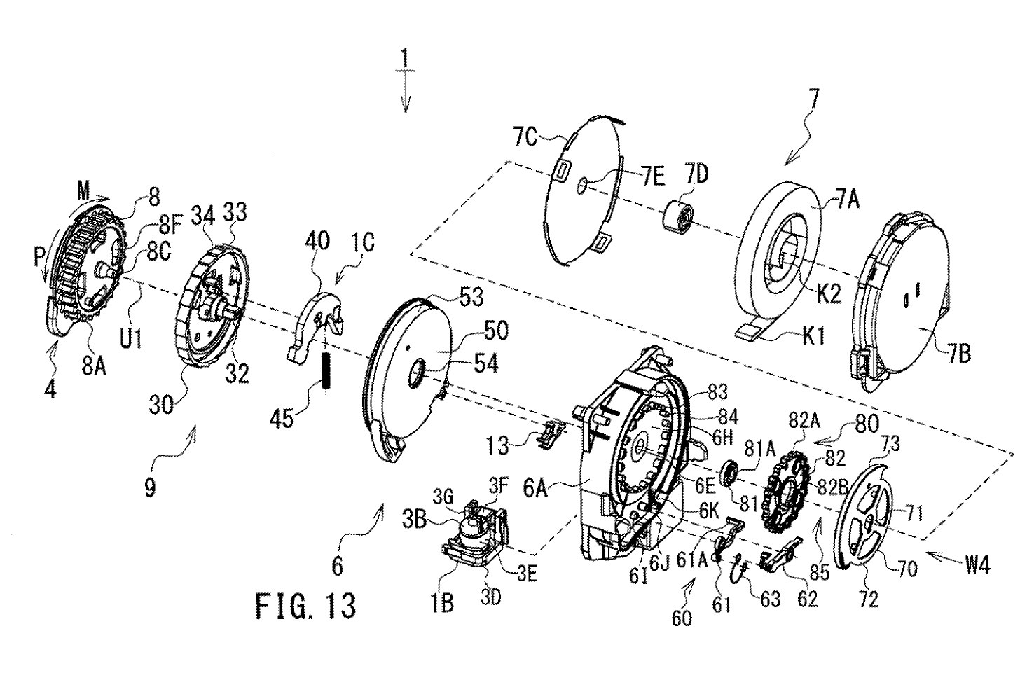

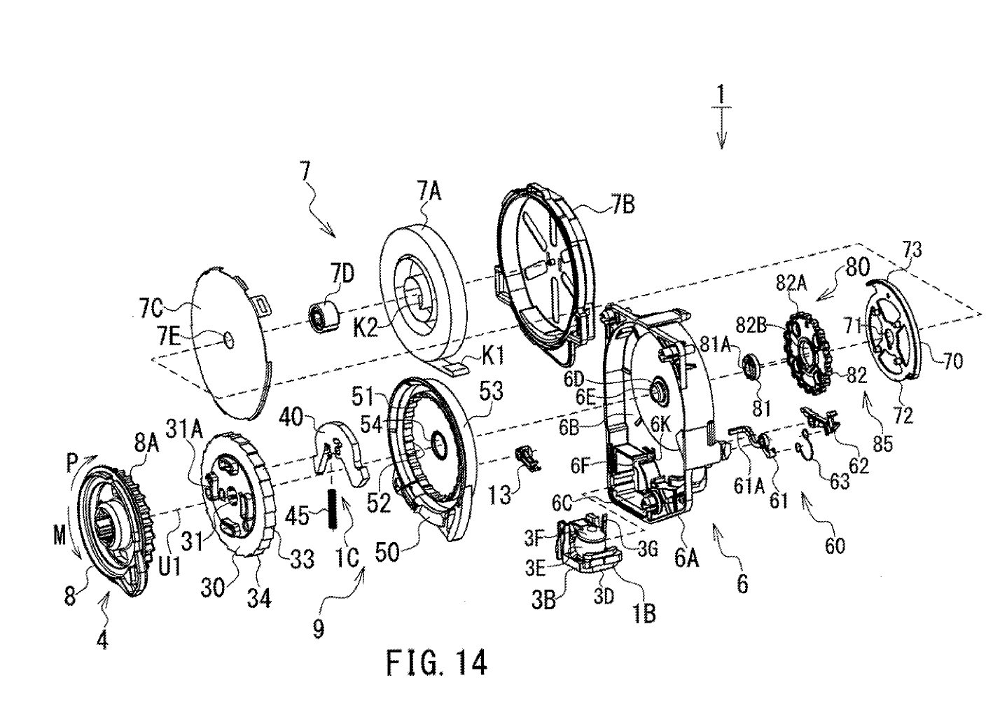

FIGS. 13, 14 are perspective views of the mechanism cover unit 6 and the winding spring unit 7 that are exploded, and also illustrate the ratchet gear 8 of the winding drum unit 4. FIG. 13 illustrates the mechanism cover unit 6 and the winding spring unit 7 viewed in the same direction as that in FIG. 4, and FIG. 14 illustrates the mechanism cover unit 6 and the winding spring unit 7 viewed from an opposite side of FIG. 13.

As illustrated in FIGS. 13, 14, the ratchet gear 8 is coupled with a locking gear 30 of the mechanism cover unit 6. The locking gear 30 is formed of a synthetic resin, and includes a shaft hole 31 into which the ratchet shaft portion 8C is inserted, four fitting protrusions 31A, and a shaft portion (gear shaft portion) 32 protruding from the center portion. The four fitting protrusions 31A fit into four fitting concave portions 8F formed on the ratchet gear 8 respectively. The locking gear 30 is mounted to the ratchet gear 8, and rotates integrally with the winding drum unit 4 (winding drum 10). The gear shaft portion 32 passes through the mechanism cover unit 6, and is mounted to the winding spring unit 7.

The winding spring unit 7 (urging mechanism) includes a spiral spring 7A, a spring case 7B, a spring sheet 7C in contact with the mechanism cover unit 6, and a spring shaft 7D. The spring case 7B, the spring sheet 7C, and the spring shaft 7D are formed of a synthetic resin. An outer end K1 of the spiral spring 7A is fixed to the spring case 7B, and an inner end K2 of the spiral spring 7A is fixed to the spring shaft 7D. The spring case 7B houses the spiral spring 7A and the spring shaft 7D. The spring sheet 7C is a sheet member mounted to the spring case 7B, and a cover portion for covering the spiral spring 7A and the spring shaft 7D in the spring case 7B. The spring shaft 7D is rotatably mounted to the spring case 7B. The gear shaft portion 32 is inserted into a support hole 7E and is rotatably supported by the spring sheet 7C, and is fixed to the spring shaft 7D. The spring shaft 7D is coupled with the winding drum unit 4 via the locking gear 30 and the ratchet gear 8.

The spring shaft 7D rotates integrally with the winding drum 10 of the winding drum unit 4, and transmits an urging force of the spiral spring 7A to the winding drum 10. The winding spring unit 7 always urges the winding drum 10 with the spiral spring 7A in the winding direction “M” of the webbing 2. Furthermore, when the webbing 2 is drawn out, the winding drum 10 is rotated to wind the spiral spring 7A. When the webbing 2 is wound, the winding drum 10 is rotated in the winding direction “M” by the urging force of the spiral spring 7A, to thereby wind the webbing 2 onto the winding drum 10.

The mechanism cover unit 6 includes a mechanism cover 6A, the locking gear 30 in a circular shape, a locking arm 40, a sensor spring 45, a clutch 50, a meshing pawl 13, and a switch mechanism 60 for switching a state of the locking mechanism 9. The mechanism cover 6A, the locking arm 40, the clutch 50, and the meshing pawl 13 are formed of a synthetic resin. In addition, the mechanism cover 6A is a housing member for housing the locking mechanism 9. The locking mechanism 9 is arranged inside the mechanism cover 6A in a drum shaft direction (at a side where the winding drum 10 is positioned). The mechanism cover 6A is arranged outside the winding drum 10 and the locking mechanism 9 in the drum shaft direction, and houses the locking mechanism 9 inside the winding drum 10 in the drum shaft direction.

The mechanism cover 6A includes a first housing portion 6B for housing the locking mechanism 9, a second housing portion 6C for housing the acceleration sensor 3B, a support portion (drum support portion) 6D for supporting a shaft portion of the winding drum 10, and an insertion hole 6E passing through the drum support portion 6D. The first housing portion 6B houses the locking gear 30, the locking arm 40, and the clutch 50 which form a part of the locking mechanism 9. The acceleration sensor 3B is inserted into the second housing portion 6C and is mounted thereto. In the state described above, the lock claw 3G of the sensor lever 3F is arranged in an opening 6F of the second housing portion 6C, passes through the opening 6F, and moves into the first housing portion 6B.

The shaft portion of the winding drum 10 serves as a center of a rotational movement of the winding drum 10 when the winding drum 10 rotates, and rotates together with the winding drum 10. Here, the gear shaft portion 32 of the locking gear 30 is the shaft portion of the winding drum 10, and is inserted into the insertion hole 6E formed in the drum support portion 6D to pass through the mechanism cover 6A. The drum support portion 6D rotatably supports the gear shaft portion 32 inserted into the insertion hole 6E. The gear shaft portion 32 is supported by the drum support portion 6D to rotate.

The locking arm 40 is displaceably coupled with the locking gear 30, and operates the locking mechanism 9 when locking arm 40 is displaced. By the operation described above, the locking gear 30, the locking arm 40, and the clutch 50 that form a part of the locking mechanism 9 move the movable pawl 9A from the non-locking position to the locking position. The movable pawl 9A locks the winding drum 10 to stop the rotation of the winding drum 10 in the drawing-out direction “P”.

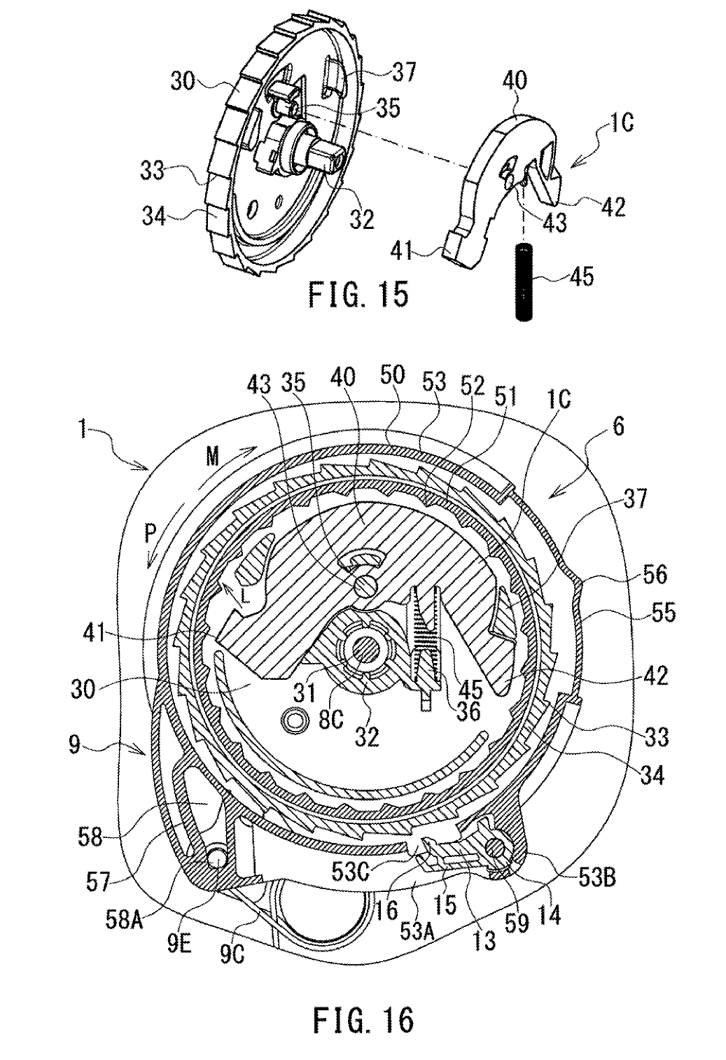

FIG. 15 is a perspective view of the locking gear 30 and the locking arm 40, and illustrates a part of FIG. 13. FIG. 16 is a cross-sectional view of the mechanism cover unit 6, and illustrates a part of the mechanism cover unit 6 that is assembled.

As illustrated in FIGS. 15, 16, the locking gear 30 includes a ratchet wheel 34 including a plurality of teeth 33, an arm support portion 35 in a columnar shape, and a support pin 36 for supporting the sensor spring 45. The ratchet wheel 34 includes a circular member formed over an outer circumference of the locking gear 30, and is rotatable with the winding drum 10. The plurality of teeth 33 is inclined to stop the rotation of the ratchet wheel 34 only in the drawing-out direction “P”, and is formed over an entire outer circumference of the ratchet wheel 34.

The locking arm 40 includes a through hole 43 formed between one end portion (engagement end portion) 41 and other end portion (free end portion) 42 in a longitudinal direction, and is formed in a curving shape. When the arm support portion 35 is inserted into the through hole 43, the locking arm 40 is mounted to the arm support portion 35. The arm support portion 35 rotatably supports the locking arm 40, and the locking arm 40 is rotatably coupled with the locking gear 30 via the arm support portion 35. The locking arm 40 is arranged inside the ratchet wheel 34, and rotates about the arm support portion 35. The sensor spring 45 is arranged between the locking arm 40 and the support pin 36, and urges the other end portion 42 of the locking arm 40 in the drawing-out direction “P”. By the urging force, the other end portion 42 of the locking arm 40 comes into contact with a stopper 37 of the locking gear 30.

The locking arm 40 rotates together with the winding drum 10 and the locking gear 30 in the drawing-out direction “P” and the winding direction “M”. Normally, by the urging force of the sensor spring 45, the other end portion 42 of the locking arm 40 is maintained to be in contact with the stopper 37 of the locking gear 30. In contrast to this, when the vehicle encounters an emergency, the other end portion 42 of the locking arm 40 separates away from the stopper 37 to displace the locking arm 40.

More specifically, when the acceleration for drawing-out the webbing 2 exceeds the predetermined acceleration (i.e., when the acceleration in the drawing-out direction “P” of the winding drum 10 rotating in the drawing-out direction “P” (acceleration of the rotation) exceeds the predetermined acceleration), with respect to the rotating locking gear 30, a delay due to inertia is caused with the locking arm 40. As a result, the locking arm 40 rotates while compressing the sensor spring 45, and the one end portion 41 of the locking arm 40 is displaced outward in the radial direction of the locking gear 30. By the displacement, as described below, the locking mechanism 9 of the retractor 1 is operated. Meanwhile, a radial direction of each member (or, a part of each member) is a straight-line direction orthogonal to an axis with an axis of each member as the center.

As described above, the locking arm 40 and the sensor spring 45 form a part of a second acceleration detection mechanism (acceleration detection mechanism of the webbing 2) 1C for detecting the acceleration of the drawing-out of the webbing 2 drawn out from the winding drum 10 (acceleration of the winding drum 10 in the drawing-out direction “P”). When the vehicle encounters an emergency, the second acceleration detection mechanism. 1C detects the acceleration of the drawing-out of the webbing 2, and operates the locking mechanism 9. Furthermore, the locking arm 40 is a displacement member that is displaceable in a lock-operating direction “L” (refer to FIG. 16) depending on the acceleration of the winding drum 10 in the drawing-out direction and is displaced in the predetermined lock-operating direction “L”, in response to the acceleration. The lock-operating direction “L” is a direction for operating the locking mechanism 9 and, here, is a direction where the one end portion 41 of the locking arm 40 is displaced outward in the radial direction of the locking gear 30. The locking mechanism 9 is operated by the locking arm 40 axially displaced in the lock-operating direction “L”.

When the locking arm 40 is displaced in the lock-operating direction “L”, the locking arm 40 may be displaced or the locking arm 40 may be displaced relative to the winding drum 10 and the locking gear 30. Or the locking arm 40 may be displaced relative to the winding drum 10 and the locking gear 30 while being displaced. Therefore, the displacement of the locking arm 40 includes the displacement in such modes described above.

The locking arm 40 is coupled with the locking gear 30 displaceably in the lock-operating direction “L” to rotate therewith. Further, the arm support portion 35 is a displacement member support portion to displace the locking arm 40 in the lock-operating direction “L” by rotation. By rotating the locking arm 40 in the lock-operating direction “L” and an opposite direction of the lock-operating direction “L”, the locking arm 40 is displaced in each of the both directions. By the urging force of the sensor spring 45, the locking arm 40 is displaced (rotates) in the opposite direction of the lock-operating direction “L”, and the one end portion 41 of the locking arm 40 is displaced inward in the radial direction of the locking gear 30.

When the locking arm 40 is displaced in the lock-operating direction “L”, the locking mechanism 9 is operated to stop the rotation of the winding drum 10 in the drawing-out direction “P”. At this time (refer to FIGS. 13, 14), the clutch 50 is coupled with the locking gear 30 through the locking arm 40, and rotates therewith. When the clutch 50 rotates, the movable pawl 9A moves from the non-locking position to the locking position. The clutch 50 includes an inner wall 51 in a circular shape, a clutch gear 52 formed on an inner circumference of the inner wall 51, an outer wall 53 in a circular shape surrounding the inner wall 51, and a center hole 54 positioned at a center of the inner wall 51. When the gear shaft portion 32 of the locking gear 30 is inserted into the center hole 54, the locking gear 30 and the winding drum unit 4 rotate relative to the clutch 50. The ratchet wheel 34 of the locking gear 30 is arranged between the inner wall 51 and the outer wall 53 (refer to FIG. 16). The locking arm 40 is arranged inside the inner wall 51, and the one end portion 41 of the locking arm 40 is engaged with the clutch gear 52.

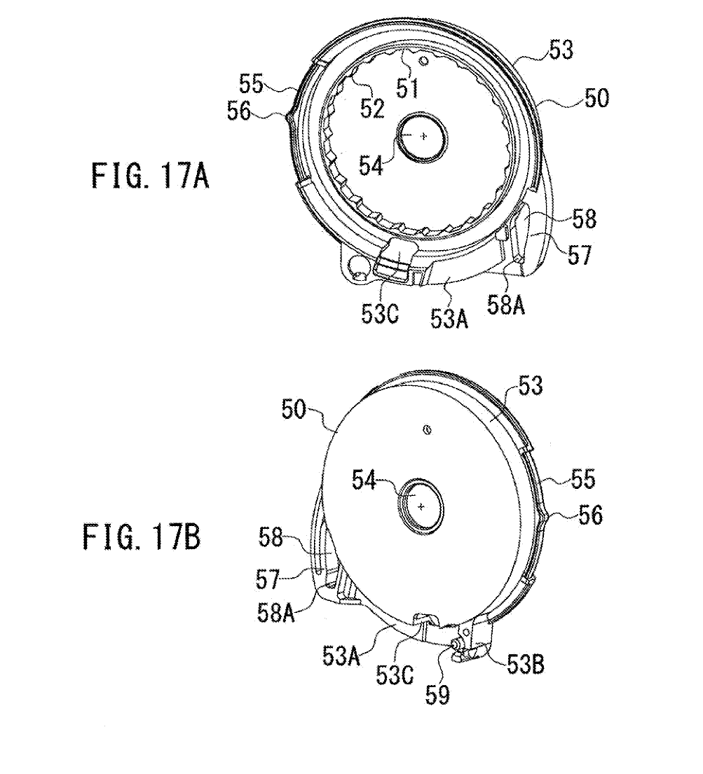

FIGS. 17A, 17B are perspective views of the clutch 50, and illustrate the clutch 50 viewed in two directions. FIG. 17A illustrates the clutch 50 viewed from the locking gear 30 side. FIG. 17B illustrates the clutch 50 viewed from an opposite side of FIG. 17A.

As illustrated in FIG. 17A, the clutch gear 52 includes a plurality of engagement teeth formed over an entire inner circumference of the inner wall 51, and engages with the one end portion 41 of the locking arm 40 displaced in the lock-operating direction “L”. Only when the locking gear 30 rotates in the drawing-out direction “P”, the one end portion 41 of the locking arm 40 engages with the clutch gear 52 in such a manner to hook the clutch gear 52. When the clutch gear 52 and the locking arm 40 engage with each other, the clutch 50 is coupled with the locking gear 30. In the state described above, the locking gear 30 and the locking arm 40 rotate in the drawing-out direction “P”, and the clutch 50 is pressed by the locking arm 40 to rotate in the drawing-out direction “P”.

The clutch 50 includes an elastically-deforming portion 55 formed on a part of the outer wall 53, a movable protrusion 56 formed on the elastically-deforming portion 55, a guide portion 57 formed outside the outer wall 53, and a guide hole 58 that is thin, long and formed at the guide portion 57. The movable protrusion 56 protrudes outward in a radial direction of the clutch 50, and when the elastically-deforming portion 55 is elastically deformed, the movable protrusion 56 moves inward in the radial direction of the clutch 50. The interlocking pin 9E of the movable pawl 9A (refer to FIGS. 5, 16) is inserted into the guide hole 58, and is guided by the guide portion 57 while moving in the guide hole 58. The movable pawl 9A is urged toward the non-locking position by the return spring 9C and, normally, is maintained in the non-locking position. At this time, the interlocking pin 9E is positioned at one end portion 58A of the guide hole 58 (refer to FIG. 16). The interlocking pin 9E presses the guide portion 57, and the position of the clutch 50 is maintained. Further, the interlocking pin 9E urges the clutch 50 in the winding direction “M”.

At the time of the normal drawing-out of the webbing 2, the winding drum 10 and the locking gear 30 rotate in the drawing-out direction “P” with respect to the stopped clutch 50. At this time, the one end portion 41 of the locking arm 40 is arranged at a position away from the clutch gear 52, and the locking arm 40 is maintained in a state of not being engaged with the clutch gear 52. In contrast to this, when the acceleration of the winding drum 10 in the drawing-out direction “P” exceeds the predetermined acceleration by the sudden drawing-out of the webbing 2, the locking arm 40 is displaced in the lock-operating direction “L” depending on the acceleration of the winding drum 10 in the drawing-out direction “P”. When the locking arm 40 rotates to thereby be displaced in the lock-operating direction “L”, the one end portion 41 of the locking arm 40 is displaced toward the clutch gear 52. Subsequently, the locking mechanism 9 is operated to lock the winding drum 10.

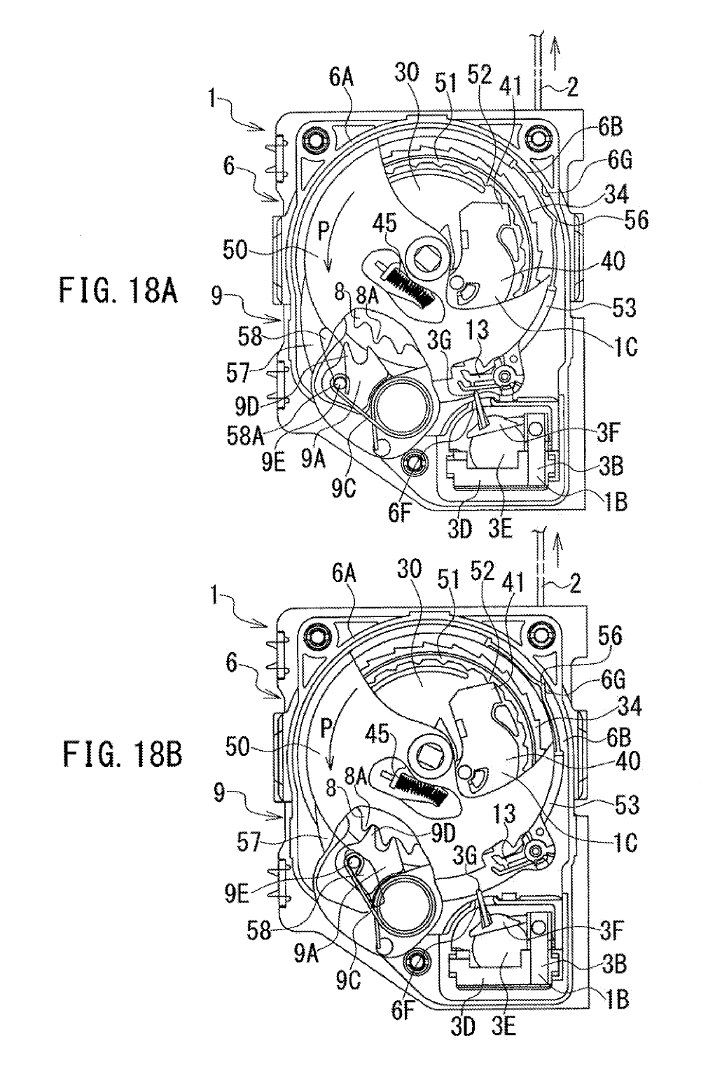

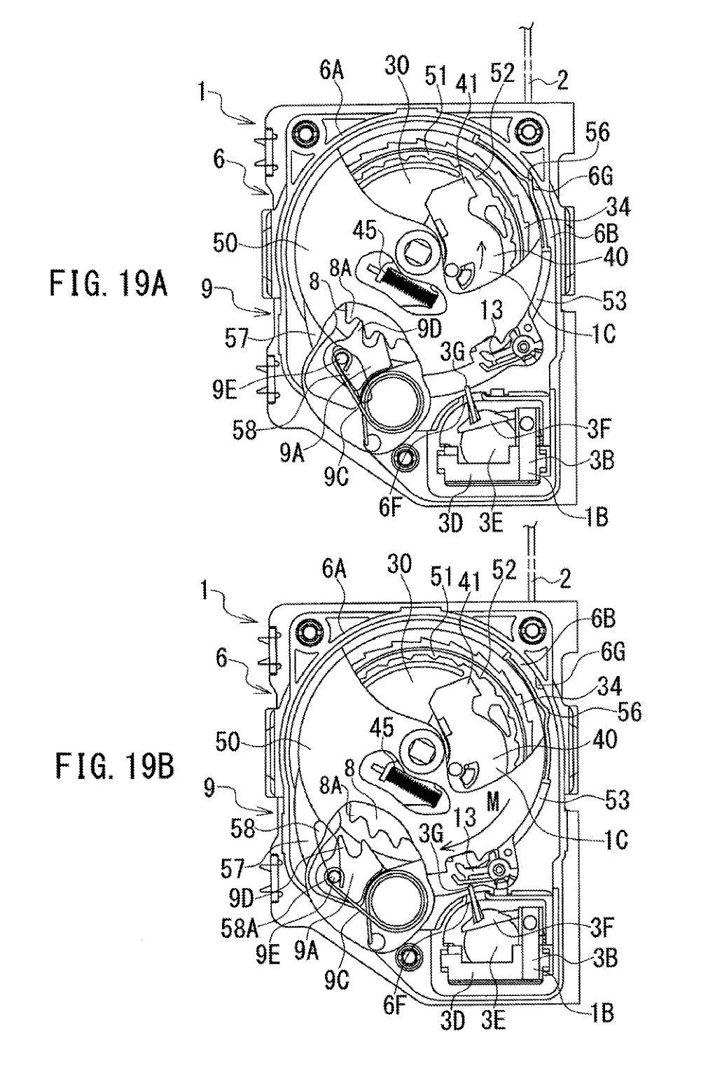

FIGS. 18A to 19B illustrate actions of the locking mechanism 9, and illustrate an inner configuration of the mechanism cover unit 6. Furthermore, FIGS. 18A to 19B illustrate a portion hidden by the clutch 50, by deleting a part of the clutch 50.

As illustrated in FIGS. 18A to 19B, the locking mechanism 9 is operated by the displacement of the locking arm 40. Specifically, by the displacement of the locking arm 40 in the lock-operating direction “L” (refer to FIG. 18A), the one end portion 41 of the locking arm 40 approaches the clutch gear 52 to thereby engage with the clutch gear 52. The clutch gear 52 is engaged with the locking arm 40 displaced in the lock-operating direction “L” to thereby stop the locking arm 40.

Through the clutch gear 52 and the locking arm 40, the clutch 50 is coupled with the locking gear 30 to rotate together with the locking gear 30 and the winding drum 10 in the drawing-out direction “P”. By the rotation described above, the interlocking pin 9E of the movable pawl 9A is pressed by the guide portion 57 to move in the guide hole 58. The interlocking pin 9E is guided by the guide portion 57 to move to a center side of the clutch 50 along the guide hole 58. When the interlocking pin 9E moves, the movable pawl 9A moves to the locking position, and the engagement teeth 9D of the movable pawl 9A engage with the ratchet teeth 8A of the ratchet gear 8 (refer to FIG. 18B).

The locking mechanism 9 locks the winding drum 10 with the movable pawl 9A. The locking mechanism 9 stops the rotation of the winding drum 10 in the drawing-out direction “P” to stop the drawing-out of the webbing 2. While the clutch 50 is rotating, the movable protrusion 56 of the clutch 50 comes into contact with a fixed protrusion 6G of the mechanism cover 6A to move inward in the radial direction of the clutch 50. The fixed protrusion 6G is formed on an inner wall of the first housing portion 6B, and protrudes into the first housing portion 6B. When an operation of the locking mechanism 9 is completed, the movable protrusion 56 stops at a position where the movable protrusion 56 has passed the fixed protrusion 6G.

The winding drum 10 is released from the load of the webbing 2, when the webbing 2 is wound, the winding drum 10 and the locking gear 30 is rotated in the winding direction “M”. At this time, since the movable protrusion 56 is hooked with the fixed protrusion 6G, the locking gear 30 and the locking arm 40 rotate relative to the clutch gear 52 of the clutch 50. By the rotation, a gap is generated between the one end portion 41 of the locking arm 40 and the clutch gear 52 to release the locking arm 40 from the clutch gear 52. When the locking arm 40 comes off the clutch gear 52, the locking arm 40 and the clutch gear 52 are disengaged. Further, the locking arm 40 is displaced in the opposite direction of the lock-operating direction “L”, and then the clutch 50 and the locking gear 30 are uncoupled (refer to FIG. 19A). By the rotation of the ratchet gear 8 in the winding direction “M”, the engagement teeth 9D of the movable pawl 9A are released from the ratchet teeth 8A of the ratchet gear 8.

Subsequently, by the urging force of the return spring 9C, the movable pawl 9A is moved toward the non-locking position, and the interlocking pin 9E of the movable pawl 9A moves in the guide hole 58. At the same time, the interlocking pin 9E presses the guide portion 57 to thereby rotate the clutch 50 in the winding direction “M”. The movable protrusion 56 of the clutch 50 is moved inward in the radial direction of the clutch 50 by the fixed protrusion 6G of the mechanism cover 6A, and passes over the fixed protrusion 6G. After that, the movable pawl 9A returns to the non-locking position while rotating the clutch 50 (refer to FIG. 19B). Therefore, the interlocking pin 9E moves to the one end portion 58A of the guide hole 58, and the clutch 50 recovers into an original state. Furthermore, the engagement teeth 9D and the ratchet teeth 8A are disengaged, and the lock of the winding drum 10 by the locking mechanism 9 is released. Afterwards, the drawing-out and winding of the webbing 2 become possible.

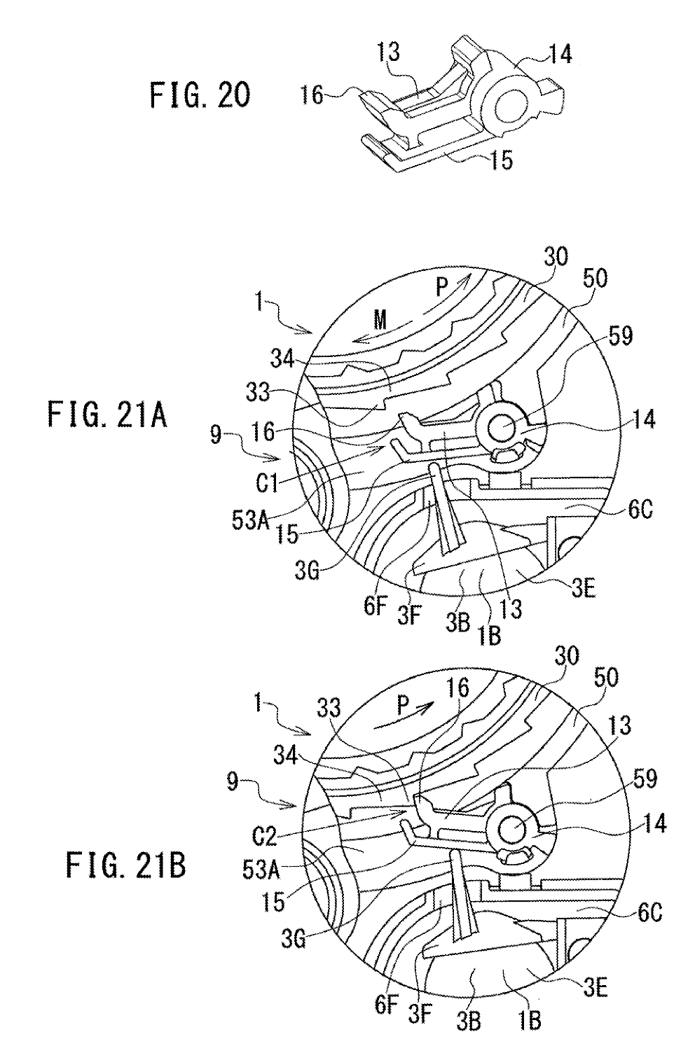

As described above, the locking mechanism 9 is a webbing-sensing locking mechanism operated by the above described second acceleration detection mechanism 1C and, in response to the sudden drawing-out of the webbing 2, stops the drawing-out of the webbing 2. Further, the locking mechanism 9 is a car-body-sensing locking mechanism operated by the acceleration sensor 3B (first acceleration detection mechanism 1B) and, in response to the sudden change of the speed of the vehicle, stops the drawing-out of the webbing 2. The locking mechanism 9, the meshing pawl 13, and the acceleration sensor 3B form the car-body-sensing locking mechanism. The acceleration sensor 3B operates the locking mechanism 9 by the meshing pawl 13, and the locking mechanism 9 locks the winding drum 10 similarly as described above. The meshing pawl 13 (refer to FIGS. 13, 14) is a mesh member for meshing with the teeth 33 of the ratchet wheel 34 and when the meshing pawl 13 meshes with the teeth 33, the clutch 50 is coupled with the locking gear 30. FIG. 20 is a perspective view of the meshing pawl 13.

As illustrated in FIG. 20, the meshing pawl 13 includes a mounting portion 14 in a cylindrical shape, a reception portion 15 in a plate-like shape protruding from the mounting portion 14, and a mesh tooth 16 meshing with the teeth 33 of the ratchet wheel 34. The meshing pawl 13 rotates about the mounting portion 14, and the meshing pawl 13 (mesh tooth 16) moves. Meanwhile, when the meshing pawl 13 meshes with the teeth 33 of the ratchet wheel 34, the mesh tooth 16 meshes with teeth 33.

The clutch 50 (refer to FIGS. 16, 17A, 17B) includes a flange 53A formed on the outer wall 53, a pawl support portion 59 in a columnar shape formed on the flange 53A, and a stopper 53B formed on the flange 53A. The pawl support portion 59 is inserted into the mounting portion 14, and the meshing pawl 13 is mounted on the pawl support portion 59. The pawl support portion 59 rotatably supports the meshing pawl 13, and the meshing pawl 13 is rotatably mounted to the clutch 50 by the pawl support portion 59. When the meshing pawl 13 rotates due to its weight, the meshing pawl 13 comes into contact with the stopper 53B to thereby stop the rotation of the meshing pawl 13. In the state described above, the mesh tooth 16 is arranged at an opening 53C of the outer wall 53. Furthermore, with the acceleration sensor 3B, the mesh tooth 16 passes through the opening 53C and moves inside the outer wall 53.

FIGS. 21A, 21B schematically illustrate a periphery of the meshing pawl 13, and also illustrate a part of the acceleration sensor 3B.

As illustrated in FIGS. 21A, 21B, the meshing pawl 13 moves (rotates) to a position where the meshing pawl 13 does not mesh with the teeth 33 of the ratchet wheel 34 (non-mesh position C1) (refer to FIG. 21A) and to a position where the meshing pawl 13 meshes with the teeth 33 of the ratchet wheel 34 (mesh position C2) (refer to FIG. 21B). Normally, the meshing pawl 13 is arranged at the non-mesh position C1, and the lock claw 3G of the sensor lever 3F is positioned near the meshing pawl 13.

When the acceleration of the vehicle exceeds the predetermined acceleration, the inertia mass body 3E moves and the sensor lever 3F and the lock claw 3G are moved upward by the inertia mass body 3E. The lock claw 3G presses the meshing pawl 13 (reception portion 15) upward so that the mesh tooth 16 approaches the ratchet wheel 34. The meshing pawl 13 moves from the non-mesh position C1 to the mesh position C2, to mesh with the teeth 33 of the ratchet wheel 34. The meshing pawl 13 and the teeth 33 of the ratchet wheel 34 are formed to mesh with each other only when the ratchet wheel 34 rotates in the drawing-out direction “P”. When the ratchet wheel 34 rotates in the winding direction “M”, the meshing pawl 13 (mesh tooth 16) relatively slides on an outer face of the teeth 33, and then passes over the teeth 33 at an edge of the teeth 33.

The meshing pawl 13 forms a part of the locking mechanism 9. When the meshing pawl 13 moves to the mesh position C2, the locking mechanism 9 is operated. When the meshing pawl 13 meshes with the teeth 33 of the ratchet wheel 34, by the meshing pawl 13 and the ratchet wheel 34, the clutch 50 is coupled with the locking gear 30. Subsequently, when the webbing 2 is drawn out, with the meshing pawl 13 meshed with the teeth 33, the clutch 50 rotates together with the locking gear 30 and the winding drum 10 in the drawing-out direction “P”. By the rotation, in the same way as the operation of the locking mechanism 9 when the locking arm 40 is displaced (refer to FIGS. 18A, 18B, 19A and 19B), the locking mechanism 9 is operated. When the clutch 50 rotates, the locking mechanism 9 is operated similarly as described above.

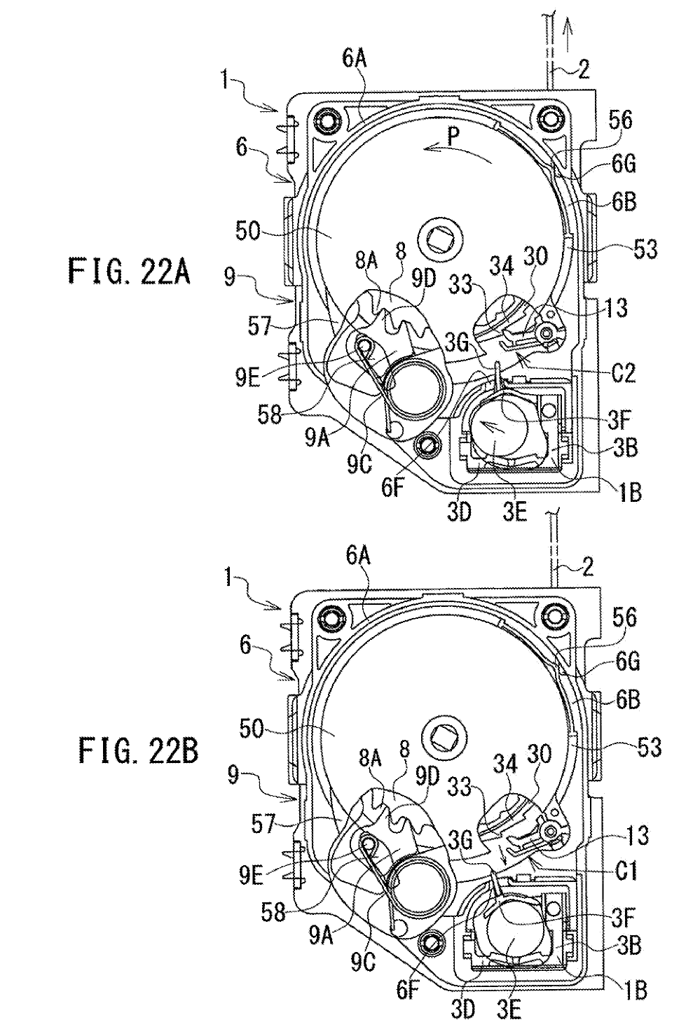

FIGS. 22A and 22B illustrate actions of the locking mechanism 9, and illustrate an inner configuration of the mechanism cover unit 6. Further, FIGS. 22A and 22B illustrate a portion hidden by the clutch 50, by deleting a part of the clutch 50.

As illustrated in FIGS. 22A and 22B, the movable pawl 9A moves to the locking position when the clutch 50 rotates, and the locking mechanism 9 locks the winding drum 10 with the movable pawl 9A (refer to FIG. 22A). The locking mechanism 9 stops the rotation of the winding drum 10 in the drawing-out direction “P” to stop the drawing-out of the webbing 2. The movable protrusion 56 of the clutch 50 stops at a position where the movable protrusion 56 has passed over the fixed protrusion 6G. When the acceleration of the vehicle becomes the predetermined acceleration or less, the inertia mass body 3E is moved to an original position by the gravity, and the sensor lever 3F and the lock claw 3G move downward (refer to FIG. 22B).

When the webbing 2 has been wound and the winding drum 10 is released from the load of the webbing 2, the winding drum 10 and the locking gear 30 rotate in the winding direction “M”. At this time, since the movable protrusion 56 is hooked with the fixed protrusion 6G, the locking gear 30 and the ratchet wheel 34 rotate relative to the clutch 50. By the rotation, a gap is generated between the mesh tooth 16 and the teeth 33 to release the meshing pawl 13 from the ratchet wheel 34. The meshing pawl 13 comes off the teeth 33, and moves due to its weight to the non-mesh position C1. Further, the clutch 50 and the locking gear are uncoupled. Subsequently, the movable pawl 9A returns to the non-locking position, and the clutch 50 recovers into the original state (refer to FIG. 19B). Therefore, the lock of the winding drum 10 via the locking mechanism 9 is released.

Next, the switch mechanism 60 of the mechanism cover unit 6 will be described (refer to FIGS. 13 and 14).

The switch mechanism 60 is switching means for switching the state of the locking mechanism 9 to thereby switch the state of the retractor 1. The switch mechanism 60 switches the locking mechanism 9 between an operation state and a waiting state. The operation state is a state where the locking mechanism 9 is operated, and the locking mechanism 9 in the operation state locks the winding drum 10 to thereby stop the rotation of the winding drum 10 in the drawing-out direction “P”. In the operation state, the locking mechanism 9 stops only the rotation of the winding drum 10 in the drawing-out direction “P”, and allows the winding drum 10 to rotate in the winding direction “M”. The waiting state is a state where the locking mechanism 9 waits the operation, and the locking mechanism 9 in the waiting state is operated when the vehicle encounters an emergency. In the waiting state, the switch mechanism 60 does not operate the locking mechanism 9, and thus the locking mechanism 9 allows the rotation of the winding drum 10 in the drawing-out direction “P” and the winding direction “M”. During the waiting state, the locking mechanism 9 can be operated independently from the switch mechanism 60, and when the vehicle encounters an emergency, the locking mechanism 9 is operated as the webbing-sensing locking mechanism and the car-body-sensing locking mechanism.

When the state of the retractor 1 is switched, the switch mechanism 60 controls the operation of the locking mechanism 9, to thereby switch the state of the locking mechanism 9. The switch mechanism 60 switches the state of the retractor 1 between the automatic locking retractor (ALR) state and the emergency locking retractor (ELR) state in accordance with the intended use. The ALR state refers to a state where the locking mechanism 9 is constantly operated. The ELR state refers to a state where the locking mechanism 9 is operated by the above described first acceleration detection mechanism 1B or the second acceleration detection mechanism 1C when the vehicle encounters an emergency.

Specifically, the switch mechanism 60 switches the locking mechanism 9 from the waiting state to the operation state, to thereby switch the retractor 1 from the ELR state to the ALR state. In the ALR state, the webbing 2 cannot be drawn out and can be wound only by the operation of the locking mechanism 9. For example, when a child seat or luggage is fixed onto the seat, the retractor 1 is switched to the ALR state. Furthermore, the switch mechanism 60 switches the locking mechanism 9 from the operation state to the waiting state to thereby switch the retractor 1 from the ALR state to the ELR state. In the ELR state, the locking mechanism 9 is in the waiting state, and thus, the webbing 2 can be wound and drawn out. However, when the vehicle encounters an emergency, the locking mechanism 9 is operated, and the winding drum 10 is locked by the locking mechanism 9. As a result, the rotation of the winding drum 10 in the drawing-out direction “P” is stopped and the drawing-out of the webbing 2 is stopped.

The switch mechanism 60 includes an operation member 61 for operating the locking mechanism 9, an arrangement member 62 for arranging the operation member 61 at a predetermined position, a control member 70 for controlling the state of the retractor 1, urging means 63, and a deceleration mechanism 80. The control member 70 is also a movement member in a circular shape for moving the arrangement member 62, and controls the state of the retractor 1 by the movement of the arrangement member 62. The deceleration mechanism 80 includes an eccentric member 81 that is a driving body, a rotational gear 82 in a circular shape that is rotatable, a fixed gear 84 including a plurality of teeth (fixed teeth) 83, and a transmission mechanism (rotation transmission mechanism) 85 for transmitting rotation of the rotational gear 82 to the control member 70. The operation member 61, the arrangement member 62, the control member 70, the eccentric member 81, and the rotational gear 82 are formed of a synthetic resin.

The deceleration mechanism 80 is coupled with the winding drum 10 and the control member 70 by the eccentric member 81 and the rotational gear 82. The fixed gear 84 is an internal gear including a plurality of fixed teeth 83. The plurality of fixed teeth 83 of the fixed gear 84 is fixed to the support body 1A of the retractor 1, its position is fixed in the retractor 1 and the switch mechanism 60. Here, the plurality of fixed teeth 83 is formed on the mechanism cover 6A and is arranged in a circular shape concentric with the axis U1 of the winding drum 10. The mechanism cover 6A is a housing member of the locking mechanism 9. Each portion of the switch mechanism 60 and the deceleration mechanism 80 is provided outside the mechanism cover 6A in the drum shaft direction (opposite side of the side where the winding drum 10 is positioned).

The winding spring unit 7 is an urging mechanism of the winding drum 10, and is arranged outside the mechanism cover 6A and the switch mechanism 60 in the drum shaft direction, and is mounted to the mechanism cover 6A. The switch mechanism 60 is positioned between the winding spring unit 7 and the mechanism cover 6A, and is covered with the winding spring unit 7. As described above, the retractor 1 includes a cover member arranged outside the mechanism cover 6A in the drum shaft direction and covering the switch mechanism 60. Here, the cover member includes a cover portion of the winding spring unit 7 covering the switch mechanism 60. The cover portion is a portion positioned on the mechanism cover 6A side of the winding spring unit 7, and includes the spring sheet 7C. The spring sheet 7C is a sheet member covering the switch mechanism 60, and is arranged outside the control member 70 in the drum shaft direction. The control member 70 is adjacent to the spring sheet 7C that is the cover member, and is arranged along the spring sheet 7C. The spring sheet 7C is arranged outside the control member 70 in the drum shaft direction, and regulates action of the control member 70 in the drum shaft direction.

The plurality of fixed teeth 83 (fixed gear 84) and the rotational gear 82 are provided outside the mechanism cover 6A in the drum shaft direction, and mesh with each other (refer to FIG. 13). Furthermore, the plurality of fixed teeth 83 is provided on a face (outside face) 6H which is an outer face of the mechanism cover 6A in the drum shaft direction. Here, the plurality of fixed teeth 83 is integrally formed on the outside face 6H of the mechanism cover 6A in the drum shaft direction, and protrudes outward from the outside face 6H in the drum shaft direction. The rotational gear 82 and the eccentric member 81 are arranged inside the plurality of fixed teeth 83, and are adjacent to the mechanism cover 6A. The outside face 6H of the mechanism cover 6A is a regulation face positioned between the locking mechanism 9 and the rotational gear 82, and regulates action of the rotational gear 82 in the drum shaft direction.

As described above, the gear shaft portion 32 of the locking gear 30 is the shaft portion of the winding drum 10, and is supported by the drum support portion 6D of the mechanism cover 6A. Furthermore, the gear shaft portion 32 passes through the insertion hole 6E of the drum support portion 6D, and protrudes outward from the insertion hole 6E in the drum shaft direction. The eccentric member 81 includes a mounting hole 81A through which the eccentric member 81 is mounted to the gear shaft portion 32 protruding from the insertion hole 6E, and rotates with the gear shaft portion 32 in the mounting hole 81A. When the gear shaft portion 32 is inserted into the mounting hole 81A, the eccentric member 81 is unrotatably mounted to the gear shaft portion 32.

The gear shaft portion 32 passes through the mounting hole 81A of the eccentric member 81, and protrudes outward from the mounting hole 81A in the drum shaft direction. The control member 70 includes a center hole 71 through which the control member 70 is mounted to the gear shaft portion 32 protruding from the mounting hole 81A, and rotates relative to the gear shaft portion 32 in the center hole 71. When the gear shaft portion 32 is inserted into the center hole 71, the control member 70 is rotatably supported by the gear shaft portion 32, and rotates relative to the winding drum 10 about the axis U1 of the winding drum 10. The control member 70 is arranged outside the rotational gear 82 in the drum shaft direction, and is adjacent to the rotational gear 82. Outside the rotational gear 82 in the drum shaft direction, the control member 70 regulates the action of the rotational gear 82 in the drum shaft direction.

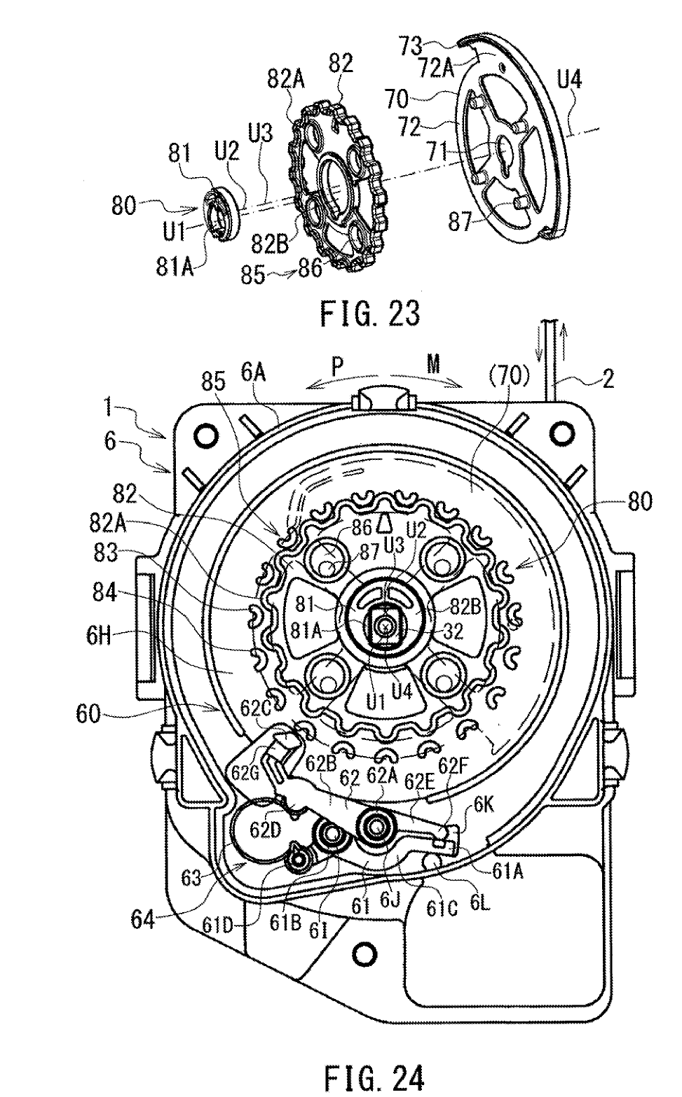

FIG. 23 is a perspective view of the eccentric member 81, the rotational gear 82, and the control member 70, and illustrates a part of FIG. 14. FIG. 24 is a side view of the mechanism cover unit 6, and illustrates a mechanism cover unit 6 viewed in an arrow W4 direction illustrated in FIG. 13. FIG. 24 illustrates the control member 70 by the dotted lines, and illustrates the deceleration mechanism 80 hidden by the control member 70, by the solid lines.

As illustrated in FIG. 24, an outer circumference of the eccentric member 81 is formed in a circular shape, and the mounting hole 81A of the eccentric member 81 is formed to be eccentric with respect to a center of a circular outer circumference of the eccentric member 81 (center U2 of the eccentric member 81). Namely, a center of the mounting hole 81A is not aligned with the center U2 of the eccentric member 81 but is positioned between the center U2 and the outer circumference of the eccentric member 81. When the gear shaft portion 32 is mounted to the mounting hole 81A, the center of the mounting hole 81A is positioned at the axis U1 of the winding drum 10. Furthermore, the center U2 of the eccentric member 81 is positioned a predetermined distance (an amount of eccentricity) away from the axis U1 of the winding drum 10. The eccentric member 81 is a circular eccentric cam, and in a state where the center U2 is eccentric with respect to the axis U1 of the winding drum 10, the eccentric member 81 rotates around the axis U1 (center of the mounting hole 81A) integrally with the winding drum 10. When the eccentric member 81 rotates, the center U2 of the eccentric member 81 rotates and moves about the axis U1 of the winding drum 10.

The rotational gear 82 is an external gear including a plurality of outer circumferential teeth 82A, and includes a center hole 82B in a circular shape and a plurality of transmission round holes 86 in a circular shape that is a part of the transmission mechanism 85. The plurality of outer circumferential teeth 82A is teeth (outer teeth) formed at an outer circumference of the rotational gear 82, and includes a smaller number of teeth than that of the plurality of fixed teeth 83. Here, the rotational gear 82 includes eighteen outer circumferential teeth 82A, and the fixed gear 84 includes nineteen fixed teeth 83. The center hole 82B is a fitting hole formed in a center of the rotational gear 82, and is rotatably fitted to the circular outer circumference of the eccentric member 81. The eccentric member 81 is fitted into the center hole 82B of the rotational gear 82, and the rotational gear 82 is rotatably mounted to the eccentric member 81 in the center hole 82B. An axis (rotation center) U3 of the rotational gear 82 is aligned with the center U2 of the eccentric member 81 and is positioned a predetermined distance (an amount of eccentricity) away from the axis U1 of the winding drum 10. The eccentric member 81 rotates in the center hole 82B to thereby move the rotational gear 82 along the plurality of fixed teeth 83.

The plurality of fixed teeth 83, the rotational gear 82, and the eccentric member 81 are positioned outside the mechanism cover 6A in the drum shaft direction, between the mechanism cover 6A and the control member 70. An inner diameter of the fixed gear 84 is larger than an outer diameter of the rotational gear 82, and the plurality of fixed teeth 83 surrounds the eccentric member 81 and the rotational gear 82. The plurality of fixed teeth 83 is a larger number of inner teeth than that of the plurality of outer circumferential teeth 82A, and meshes with the outer circumferential teeth 82A of the rotational gear 82. Furthermore, the plurality of fixed teeth 83 is positioned on the same circle concentric with the axis U1 of the winding drum 10, and is arranged at regular intervals in a circumferential direction of the circle. Meanwhile, the plurality of fixed teeth 83 may be a meshing portion where the fixed teeth 83 mesh with the rotational gear 82 rotating inside the fixed teeth. Therefore, for example, the plurality of fixed teeth 83 may be formed at an inner circumference of a circle portion, or may be a plurality of protrusions arranged in a circular shape in a state where the fixed teeth 83 are separated from each other.

Inside the plurality of fixed teeth 83, the rotational gear 82 is rotatably supported by the eccentric member 81 in a state where a rotational center of the rotational gear 82 is eccentric with respect to the axis U1 of the winding drum 10, and rotates relative to the eccentric member 81. Rotational centers of the eccentric member 81 and the rotational gear 82 are eccentric with respect to the plurality of fixed teeth 83, and the rotational gear 82 comes into contact with a part of the plurality of fixed teeth 83. A gap is formed between the rotational gear 82 and the fixed teeth 83, except for the fixed teeth 83 being in contact with the rotational gear 82. By the rotation of the eccentric member 81, in a state where a rotational center of the rotational gear 82 is eccentric with respect to the axis U1 of the winding drum 10, the eccentric member 81 that is rotating moves the rotational gear 82 along the plurality of fixed teeth 83.

When the eccentric member 81 rotates once, the rotational gear 82 moves one round along the plurality of fixed teeth 83 inside the plurality of fixed teeth 83. While moving of the rotational gear 82, the rotational gear 82 sequentially comes into contact with a part of the plurality of fixed teeth 83, and a part of the plurality of fixed teeth 83 sequentially meshes with a part of the plurality of outer circumferential teeth 82A. Through this meshing, the rotational gear 82 interlocks with the rotation of the winding drum 10 and the eccentric member 81, to thereby rotate around the axis U3 (center U2). The rotational gear 82 moves while rotating, and rolls along the plurality of fixed teeth 83. By the rotation of the rotational gear 82, the axis U3 of the rotational gear 82 rotates and moves about the axis U1 of the winding drum 10.

The plurality of transmission round holes 86 of the rotational gear 82 includes two or more circular holes formed in a circular shape having the same inner diameter and is formed with an interval each other at a position a predetermined distance away from the axis U3 of the rotational gear 82. Furthermore, between the center hole 82B and the outer circumferential teeth 82A, the plurality of transmission round holes 86 is formed in the rotational gear 82 with 180 degrees or less intervals (angular interval) in a circumferential direction concentric with the axis U3 of the rotational gear 82. Here, the plurality of transmission round holes 86 is arranged at regular intervals (equal angular interval) in the circumferential direction of a circle (same circle) concentric with the axis U3 of the rotational gear 82, and is positioned on the same circle concentric with the axis U3. More specifically, four transmission round holes 86 are arranged at 90 degrees intervals in the circumferential direction concentric with the axis U3, surrounding the center hole 82B, and are positioned at the same distance away from the axis U3.

Meanwhile, when the position and interval of the transmission round hole 86 are specified with respect to the retractor 1, the position and interval thereof are specified with reference to a center of the transmission round hole 86. Therefore, the position of the transmission round hole 86 is a position of a center thereof, and the intervals among the transmission round holes 86 are intervals among the centers of the transmission round holes 86. For example, when the plurality of transmission round holes 86 is positioned on the same circle, the centers of the plurality of transmission round holes 86 are positioned on the same circle. When the intervals among the plurality of transmission round holes 86 are 180 degrees or less intervals in the circumferential direction, the intervals among the centers of the plurality of transmission round holes 86 are 180 degrees or less intervals therein. Further, when the plurality of transmission round holes 86 is formed with 180 degrees or less intervals in the circumferential direction, the plurality of transmission round holes 86 is formed such that none of the intervals among the plurality of transmission round holes 86 in the circumferential direction is larger than 180 degrees intervals and thus all the intervals are 180 degrees or less. Such a state is referred to as 180 degrees or less intervals. Therefore, in the rotational gear 82 having two transmission round holes 86, two transmission round holes 86 are formed 180 degrees intervals such that the interval is not larger than 180 degrees intervals.

The control member 70 includes the center hole 71, an outer circumferential portion 72 in a circular shape, an outer edge convex portion 73 in a circular-arc shape formed on the outer circumferential portion 72, and a plurality of transmission protrusions 87 in a post-like shape (here, columnar shape) that is a part of the transmission mechanism 85. The outer edge convex portion 73 is formed on a part of the outer circumferential portion 72, and protrudes from the control member 70 toward the mechanism cover 6A. The outer edge convex portion 73 of the control member 70 is formed from an outside of the rotational gear 82 in the drum shaft direction toward the mechanism cover 6A, and is arranged outside the plurality of fixed teeth 83 in a radial direction of the control member 70.

An axis (rotation center) U4 of the control member 70 is aligned with the axis U1 of the winding drum 10, and the control member 70 is coaxial with the winding drum 10. Furthermore, the axis U4 of the control member 70 is positioned a predetermined distance away from the axis U3 of the rotational gear 82, and the rotational gear 82 rotates in a state where a rotational center of the rotational gear 82 is eccentric with respect to the axis U4 of the control member 70. By the rotation of the rotational gear 82, the control member 70 rotates by interlocking with the rotation of the rotational gear 82 around the axes U1 and U4.

The plurality of transmission protrusions 87 includes two or more columnar portions formed in a columnar shape having the same outer diameter and is formed with an interval each other at a position a predetermined distance away from the axis U4 of the control member 70. Moreover, between the center hole 71 and the outer circumferential portion 72, the plurality of transmission protrusions 87 is formed on the control member 70 with 180 degrees or less intervals (angular interval) in a circumferential direction concentric with the axis U4 of the control member 70. Here, the plurality of transmission protrusions 87 is arranged at regular intervals (equal angular interval) in the circumferential direction of a circle (same circle) concentric with the axis U4 of the control member 70, and is positioned on the same circle concentric with the axis U4. More specifically, the same number (four) of the transmission protrusions 87 as that of the plurality of transmission round holes 86 are arranged with 90 degrees intervals in the circumferential direction concentric with the axis U4 as surrounding the center hole 71, and are positioned at the same distance away from the axis U4. The plurality of transmission protrusions 87 is arranged on a circle having a same diameter as that of a circle on which the plurality of transmission round holes 86 is arranged.

When the position and interval of the transmission protrusion 87 are specified with respect to the retractor 1, the position and interval thereof are specified with reference to a center of the transmission protrusion 87. Therefore, the position of the transmission protrusion 87 is a position of a center of the transmission protrusion 87, and the intervals among the transmission protrusions 87 are the intervals among the centers of the transmission protrusions 87. For example, when the plurality of transmission protrusions 87 is positioned on the same circle, the centers of the plurality of protrusions 87 are positioned on the same circle. When the intervals among the plurality of transmission protrusions 87 are 180 degrees or less intervals in the circumferential direction, the intervals among the centers of the plurality of transmission protrusions 87 are 180 degrees or less intervals in the circumferential direction. Further, when the plurality of transmission protrusions 87 is formed with 180 degrees or less intervals in the circumferential direction, the plurality of transmission protrusions 87 is formed such that none of the intervals among the plurality of transmission protrusions 87 in the circumferential direction is larger than 180 degrees intervals and thus all the intervals are 180 degrees or less. Such a state is referred to as 180 degrees or less intervals. Therefore, in the control member 70 having two transmission protrusions 87, two transmission protrusions 87 are formed with 180 degrees intervals such that the interval is not larger than 180 degrees.

The transmission mechanism 85 includes the plurality of transmission round holes 86, and each of the plurality of transmission protrusions 87 that is always movable in the transmission round hole 86. When, in a state where the axis U3 of the rotational gear 82 and the axis U4 of the control member 70 are aligned with each other, the rotational gear 82 and the control member 70 are combined with each other, the positions of the plurality of transmission round holes 86 and those of the plurality of transmission protrusions 87 are aligned with each other. Each of the plurality of transmission protrusions 87 is inserted into the corresponding transmission round hole 86 and is arranged therein. Here, the transmission mechanism 85 includes plural pairs of transmission round hole 86 and transmission protrusion 87 including the plurality of transmission round holes 86 and the plurality of transmission protrusions 87 that are arranged with equal angular interval in each circumferential direction. With the plural pairs of transmission round hole 86 and transmission protrusion 87, the transmission mechanism 85 sequentially transmits the rotation of the rotational gear 82 to the control member 70, and rotates the control member 70 in the same direction as the rotational direction of the rotational gear 82.

The plurality of transmission protrusions 87 is formed so as to have a predetermined outer diameter smaller than an inner diameter of the transmission round hole 86, and is respectively formed at a position corresponding to the plurality of transmission round holes 86. Each of the plurality of transmission protrusions 87 is arranged in the corresponding transmission round hole 86, and when the rotational gear 82 rotates, each of the plurality of transmission protrusions 87 moves in the transmission round hole 86. When the axis U3 of the rotational gear 82 is aligned with the axis U4 of the control member 70, as to each of the plural pairs of transmission round hole 86 and transmission protrusion 87, the center of the transmission protrusion 87 is aligned with the center of the transmission round hole 86. From the state described above, when a rotational center of the rotational gear 82 is eccentric with respect to the winding drum 10 and the control member 70, the transmission protrusion 87 moves relative to an inner circumferential side of the transmission round hole 86 to thereby come into contact with an inner circumference (inner circumferential face) of the transmission round hole 86. The transmission mechanism 85 transmits the rotation of the rotational gear 82 to the control member 70 while the inner circumference of the transmission round hole 86 being in contact with an outer circumference of the transmission protrusion 87.

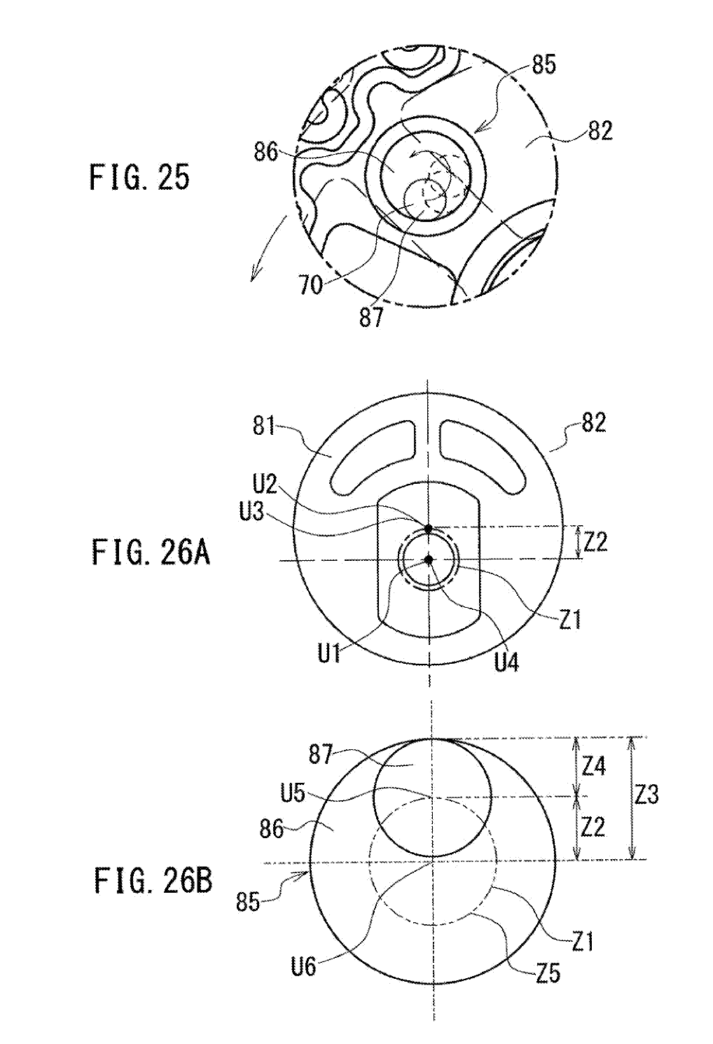

FIG. 25 illustrates a pair of transmission round hole 86 and transmission protrusion 87, and illustrates a part of FIG. 24.

As illustrated in FIG. 25, when the rotational gear 82 rotates, the transmission protrusion 87 of the control member 70 moves along the inner circumference of the transmission round hole 86, and is pressed by the inner circumference thereof. Therefore, the rotation of the rotational gear 82 is transmitted to the control member 70 to rotate the control member 70.

FIGS. 26A, 26B illustrate relationships between the rotational gear 82 and the transmission mechanism 85.

As illustrated in FIGS. 26A and 26B, when the rotational gear 82 moves along the plurality of fixed teeth 83, a track of the axis Z1 of the rotational gear 82 is shaped in a circle having a predetermined diameter (refer to FIG. 26A). The track of the axis Z1 is a track of the axis U3 of the rotational gear 82 moved by the eccentric member 81 along the plurality of fixed teeth 83. The track of the axis Z1 of the rotational gear 82 is shaped in a circle concentric with the axis U1 of the winding drum 10, and is aligned with a track of the center U2 of the eccentric member 81 rotating together with the winding drum 10. A radius of the track of the axis Z1 is a distance from the axis U1 to the axis U3 (center U2), and an amount of eccentricity Z2 of the rotational gear 82 (eccentric member 81) with respect to the winding drum 10.

A radius Z3 of the transmission round hole 86 is set to be a sum (Z2+Z4) of the amount of eccentricity Z2 of the rotational gear 82 and a radius Z4 of the transmission protrusion 87 (refer to FIG. 26B). When the transmission round hole 86 is formed in a circle having the radius Z3, the track of the axis Z1 of the rotational gear 82 is shaped to be aligned with a track of a center Z5 of the transmission protrusion 87 in the transmission round hole 86. The track of the center Z5 is a track of a center U5 of the transmission protrusion 87 in the transmission round hole 86 when the transmission protrusion 87 moves one round as being in contact with the inner circumference of the transmission round hole 86. The center U5 of the transmission protrusion 87 is a center of the transmission protrusion 87, a part of which is in contact with the inner circumference of the transmission round hole 86. The track of the center Z5 is positioned at a center U6 of the transmission round hole 86. Furthermore, the track of the center Z5 of the transmission protrusion 87 is shaped in a circle having a same diameter as that of the circular track of the axis Z1 of the rotational gear 82. Therefore, the transmission protrusion 87 smoothly moves along the inner circumference of the transmission round hole 86 along with the movement and rotation of the rotational gear 82.

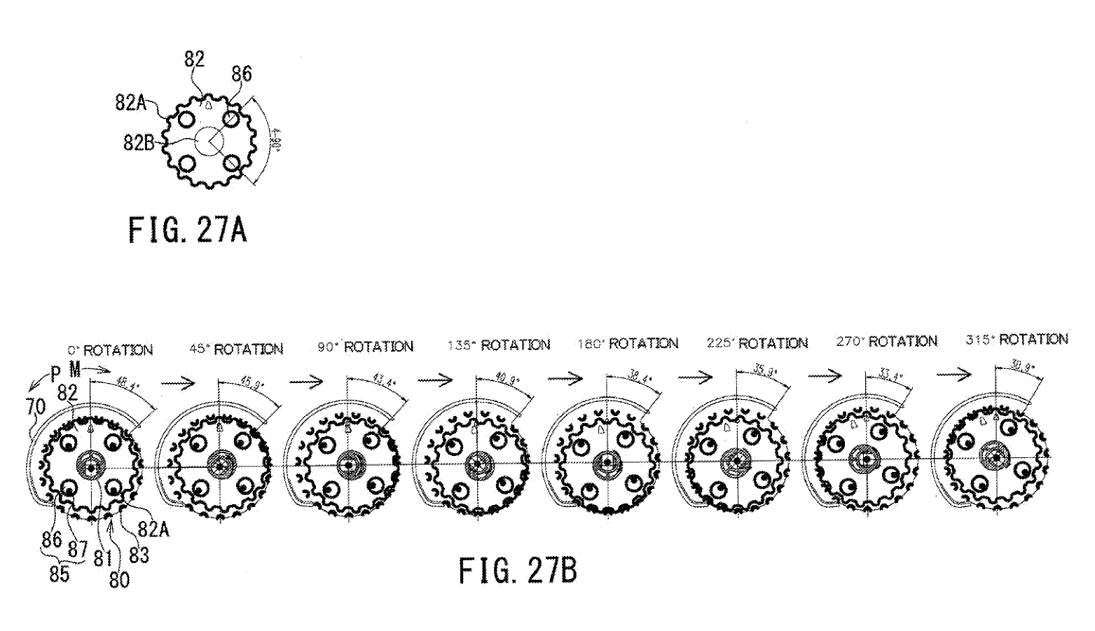

FIGS. 27A, 27B illustrate actions of the deceleration mechanism 80, and illustrate a part of the deceleration mechanism 80 and the control member 70 corresponding to FIG. 24. However, FIG. 27A illustrates only the rotational gear 82. FIG. 27B sequentially illustrates the actions of the deceleration mechanism 80 from the left to the right when the winding drum 10 rotates in the winding direction “M” of the webbing 2. Further, FIG. 27B illustrates the eccentric member 81 rotating each 45 degrees in the winding direction “M” by the rotation of the winding drum 10, and also illustrates a state of the rotational gear 82 and the control member 70 changing by the rotation of the eccentric member 81.

As illustrated in FIG. 27B, the eccentric member 81 rotates together with the winding drum 10 in a state where the center U2 is eccentric with respect to the axis U1 of the winding drum 10. The rotational gear 82 moves along the plurality of fixed teeth 83 by the eccentric member 81, while sequentially contacting with a part of the fixed teeth inside the plurality of fixed teeth 83. When the rotational gear 82 moves in an arrangement direction (circumferential direction) of the plurality of fixed teeth 83, the plurality of outer circumferential teeth 82A sequentially meshes with the fixed teeth 83 to gradually rotate the rotational gear 82. While the rotational gear 82 moves one round along the plurality of fixed teeth 83, the rotational gear 82 rotates in an opposite direction of the rotational direction of the winding drum 10 and the eccentric member 81 by an amount of difference between the number of outer circumferential teeth 82A and that of fixed teeth 83. Therefore, the rotational gear 82 rotates at a rotational speed slower than that of the winding drum 10.

Here, the eccentric member 81 rotating in the winding direction “M” moves the rotational gear 82 one round along the plurality of fixed teeth 83 and, then, the rotational gear 82 rotates in the drawing-out direction “P” by an angle corresponding to one outer circumferential tooth 82A. More specifically, since the eighteen outer circumferential teeth 82A are provided, the angle corresponding to one outer circumferential tooth 82A is one eighteenth of 360 degrees (20 degrees). The rotational gear 82 rotates 2.5 degrees each time the eccentric member 81 rotates 45 degrees and, when the eccentric member 81 rotates 360 degrees, the rotational gear 82 rotates 20 degrees.

As described above, inside the plurality of fixed teeth 83, the eccentric member 81 and the plurality of fixed teeth 83 rotate the rotational gear 82 at a decelerated speed than that of the winding drum 10. At this time, by the rotation of the eccentric member 81, the rotational gear 82 sequentially meshes with each of the fixed teeth 83 and rotates at the decelerated speed than that of the winding drum 10, while moving along the plurality of fixed teeth 83. While the rotational gear 82 is rotating, the transmission protrusion 87 is pressed by the inner circumference of the transmission round hole 86 from behind in the rotational direction of the rotational gear 82. Namely, the inner circumference of one transmission round hole 86 presses the transmission protrusion 87 in the rotational direction of the rotational gear 82 with a half portion (range of 180 degrees) (referred to as a transmission portion) behind in the rotational direction of the rotational gear 82. Therefore, in order to always transmit the rotation of the rotational gear 82 to the control member 70 by the transmission round hole 86 and the transmission protrusion 87, two or more pairs of transmission round hole 86 and transmission protrusion 87 need to be provided with 180 degrees or less intervals. The plurality of transmission round holes 86 and the plurality of transmission protrusions 87 are formed with 180 degrees or less intervals respectively, so as to satisfy the condition described above. Furthermore, the track of the center Z5 of the transmission protrusion 87 is shaped in a circle having a same diameter as that of the circular track of the axis Z1 of the rotational gear 82.

In the transmission mechanism 85 including such transmission round hole 86 and transmission protrusion 87, when the rotational gear 82 rotates, each of the plurality of transmission protrusions 87 smoothly moves in the transmission round hole 86. Furthermore, at least one pair of the plural pairs of transmission round hole 86 and transmission protrusion 87 is maintained in a state where the outer circumference of the transmission protrusion 87 is in contact with the transmission portion of the inner circumference of the transmission round hole 86. By the movement and rotation of the rotational gear 82, each transmission protrusion 87 may separate away from the transmission portion of the transmission round hole 86, but all the transmission protrusions 87 do not separate away from the transmission portions of the transmission round holes 86 at a time. At least one of the plurality of transmission protrusions 87 comes into contact with the inner circumference of one of the plurality of transmission round holes 86 behind in the rotational direction of the rotational gear 82 (transmission portion), and thus, is pressed by the inner circumference of the transmission round hole 86, while moving along the inner circumference of the transmission round hole 86. When at least one transmission protrusion 87 is pressed by the transmission portion of the transmission round hole 86, the plurality of transmission protrusions 87 always transmits the rotation of the rotational gear 82 to the control member 70. Therefore, the control member 70 is rotated. The rotational gear 82 and the control member 70 are rotated at a predetermined angle each time the rotational gear 82 moves one round.

In a state where at least one transmission protrusion 87 is in contact with the transmission portion of the transmission round hole 86, each of the plurality of transmission protrusions 87 moves in the transmission round hole 86. By the movement described above, the control member 70 smoothly rotates together with the rotational gear 82, and the rotation of the control member 70 accurately synchronizes with the rotation of the rotational gear 82. Furthermore, the change of a ratio between an amount of rotation of the winding drum 10 and that of the control member 70 is prevented. Even when the rotational direction of the rotational gear 82 is changed, the transmission mechanism 85 correctly transmits the rotation of the rotational gear 82 to the control member 70. Therefore, the control member 70 rotates by correctly interlocking with the rotation of the winding drum 10. The deceleration mechanism 80 decelerates the rotation of the winding drum 10 in the winding direction “M” and the drawing-out direction “P”, to thereby transmit the rotation of the winding drum 10 from the eccentric member 81 to the control member 70. Therefore, the control member 70 is rotated at the rotational speed slower than that of the winding drum 10, and in the opposite direction of the rotational direction of the winding drum 10. Here, while the entire webbing 2 is being drawn out, the control member 70 rotates by a predetermined angle of 360 degrees or less.

The control member 70 (refer to FIGS. 13 and 14) is a deceleration member rotating at a decelerated speed than that of the winding drum 10, and on the basis of a rotational angle, controls the state of the retractor 1. The deceleration mechanism 80 rotates the control member 70 by interlocking with the rotation of the winding drum 10 (drawing-out of the webbing 2 from the winding drum 10 and winding of the webbing 2 onto the winding drum 10). Therefore, the control member 70 rotates corresponding to a drawing-out length of the webbing 2 drawn out from the winding drum 10 and a winding length of the webbing 2 wound onto the winding drum 10, to thereby control the state of the retractor 1.

The switch mechanism 60 controls the state of the retractor 1 by the rotating control member 70, to thereby switch the state thereof between the ELR state and the ALR state. At this time, the switch mechanism 60 controls an operation of the locking mechanism 9 by the control member 70, to thereby switch the locking mechanism 9 between the operation state and the waiting state, and switch the state of the retractor 1. The switch mechanism 60 controls the states of the locking mechanism 9 and the retractor 1 depending on the drawing-out length and the winding length of the webbing 2 to switch the states thereof. Furthermore, the control member 70 is a cam member to move the arrangement member 62 by rotation and controls a position of the operation member 61 via the arrangement member 62. The switch mechanism 60 controls positions of the arrangement member 62 and the operation member 61 by the control member 70 to thereby switch the states of the locking mechanism 9 and the retractor 1.

The arrangement member 62 is a cam follower driven by the control member 70, and is a switch lever for switching the states of the locking mechanism 9 and the retractor 1. The operation member 61 is an interlock member for interlocking with the arrangement member 62, and is an operation switch (switch) for switching the locking mechanism 9 between an operation and a non-operation. The locking mechanism 9 is operated by the operation member 61 to thereby stop the rotation of the winding drum 10 in the drawing-out direction “P”. The mechanism cover 6A includes, outside the plurality of fixed teeth 83, first and second rotational shafts (shafts for rotation) 6I and 6J in a columnar shape, and a through opening 6K positioned near the opening 6F. The first rotational shaft 6I is an operation-member rotational shaft, and the operation member 61 is rotatably mounted to the first rotational shaft 6I. The second rotational shaft 6J is an arrangement-member rotational shaft, and the arrangement member 62 is rotatably mounted to the second rotational shaft 6J.

The operation member 61 includes a press portion 61A protruding toward the mechanism cover 6A. In the same way as the acceleration sensor 3B, the press portion 61A presses the meshing pawl 13 to thereby operate the locking mechanism 9. The press portion 61A is inserted into the through opening 6K, and moves therein. Furthermore, in the same way as the lock claw 3G (refer to FIGS. 21A and 21B) of the acceleration sensor 3B, the press portion 61A is positioned near the meshing pawl 13, and moves upward by a movement of the operation member 61 to press the meshing pawl 13 upward. The operation member 61 moves the meshing pawl 13 from the non-mesh position C1 to the mesh position C2, and meshes with the teeth 33 of the ratchet wheel 34. When the meshing pawl 13 moves to the mesh position C2, the clutch 50 is coupled with the locking gear 30 by the meshing pawl 13 and the ratchet wheel 34. Subsequently, the locking mechanism 9 is operated in the same way as described above (refer to FIGS. 22A and 22B).

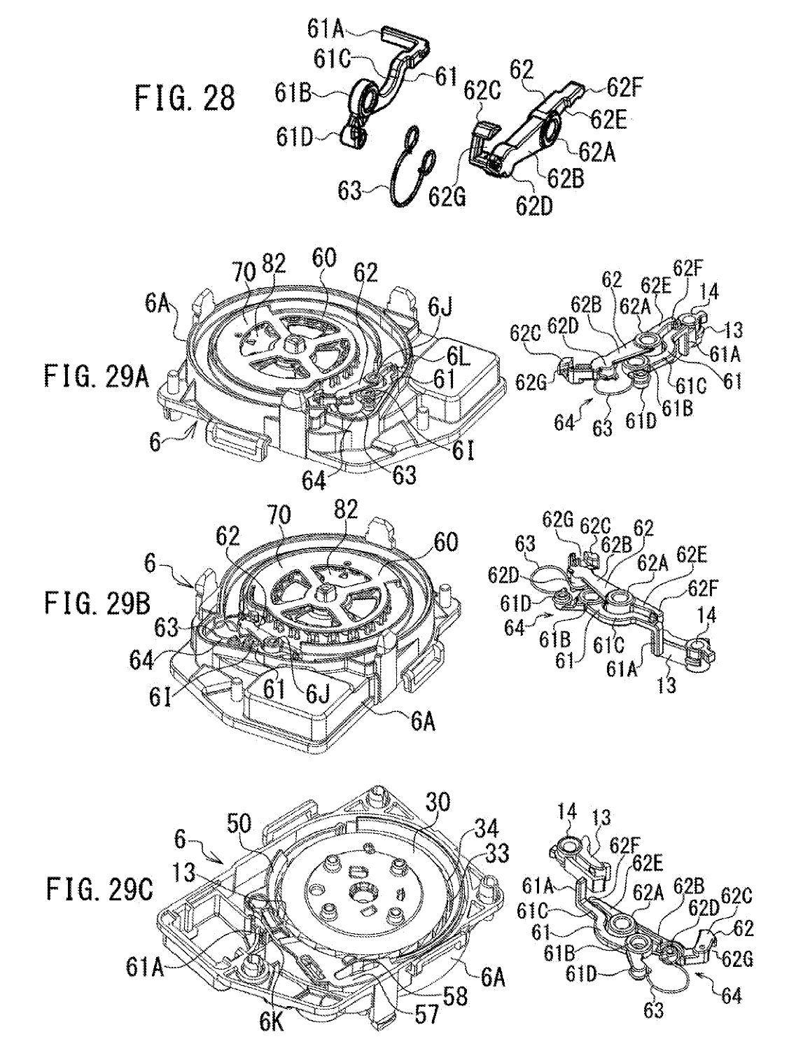

FIG. 28 is a perspective view of the operation member 61, the arrangement member 62, and the urging means 63, and illustrates a part of FIG. 13. FIGS. 29A to 29C are perspective views of the mechanism cover unit 6, and illustrate the mechanism cover unit 6 viewed in three directions. Furthermore, FIGS. 29A to 29C illustrate the operation member 61, the arrangement member 62, the urging means 63, and the meshing pawl 13 in the mechanism cover unit 6.

As illustrated in FIGS. 29A to 29C, when each portion of the switch mechanism 60 is mounted to the mechanism cover 6A, the operation member 61 and the arrangement member 62 are mounted to different shafts 6I and 6J, and are rotatably combined by interlocking with each other. The urging means 63 includes an elastically-deformable urging member (spring, rubber, elastic member and the like) (here, spring formed of linear material made of steel), and is mounted to the operation member 61 and the arrangement member 62. The urging means 63 is operation-member urging means and also arrangement-member urging means, and urges the operation member 61 and the arrangement member 62 in a predetermined direction respectively.

The operation member 61 includes a mounting portion 61B in a cylindrical shape mounted to the first rotational shaft 6I, an arm portion 61C protruding from the mounting portion 61B, and an urging portion 61D urged by the urging means 63. The operation member 61 rotates about the mounting portion 61B (first rotational shaft 6I) to thereby move in a rotational direction. The press portion 61A of the operation member 61 is formed at a leading end of the arm portion 61C. The urging portion 61D is formed on the mounting portion 61B on an opposite side of the arm portion 61C.

The arrangement member 62 includes a mounting portion 62A in a cylindrical shape mounted to the second rotational shaft 6J, an arm portion 62B protruding from the mounting portion 62A, a contact portion 62C coming into contact with the control member 70, an urging portion 62D urged by the urging means 63, an action protrusion 62E acting on the operation member 61, and a passage portion 62G for the control member 70. The arrangement member 62 rotates about the mounting portion 62A (second rotational shaft 6J), and moves in a rotational direction. The contact portion 62C and the urging portion 62D are formed at a leading end of the arm portion 62B. The action protrusion 62E is shorter than the arm portion 62B, and protrudes from the mounting portion 62A toward an opposite side of the arm portion 62B. The arm portion 61C of the operation member 61 is arranged along the mounting portion 62A and the action protrusion 62E of the arrangement member 62. An action portion 62F is formed at a leading end of the action protrusion 62E to come into contact with the arm portion 61C of the operation member 61. The arm portion 62B of the arrangement member 62 is arranged on the urging portion 61D side of the operation member 61. In a state where the action portion 62F is in contact with the arm portion 61C, the urging portions 61D and 62D are arranged with a space therebetween. The passage portion 62G includes a concave portion formed on the contact portion 62C.

Two circular end portions of the urging means 63 are each mounted to the urging portion 61D of the operation member 61 and the urging portion 62D of the arrangement member 62. The urging means 63 urges the operation member 61 and the arrangement member 62 with a same force (urging force) in a direction where the urging portion 61D and the urging portion 62D separate away from each other. By the urging force described above, torque (rotational moment) acts on the operation member 61 and the arrangement member 62. A distance between a rotational center of the arrangement member 62 and the urging portion 62D is longer than a distance between a rotational center of the operation member 61 and the urging portion 61D. Therefore, when the torque acts on the operation member 61 and the arrangement member 62 by the urging force of the urging means 63, the torque acting on the arrangement member 62 is larger than the torque acting on the operation member 61. Moreover, a distance between the rotational center of the arrangement member 62 and the action portion 62F is shorter than a distance between the rotational center of the operation member 61 and a position of the arm portion 61C that comes into contact with the action portion 62F. As a result, a force applied from the action portion 62F to the arm portion 61C is larger than a force applied from the arm portion 61C to the action portion 62F. The arm portion 61C is pressed and moved by the action portion 62F.

The arrangement member 62 rotates (moves) while pressing the arm portion 61C. At the same time, the operation member 61 rotates, and thus the arm portion 61C comes into contact with a stopper 6L (refer to FIG. 24) of the mechanism cover 6A. The stopper 6L maintains the operation member 61 and the arrangement member 62 at a position where the locking mechanism 9 is not operated by the operation member 61. The operation member 61 does not press the meshing pawl 13 by the press portion 61A, and arranges the meshing pawl 13 at the non-mesh position C1. The switch mechanism 60 does not operate the locking mechanism 9, and maintains the locking mechanism 9 in the waiting state. From the state described above, the contact portion 62C comes into contact with the control member 70 to thereby be moved by the control member 70 against the urging force of the urging means 63. By a movement of the contact portion 62C, the arrangement member 62 rotates (moves) to thereby move the action portion 62F. At the same time, by the urging force of the urging means 63, in a state where the arm portion 61C is in contact with the action portion 62F, the operation member 61 is rotated. As described above, the arrangement member 62 and the operation member 61 rotate by interlocking with each other.

When the operation member 61 moves in a direction of separating away from the stopper 6L, the operation member 61 presses the meshing pawl 13 toward the ratchet wheel 34 by the press portion 61A, and then, arranges the meshing pawl 13 at the mesh position C2. Furthermore, the control member 70 maintains the arrangement member 62 at a position where the locking mechanism 9 is operated by the operation member 61, against the urging force of the urging means 63. At the same time, the operation member 61 is maintained at a position for operating the locking mechanism 9 by the urging force of the urging means 63. The switch mechanism 60 operates the locking mechanism 9, and thus the locking mechanism 9 is maintained in the operation state.

In the state described above, when the ratchet wheel 34 rotates in the winding direction “M”, the meshing pawl 13 is displaced along the teeth 33 of the ratchet wheel 34 and is pressed outward in the radial direction of the ratchet wheel 34. Along with the state described above, the meshing pawl 13 presses the press portion 61A and thus the arm portion 61C is separated away from the action portion 62F. As a result, the operation member 61 rotates to thereby further compress the urging means 63. The press portion 61A is maintained in a state being in contact with the meshing pawl 13, by the urging force of the urging means 63, and then, is displaced according to the displacement of the meshing pawl 13. Therefore, the retractor 1 includes a displacement mechanism 64 for displacing of the operation member 61 constituted as described above.

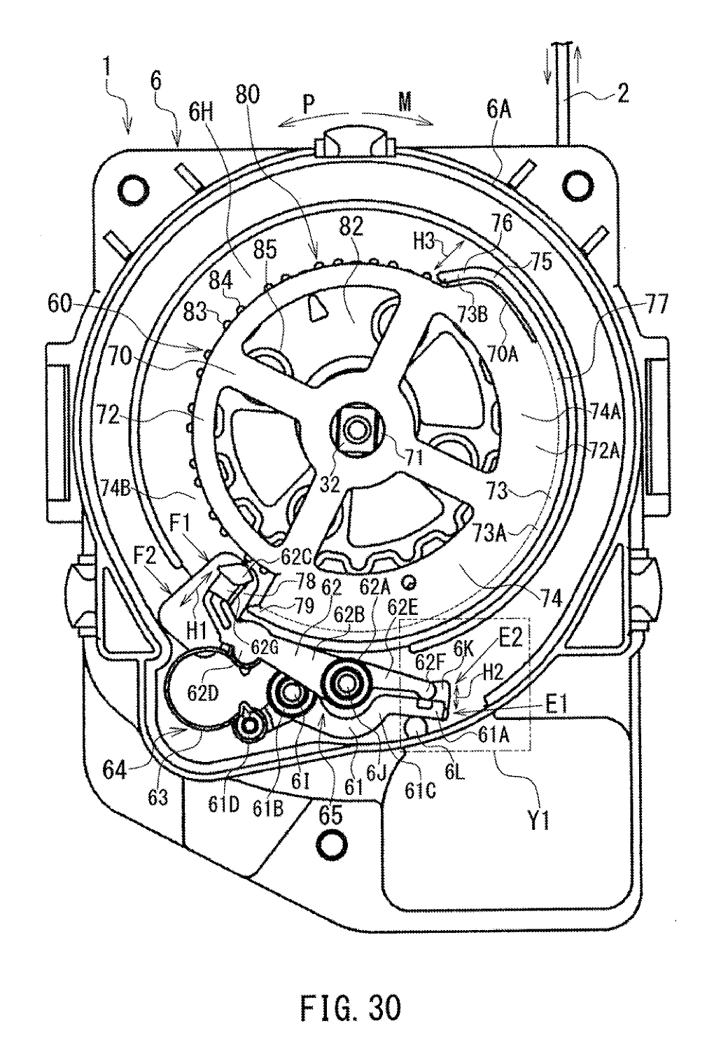

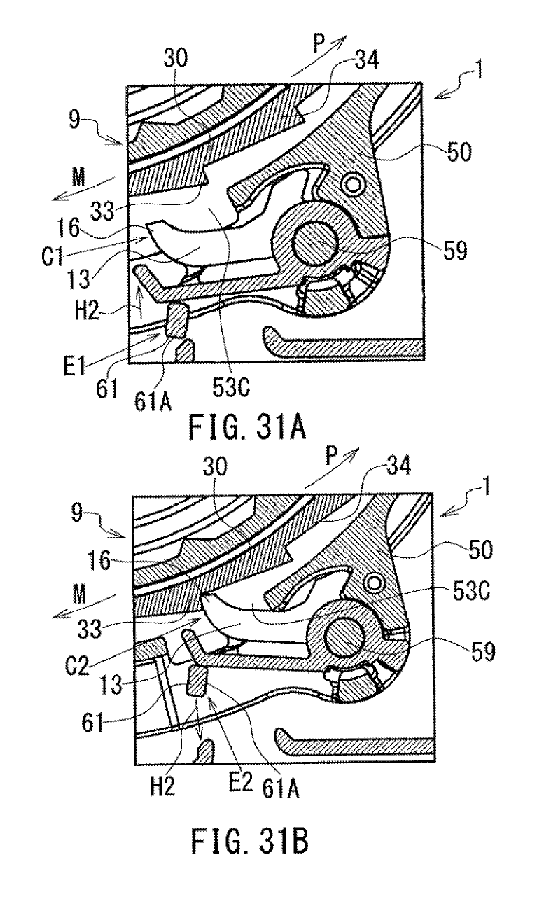

FIG. 30 is a side view of the mechanism cover unit 6, and illustrates the mechanism cover unit 6 viewed in an arrow W4 direction illustrated in FIG. 13. FIGS. 31A and 31B are cross-sectional views of a Y1 portion illustrated in FIG. 30. FIG. 31A illustrates the meshing pawl 13 arranged at the non-mesh position C1. FIG. 31B illustrates the meshing pawl 13 arranged at the mesh position C2.

As illustrated in FIG. 30, the operation member 61 and the arrangement member 62 rotate about the rotational shafts 6I and 6J, respectively, to thereby move in the rotational direction. That is, the retractor 1 includes rotation means 65 for rotating to thereby move the operation member 61 and the arrangement member 62, and the rotation means 65 includes two rotational shafts 6I and 6J. The arrangement member 62 is rotated to move by the rotation means 65 together with the operation member 61 (arrow H1 illustrated in FIG. 30). By interlocking with the movement (rotation) of the arrangement member 62, the operation member 61 is rotated to move (arrow H2 in FIGS. 30, 31A and 31B). Therefore, the operation member 61 moves (rotates) to the non-operation position E1 where the locking mechanism 9 is not operated or the operation position E2 where the locking mechanism 9 is operated.

The non-operation position E1 of the operation member 61 is a position where the meshing pawl 13 is arranged at the non-mesh position C1 (refer to FIG. 31A). The operation member 61 moves to the non-operation position E1 to arrange the meshing pawl 13 at the non-mesh position C1. The meshing pawl 13 does not mesh with the teeth 33 of the ratchet wheel 34, and thus the locking mechanism 9 is maintained in the waiting state. The operation position E2 of the operation member 61 is a position where the meshing pawl 13 is arranged at the mesh position C2 (refer to FIG. 31B). The operation member 61 moves to the operation position E2 to thereby arrange the meshing pawl 13 at the mesh position C2. The meshing pawl 13 is pressed by the press portion 61A to thereby mesh with the teeth 33 of the ratchet wheel 34. The locking mechanism 9 is maintained in the operation state. The operation member 61 is moved from the non-operation position E1 to the operation position E2 by the arrangement member 62, to thereby operate the locking mechanism 9 with the meshing pawl 13. When the teeth 33 and the meshing pawl 13 are meshed with each other, the locking mechanism 9 is operated.

The urging means 63 always urges the operation member 61 toward the operation position E2, and the press portion 61A presses the meshing pawl 13. When the meshing pawl 13 comes into contact with the ratchet wheel 34, the press portion 61A presses the meshing pawl 13 to the ratchet wheel 34. In contrast to this, the urging means 63 always urges the arrangement member 62 in a direction in which the operation member 61 is moved to the non-operation position E1 (direction in which the press portion 61A is separated away from the meshing pawl 13). As illustrated in FIG. 30, the urging means 63 urges the operation member 61 so as to rotate in a counter-clockwise direction and urges the arrangement member 62 so as to rotate in a clockwise direction.

Due to the difference in the torque described above, the operation member 61 is pressed by the arrangement member 62 to thereby come into contact with the stopper 6L (refer to FIG. 30). In the state described above, the contact portion 62C of the arrangement member 62 is positioned near the fixed teeth 83, and the arrangement member 62 is arranged at a first position F1. The first position F1 of the arrangement member 62 is a position where the operation member 61 is arranged at the non-operation position E1, and the arrangement member 62 arranges the operation member 61 at the non-operation position E1. From the state described above, the arrangement member 62 moves toward a second position F2 outside the first position F1 to be arranged at the second position F2. The second position F2 is a position where the operation member 61 is arranged at the operation position E2. By the movement of the arrangement member 62, by the urging force of the urging means 63, the operation member 61 is moved toward the operation position E2, and thus the press portion 61A approaches the meshing pawl 13.

The arrangement member 62 is rotated by the rotation means 65 to be arranged at the first position F1 or the second position F2. At the same time, the arrangement member 62 moves together with the operation member 61 to arrange the operation member 61 at the non-operation position E1 or the operation position E2. The urging means 63 urges the arrangement member 62 toward the first position F1. The arrangement member 62 is moved from the second position F2 to the first position F1 by the urging force of the urging means 63, and the operation member 61 is moved from the operation position E2 to the non-operation position E1.

When the control member 70 moves the arrangement member 62 from the first position F1 to the second position F2, the operation member 61 is moved from the non-operation position E1 to the operation position E2 by the urging force of the urging means 63. Therefore, the meshing pawl 13 is pressed to the ratchet wheel 34 (refer to FIG. 31B). The meshing pawl 13 meshes with only the teeth 33 of the ratchet wheel 34 rotating in the drawing-out direction “P”. In the state described above, when the ratchet wheel 34 rotates in the winding direction “M” together with the winding drum 10, the meshing pawl 13 is pressed by the teeth 33 as described above. The meshing pawl 13 is displaced along the teeth 33, and sequentially transfers from tooth to tooth of the plurality of teeth 33. By the displacement of the meshing pawl 13, in a state where the arrangement member stops, the displacement mechanism 64 displaces the operation member 61 against the urging force of the urging means 63.

In a state where the arrangement member 62 is maintained at the second position F2, through the displacement mechanism 64, the meshing pawl 13 is displaced along the teeth 33 of the ratchet wheel 34 rotating in the winding direction “M” together with the winding drum 10. Therefore, during the rotation of the ratchet wheel 34 in the winding direction “M”, the meshing pawl 13 is reliably maintained in a state of being ready for meshing with the plurality of teeth 33. When the ratchet wheel 34 rotates in the drawing-out direction “P”, the meshing pawl 13 meshes with the teeth 33 again.

The arrangement member 62 (refer to FIGS. 30, 31A and 31B) moves together with the operation member 61 to thereby move the operation member 61 to the non-operation position E1 or the operation position E2. By the movement described above, the operation member 61 and the arrangement member 62 control the position of the meshing pawl 13, and also switch the state of the locking mechanism 9 and that of the retractor 1. When the arrangement member 62 moves the operation member 61 to the non-operation position E1, the meshing pawl 13 moves to the non-mesh position C1 and the clutch 50 and the locking gear 30 are uncoupled. Therefore, the state of the locking mechanism 9 is switched to the waiting state, and the state of the retractor 1 is switched to the ELR state accordingly. When the arrangement member 62 moves the operation member 61 to the operation position E2, the meshing pawl 13 moves to the mesh position C2, and the clutch 50 is coupled with the locking gear 30. Therefore, the state of the locking mechanism 9 is switched to the operation state, and the state of the retractor 1 is switched to the ALR state.

The control member 70 arranges the arrangement member 62 at the first position F1 or the second position F2, and arranges the operation member 61 at the non-operation position E1 or the operation position E2. The control member 70 rotates by interlocking with the rotation of the winding drum 10, and by the rotation, the control member 70 moves the arrangement member 62 to the first position F1 or the second position F2. The control member 70 includes the outer circumferential portion 72, the outer edge convex portion 73, a first maintaining portion 74 for maintaining the arrangement member 62 at the first position F1, a changing portion 75, a movement portion 76 for moving the arrangement member 62, a second maintaining portion 77 for maintaining the arrangement member 62 at the second position F2, and a release portion 78. The contact portion 62C of the arrangement member 62 comes into contact with each of the portions 73, 75, 76, and 77 of the control member 70.

The outer circumferential portion 72 includes an expansion portion 72A expanded outward in the radial direction of the control member 70, and covers the plurality of fixed teeth 83. The expansion portion 72A is formed in a circular-arc shape at a part of the outer circumferential portion 72. The outer edge convex portion 73 is a convex portion in a circular-arc shape formed at an edge of the expansion portion 72A, and is arranged so as to surround a part of the plurality of fixed teeth 83. The first maintaining portion 74 includes a passage 74A in a circular-arc shape formed between the plurality of fixed teeth 83 and the outer edge convex portion 73 (second maintaining portion 77). The passage 74A of the first maintaining portion 74 includes an open space between the expansion portion 72A and the mechanism cover 6A. One end portion of the passage 74A is closed with the movement portion 76, and other end portion of the passage 74A is opened at a terminal portion 79 of the second maintaining portion 77.

The contact portion 62C of the arrangement member 62 enters the passage 74A of the first maintaining portion 74 from the other end portion of the passage 74A, and relatively moves along the outer edge convex portion 73 in the passage 74A. At this time, the outer edge convex portion 73 passes through the passage portion 62G of the arrangement member 62, and the arrangement member 62 (contact portion 62C) is arranged at the first position F1 near the fixed teeth 83. When the contact portion 62C is positioned outside the passage 74A, the arrangement member 62 is arranged at the first position F1 near the fixed teeth 83, and relatively moves along the outer circumferential portion 72 of the control member 70. Therefore, the first maintaining portion 74 of the control member 70 includes the passage 74A and a peripheral portion 74B of the control member 70 positioned outside the passage 74A. The peripheral portion 74B is a peripheral open space in a circular-arc shape along the outer circumferential portion 72 of the control member 70, and is connected to the passage 74A.

The outer edge convex portion 73 includes a circular-arc portion 73A extending in a circumferential direction of the control member 70 and a leading end portion 73B connected to an end portion of the circular-arc portion 73A, and bends inward in the radial direction of the control member 70 at a portion between the circular-arc portion 73A and the leading end portion 73B. The second maintaining portion 77 includes the circular-arc portion 73A of the outer edge convex portion 73, and the movement portion 76 includes the leading end portion 73B thereof. The changing portion 75 includes the leading end portion 73B (movement portion 76) and an end portion of the circular-arc portion 73A (second maintaining portion 77) connected to the leading end portion 73B, and is positioned at a terminal portion of the first maintaining portion 74. By a slit 70A formed between the changing portion 75 and the expansion portion 72A, the changing portion 75 is separated away from the expansion portion 72A. When the changing portion 75 passes through the passage portion 62G of the arrangement member 62, the changing portion 75 is pressed by the contact portion 62C of the arrangement member 62 to thereby be elastically deformed outward in the radial direction of the control member 70 (refer to an arrow H3 illustrated in FIG. 30).

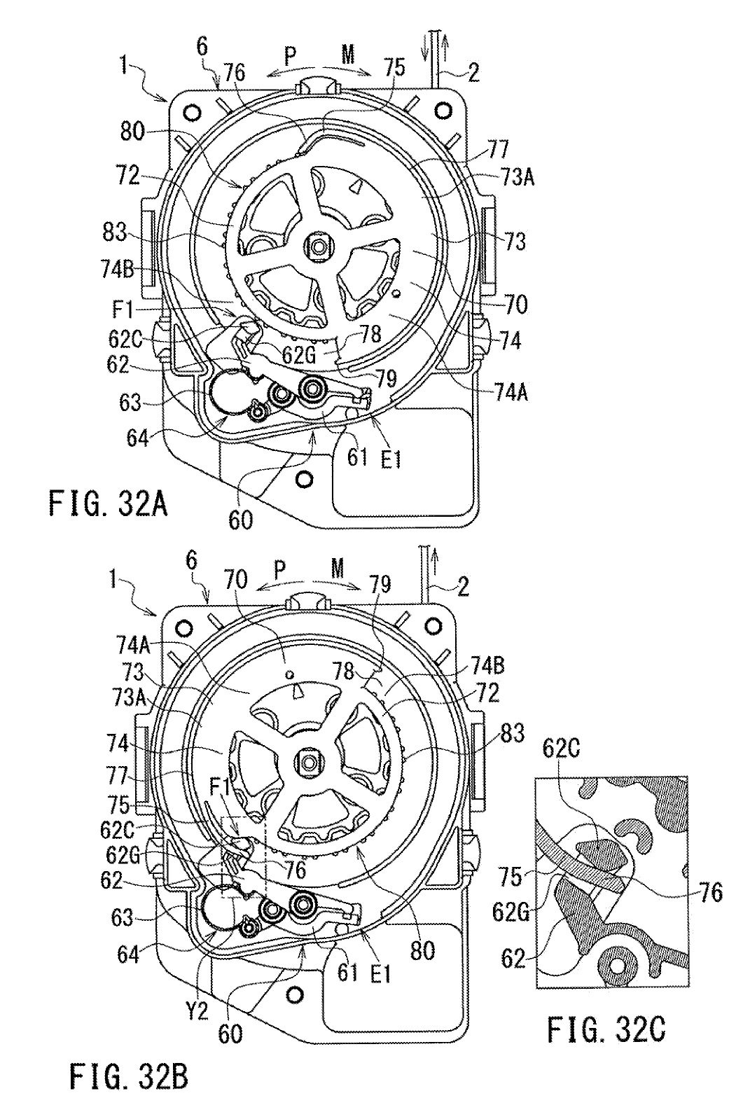

FIGS. 32A to 34B illustrate actions of the switch mechanism 60 by the rotation of the control member 70, and illustrate the retractor 1 in the same way as that in FIG. 30. FIG. 32C is a cross-sectional view schematically illustrating a Y2 portion illustrated in FIG. 32B.

As illustrated in FIGS. 32A to 34B, when the winding drum 10 is rotated in the drawing-out direction “P” or the winding direction “M” by the drawing-out and winding of the webbing 2, the control member 70 is rotated in the opposite direction of the rotational direction of the winding drum 10 by the deceleration mechanism 80. Furthermore, by the rotation of the control member 70, the arrangement member 62 relatively moves in the circumferential direction of the control member 70 and relatively moves along each of the portions 72 to 77 of the control member 70.

When the webbing 2 is completely wound onto the winding drum 10, the contact portion 62C of the arrangement member 62 is arranged at the first maintaining portion 74 (peripheral portion 74B) (refer to FIG. 32A). The arrangement member 62 is maintained at the first position F1 and the operation member 61 is maintained at the non-operation position E1 by the first maintaining portion 74. Subsequently, when the control member 70 is rotated by drawing-out of the webbing 2, the arrangement member 62 (contact portion 62C) relatively moves along the first maintaining portion 74 (passage 74A and peripheral portion 74B). Furthermore, by the drawing-out and winding of the webbing 2, the arrangement member 62 relatively moves in the circumferential direction of the control member 70 in the first maintaining portion 74. Until the webbing 2 is drawn out from the winding drum 10 by a predetermined drawing-out length, the contact portion 62C is arranged in the first maintaining portion 74, and the arrangement member 62 is maintained at the first position F1 by the first maintaining portion 74. As a result, the state of the locking mechanism 9 is maintained in the waiting state, and the state of the retractor 1 is maintained in the ELR state.

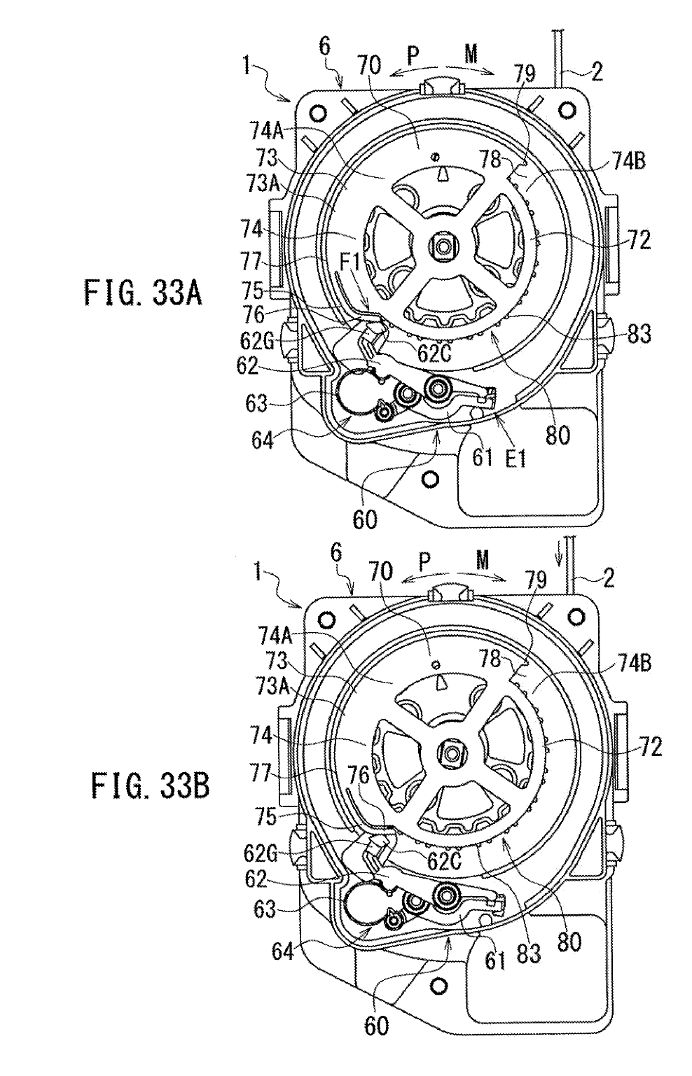

When the webbing 2 is drawn out from the winding drum 10 by the predetermined drawing-out length (refer to FIG. 32B), the arrangement member 62 is relatively displaced along the changing portion 75, and the changing portion 75 changes the position of the arrangement member 62 from the first maintaining portion 74 to a movement position by the movement portion 76. The movement position by the movement portion 76 is a position where the arrangement member 62 becomes being movable by the movement portion 76. After the arrangement member 62 moves to the movement position, the arrangement member 62 is moved by the movement portion 76. Here, by the rotation of the control member 70 when the webbing 2 is drawn out, the contact portion 62C of the arrangement member 62 approaches the changing portion 75 in the passage 74A of the first maintaining portion 74 (refer to FIG. 32C). Subsequently, the contact portion 62C comes into contact with the changing portion 75 in the passage portion 62G, to press the changing portion 75 outward in the radial direction of the control member 70. Therefore, the changing portion 75 is elastically deformed to pass through the passage portion 62G (refer to FIG. 33A).

The changing portion 75 is elastically deformed by the arrangement member 62 to change the position of the arrangement member 62 from the first maintaining portion 74 to the movement position by the movement portion 76. Further, when the changing portion 75 completely passes through the passage portion 62G, the changing portion 75 recovers into an original shape. At the same time, the movement portion 76 returns to an original position where the movement portion 76 closes the terminal portion (passage 74A) of the first maintaining portion 74, and the contact portion 62C is arranged at a position where contact with the movement portion 76 becomes possible.

The control member 70 is entirely formed of the synthetic resin, and the changing portion 75 that is a part of the control member 70 is elastically deformed by the arrangement member 62. In contrast to this, only the changing portion 75 may be formed of a component different from other part of the control member 70. In this case, the changing portion 75 is formed of the elastically deformable material (e.g., synthetic resin, or a plate made of stainless steel), and is fixed to the control member 70.

When the webbing 2 is wound onto the winding drum 10 after the webbing 2 is drawn out from the winding drum 10 by the predetermined drawing-out length, by the rotation of the control member 70, the movement portion 76 of the control member 70 moves the arrangement member 62 from the first position F1 to the second position F2 (refer to FIG. 33B). The movement portion 76 includes an inclination portion (here, inclining convex portion) that inclines toward the second maintaining portion 77, and is formed from a position near the fixed teeth 83 to the circular-arc portion 73A (second maintaining portion 77). Further, the movement portion 76 inclines from the movement position by the movement portion 76 toward the second maintaining portion 77 with respect to the rotational direction of the control member 70, and is connected to a front end portion of the second maintaining portion 77.

By the rotation of the control member 70 when the webbing 2 is wound, the arrangement member 62 comes into contact with the movement portion 76 and gradually moves along the movement portion 76, and then is guided by the movement portion 76 from the first position F1 to the second position F2. Therefore, the movement portion 76 also functions as a guide portion for guiding the arrangement member 62 from the first position F1 to the second position F2.

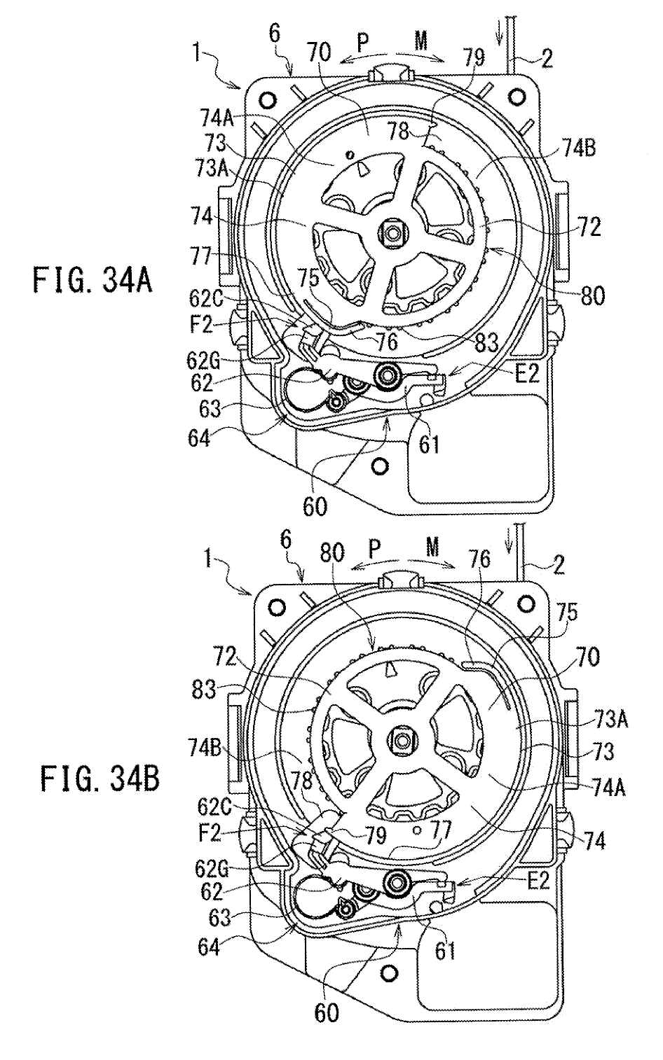

When the movement portion 76 moves the arrangement member 62, the contact portion 62C of the arrangement member 62 is guided by the movement portion 76 to move toward the second maintaining portion 77 in a state where the contact portion 62C thereof is pressed to the movement portion 76 by the urging force of the urging means 63. Therefore, the arrangement member 62 moves outward in the radial direction of the control member 70, and moves from the first position F1 to the second position F2 (refer to FIG. 34A). At the same time, the operation member 61 moves from the non-operation position E1 to the operation position E2, and the state of the locking mechanism 9 is switched from the waiting state to the operation state accordingly. As described above, when the webbing 2 is drawn out from the winding drum 10 by the predetermined drawing-out length in the ELR state, the switch mechanism 60 switches the state of the locking mechanism 9 to switch the state of the retractor 1 from the ELR state to the ALR state.

Here, when the webbing 2 is completely drawn out from the winding drum 10, the changing portion 75 changes the position of the arrangement member 62 from the first maintaining portion 74 to the movement position by the movement portion 76. Therefore, until the webbing 2 is completely drawn out from the winding drum 10, the first maintaining portion 74 maintains the arrangement member 62 at the first position F1. Further, when the webbing 2 completely drawn out from the winding drum 10 is wound onto the winding drum 10, the movement portion 76 moves the arrangement member 62. When the webbing 2 is completely drawn out from the winding drum 10, the switch mechanism 60 switches the state of the retractor 1 from the ELR state to the ALR state.

At a portion where the movement portion 76 is connected to the second maintaining portion 77, the outer edge convex portion 73 gently bends to form a curving shape. Therefore, the contact portion 62C of the arrangement member 62 smoothly moves from the movement portion 76 to the second maintaining portion 77. The contact portion 62C comes into contact with the second maintaining portion 77 and is pressed to the second maintaining portion 77 by the urging force of the urging means 63. When the second maintaining portion 77 presses the contact portion 62C, the second maintaining portion 77 holds the arrangement member 62. The second maintaining portion 77 includes the circular-arc portion 73A formed in a circular-arc shape concentric with the axis U1 of the winding drum 10, outside in a radial direction of the first maintaining portion 74, and surrounds a part of the first maintaining portion 74 (passage 74A). While the webbing 2 is wound onto the winding drum 10 after the webbing 2 is drawn out from the winding drum 10 by the predetermined drawing-out length, the arrangement member 62 comes into contact with the second maintaining portion 77, and is maintained at the second position F2 by the second maintaining portion 77. Here, while the webbing 2 completely drawn out is being wound, the arrangement member 62 is maintained at the second position F2. The second maintaining portion 77 is formed in a predetermined length along the circumferential direction of the control member 70.

When the arrangement member 62 is maintained at the second position F2, the operation member 61 is maintained at the operation position E2. The operation member 61 arranged at the operation position E2 (refer to FIG. 31B) arranges the meshing pawl 13 at the mesh position C2 to mesh with the teeth 33 of the ratchet wheel 34. In the state described above, when the webbing 2 is drawn out, the clutch 50 rotates in the drawing-out direction “P” together with the locking gear 30 and the winding drum 10, and the meshing pawl 13 separates away from the operation member 61 (refer to FIG. 22). Further, the locking mechanism 9 is operated to lock the winding drum 10.

When the webbing 2 is wound, the meshing pawl 13 once comes off the teeth 33 of the ratchet wheel 34. Subsequently, the meshing pawl 13 comes into contact with the press portion 61A of the operation member 61 to be pressed up by the press portion 61A, and the operation member 61 arranged at the operation position E2 arranges the meshing pawl 13 at the mesh position C2 again (refer to FIG. 31B). As a result, the state of the locking mechanism 9 is maintained in the operation state, and that of the retractor 1 is maintained in the ALR state accordingly. The locking mechanism 9 stops the rotation of the winding drum 10 only in the drawing-out direction “P”.

By the rotation of the control member 70 when the webbing 2 is wound (refer to FIG. 34B), the arrangement member 62 (contact portion 62C) relatively moves along the second maintaining portion 77, and also relatively moves toward the terminal portion 79 of the second maintaining portion 77 and the release portion 78 of the control member 70. Until the webbing 2 is wound onto the winding drum 10 by a predetermined winding length, the second maintaining portion 77 maintains the arrangement member 62 at the second position F2. Further, when the webbing 2 is wound onto the winding drum 10 by the predetermined winding length, the arrangement member 62 comes off the terminal portion 79 of the second maintaining portion 77 to be released toward the first maintaining portion 74 by the release portion 78. Before the webbing 2 is completely wound onto the winding drum 10, the arrangement member 62 comes off the terminal portion 79.

The contact portion 62C of the arrangement member 62 comes off the second maintaining portion 77 after reaching the terminal portion 79. Therefore, the contact portion 62C is released from the state of being pressed by the second maintaining portion 77, and the arrangement member 62 is released from the second maintaining portion 77. The release portion 78 of the control member 70 is a portion continuing to the terminal portion 79, and includes a release region formed from the second maintaining portion 77 to the first maintaining portion 74. At the release portion 78, the arrangement member 62 moves from the second maintaining portion 77 to the first maintaining portion 74 inward in the radial direction of the control member 70 without coming into contact with the control member 70.

When the webbing 2 is wound onto the winding drum 10 by the predetermined winding length and the arrangement member 62 comes off the terminal portion 79 of the second maintaining portion 77, the release portion 78 releases the arrangement member 62 from the second maintaining portion 77 toward the first maintaining portion 74 (refer to FIG. 30). By this release, the arrangement member 62 is instantly moved from the second maintaining portion 77 (second position F2) to the first maintaining portion 74 (first position F1) by the urging force of the urging means 63. At the same time, the arrangement member 62 instantly moves the operation member 61 from the operation position E2 to the non-operation position E1, and the state of the locking mechanism 9 is instantly switched from the operation state to the waiting state. As described above, the webbing 2 is wound onto the winding drum 10 by the predetermined winding length in the ALR state, and then the switch mechanism 60 switches the state of the locking mechanism 9 to instantly switch the state of the retractor 1 from the ALR state to the ELR state. Subsequently, the webbing 2 is wound onto the winding drum 10, or is drawn out from the winding drum 10.

As described above, in the retractor 1 of the first embodiment (refer to FIGS. 24, 27A and 27B), each of the plurality of transmission protrusions 87 smoothly moves in the transmission round hole 86 and always transmits the rotation of the rotational gear 82 to the control member 70. Therefore, by using the eccentric member 81 rotating together with the winding drum 10, the control member 70 controlling the state of the retractor 1 can be rotated by correctly interlocking with the rotation of the winding drum 10. Further, the switch mechanism 60 can correctly switch the state of the locking mechanism 9 and the state of the retractor 1. Since the control member 70 regularly rotates, the control member 70 can stably control the state of the locking mechanism 9 and the state of the retractor 1, and the state of the locking mechanism 9 and the state of the retractor 1 can be switched as set.

The switch mechanism 60 can control the operation of the locking mechanism 9, to thereby correctly control the state of the retractor 1. As a result, the switch mechanism 60 can correctly switch the state of the retractor 1 between a state where the webbing 2 can be wound only (the ALR state) and a state where the webbing 2 can be wound and drawn out (the ELR state).

When the track of the center Z5 of the plurality of transmission protrusions 87 is respectively shaped in a circle having a same diameter as that of the track of the axis Z1 of the rotational gear 82 (refer to FIG. 26B), each of the plurality of transmission protrusions 87 smoothly moves along the inner circumference of each transmission round hole 86 along with the movement and rotation of the rotational gear 82. Therefore, the rotation of the rotational gear 82 can be smoothly transmitted to the control member 70.

The plurality of transmission round holes 86 (refer to FIG. 23) is formed in a circular shape having the same inner diameter and is arranged with equal angular interval in the circumferential direction of the same circle concentric with the axis U3 of the rotational gear 82. Further, the plurality of transmission protrusions 87 is formed in a columnar shape having the same outer diameter and is arranged with equal angular interval in the circumferential direction of the same circle concentric with the axis U4 of the control member 70. When the plural pairs of transmission round hole 86 and transmission protrusion 87 including the transmission round holes 86 and the transmission protrusions transmit the rotation of the rotational gear 82 to the control member 70, the same maximum load is applied to the plural pairs of transmission round hole 86 and transmission protrusion 87. Further, the plurality of transmission protrusions 87 equally comes into contact with the inner circumference of the transmission round hole 86. Therefore, endurance of the plural pairs of transmission round hole 86 and transmission protrusion 87 can be improved.

By increasing the number of transmission round hole 86 and transmission protrusion 87, the switch mechanism 60 can be operated more securely. Furthermore, since the strength required for each transmission protrusion 87 can be reduced, the outer diameter of transmission protrusion 87 and the inner diameter of the transmission round hole 86 can become smaller, and the diameters of the rotational gear 82 and the control member 70 can also become smaller. When the thickness of the rotational gear 82 is reduced, the rotation of the rotational gear 82 can be securely transmitted to the control member 70. Depending on the sizes of the rotational gear 82 and the control member 70, the switch mechanism 60 and the retractor 1 can be downsized.

The winding spring unit 7 (refer to FIG. 3) may be arranged outside the pretensioner unit 5 in the drum shaft direction, and may be coupled with the winding drum 10 via the pretensioner unit 5. In this case, instead of the winding spring unit 7, the cover member is arranged outside the mechanism cover 6A in the drum shaft direction, and is mounted to the mechanism cover 6A. The cover member covers the switch mechanism 60 of the mechanism cover unit 6 to thereby regulate action of the control member 70 outside the control member 70 in the drum shaft direction.

Until the webbing 2 is drawn out from the winding drum 10 by the predetermined drawing-out length (refer to FIG. 30), the first maintaining portion 74 of the control member 70 maintains the arrangement member 62 at the first position F1. The predetermined drawing-out length of the webbing 2 can be set to be an arbitrary length. Therefore, the predetermined drawing-out length may be an entire length of the webbing 2 or a length shorter than the entire length.

The transmission round hole 86 may be a hole passing through the rotational gear 82, or may be a hole not passing through the rotational gear 82 (including a recess formed on the rotational gear 82). Further, as described above (refer to FIG. 26B), the track of the center Z5 of the plurality of transmission protrusions 87 is respectively shaped in a circle having a same diameter as that of the track of the axis Z1 of the rotational gear 82. As long as the conditions of the track of the center Z5 are satisfied, all the transmission protrusions 87 need not be formed having the same outer diameter. Further, the transmission round hole 86 may be formed having the inner diameter corresponding to the outer diameter of the transmission protrusion 87.

Due to range of the allowance set to the components, or the convenience of assembling of the components, an actual radius of the plurality of transmission protrusions 87 may become slightly smaller than the radius Z4. In this case, backlash is generated in the transmission protrusion 87 and the transmission round hole 86. In a state where the backlash is generated as described above, by including three or more pairs of transmission round hole 86 and transmission protrusion 87 in the transmission mechanism 85, three or more pairs of transmission round hole 86 and transmission protrusion 87 suppress the backlash each other, and at least one transmission protrusion 87 is pressed by the transmission portion of the transmission round hole 86. As a result, the rotation of the rotational gear 82 can be securely transmitted to the control member 70.

As described above (refer to FIG. 24), the positions of the plurality of transmission round holes 86 and those of the plurality of transmission protrusions 87 are aligned with each other in the state where the axis U3 of the rotational gear 82 and the axis U4 of the control member 70 are aligned with each other, and each of the plurality of transmission protrusions 87 is arranged in the corresponding transmission round hole 86 and moves in the transmission round hole 86. As long as the transmission mechanism 85 is operated under the conditions of the transmission round hole 86 and the transmission protrusion 87 as described above, all the transmission round holes 86 need not be positioned on the same circle concentric with the axis U3 of the rotational gear 82. Namely, all the transmission round holes 86 may be positioned on a circle different from each other, or a part of the transmission round holes 86 may be positioned on a circle different from other transmission round holes 86. Likewise, all the transmission protrusions 87 need not be positioned on the same circle concentric with the axis U4 of the control member 70. Namely, all the transmission protrusions 87 may be positioned on a circle different from each other, or a part of the transmission protrusions 87 may be positioned on a circle different from other transmission protrusions 87.

Here (refer to FIGS. 27A and 27B), the transmission mechanism 85 including four pairs of transmission round hole 86 and transmission protrusion 87 is described, the transmission mechanism 85 may include two or more pairs of transmission round hole 86 and transmission protrusion 87. Furthermore, the plural pairs of transmission round hole 86 and transmission protrusion 87 can be arranged with an arbitrary 180 degrees or less intervals.

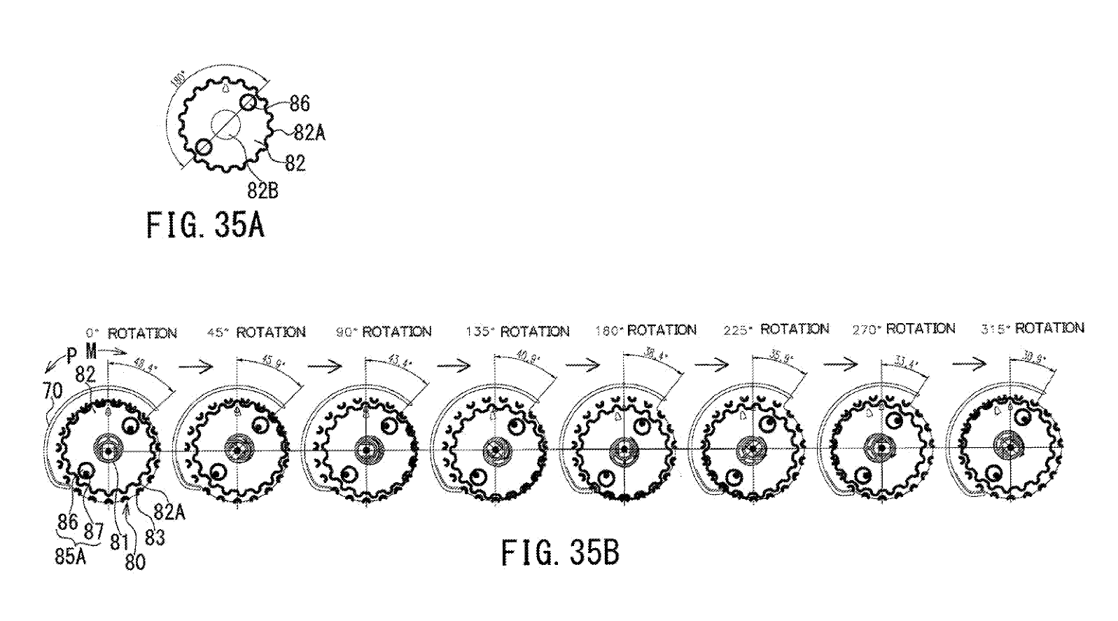

FIGS. 35A to 39B illustrate modifications of the transmission mechanism 85, and illustrate a part of the deceleration mechanism 80 and the control member 70 in the same way as that in FIGS. 27A and 27B.

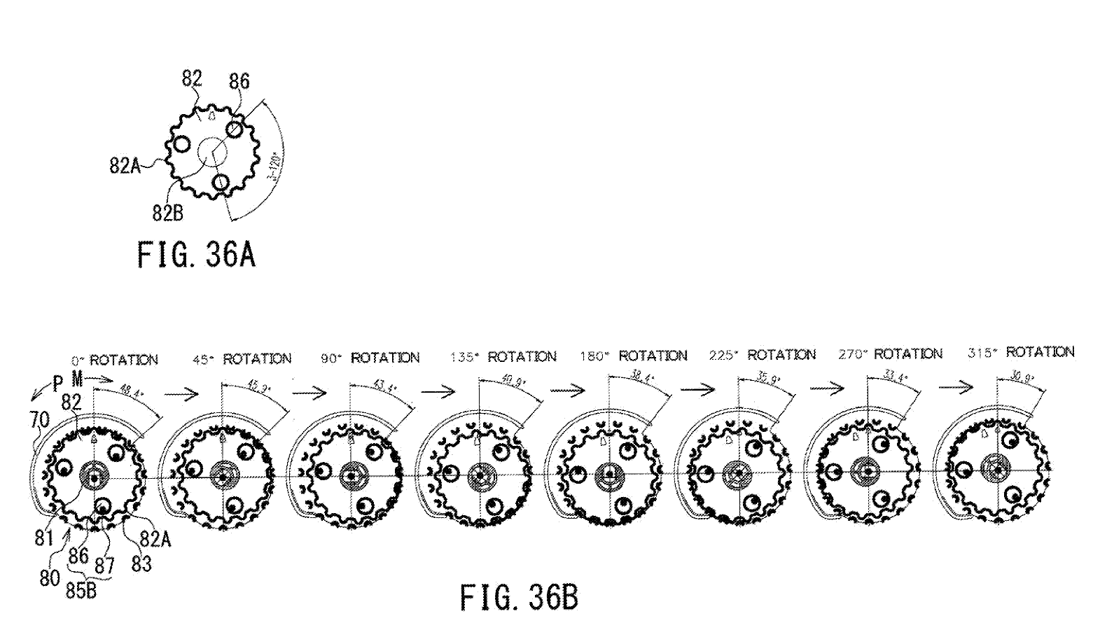

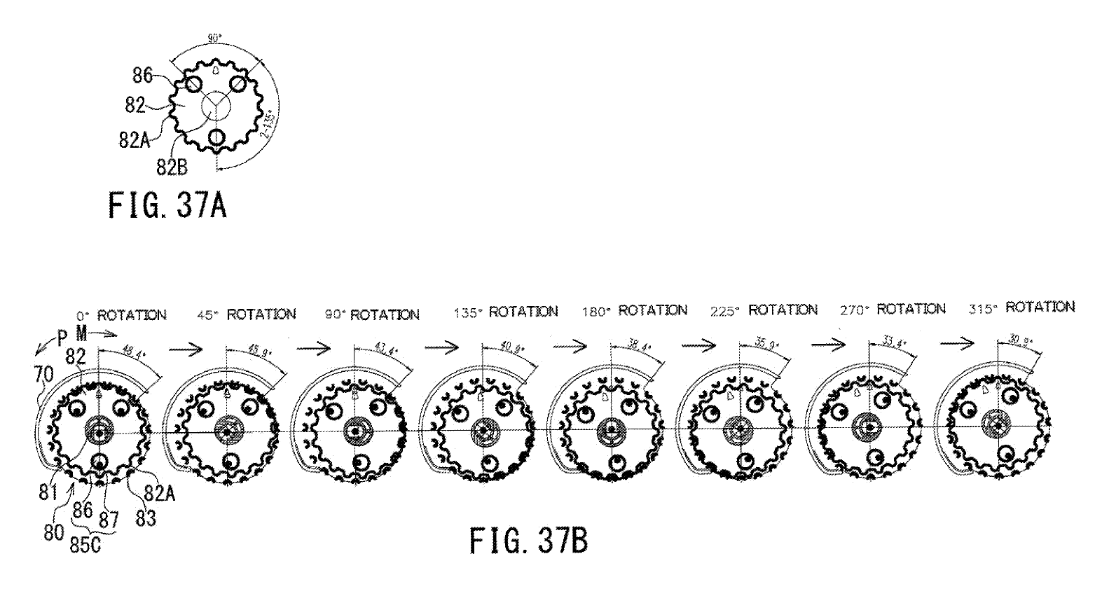

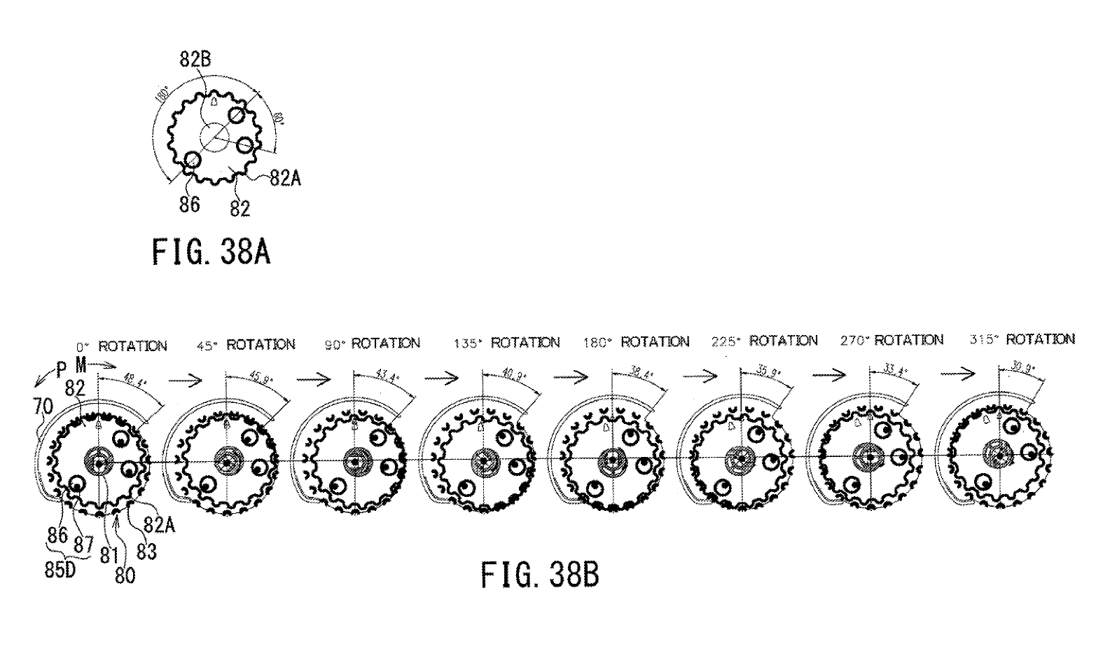

A transmission mechanism 85A illustrated in FIG. 35B includes two pairs of transmission round hole 86 and transmission protrusion 87 arranged with equal angular interval (180 degrees intervals). Transmission mechanisms 85B, 85C and 85D illustrated in FIGS. 36B to 38B include three pairs of transmission round hole 86 and transmission protrusion 87, respectively. In addition, in the transmission mechanism 85B illustrated in FIG. 36B, the three pairs of transmission round hole 86 and transmission protrusion 87 are arranged with equal angular interval (120 degrees intervals). In the transmission mechanism 85C illustrated in FIG. 37B, the three pairs of transmission round hole 86 and transmission protrusion 87 are arranged so that some of the intervals are different from one another. In the transmission mechanism 85D illustrated in FIG. 38B, the three pairs of transmission round hole 86 and transmission protrusion 87 are arranged so that all the intervals are different from one another. Since, in examples illustrated in FIGS. 35A to 38B, the plural pairs of transmission round hole 86 and transmission protrusion 87 are arranged with 180 degrees or less intervals, the transmission mechanisms 85A to 85D always transmit the rotation of the rotational gear 82 to the control member in the same way as the transmission mechanism 85 described above.

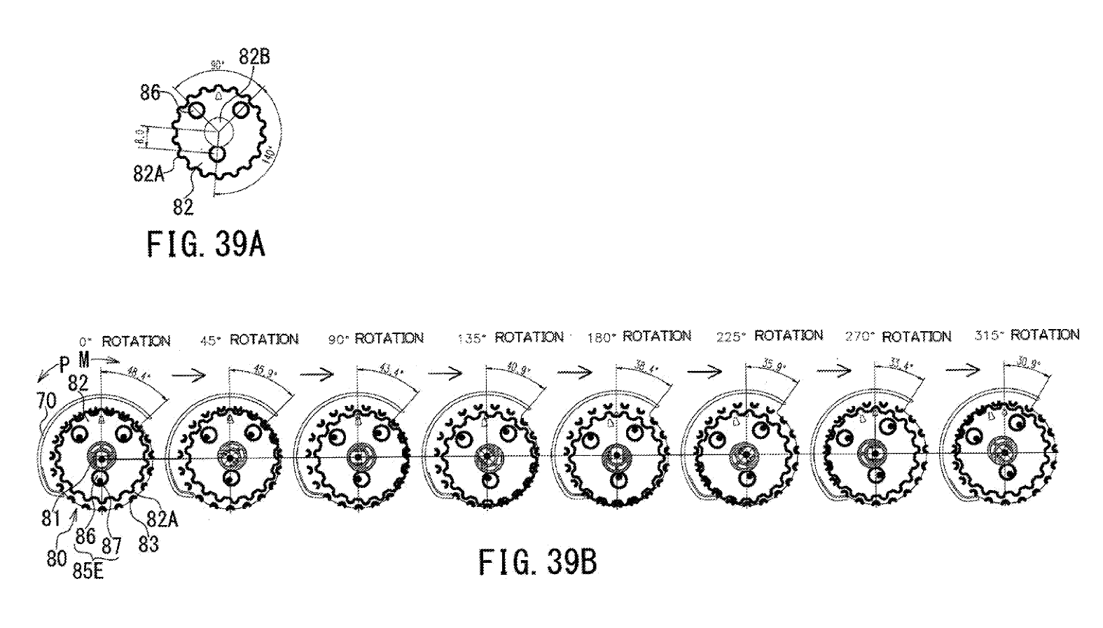

In the same way as the transmission mechanism 85C illustrated in FIG. 37B, a transmission mechanism 85E illustrated in FIG. 39B includes the plural pairs (here, three pairs) of transmission round hole 86 and transmission protrusion 87 arranged so that some of the intervals are different from one another. The plurality of transmission round holes 86 is formed in the rotational gear 82 with 180 degrees or less intervals in the circumferential direction concentric with the axis U3 of the rotational gear 82. Furthermore, the plurality of transmission protrusions 87 is formed on the control member 70 with 180 degrees or less intervals in the circumferential direction concentric with the axis U4 of the control member 70.

However, one transmission round hole 86 is formed at a position closer to the axis U3 of the rotational gear 82 than other transmission round holes 86, and one transmission protrusion 87 is formed at a position closer to the axis U4 of the control member 70 than other transmission protrusions 87. As a result, in a different manner from the transmission mechanism 85C illustrated in FIG. 37B, in the transmission mechanism 85E illustrated in FIG. 39B, one pair of transmission round hole 86 and transmission protrusion 87 is arranged at a position closer to the eccentric member 81 than other two pairs of transmission round hole 86 and transmission protrusion 87. Also in this case, in the same way as the transmission mechanism 85C illustrated in FIG. 37B, the rotation of the rotational gear 82 can be always transmitted to the control member 70 by each of the plurality of transmission protrusions 87 moving in the transmission round hole 86.

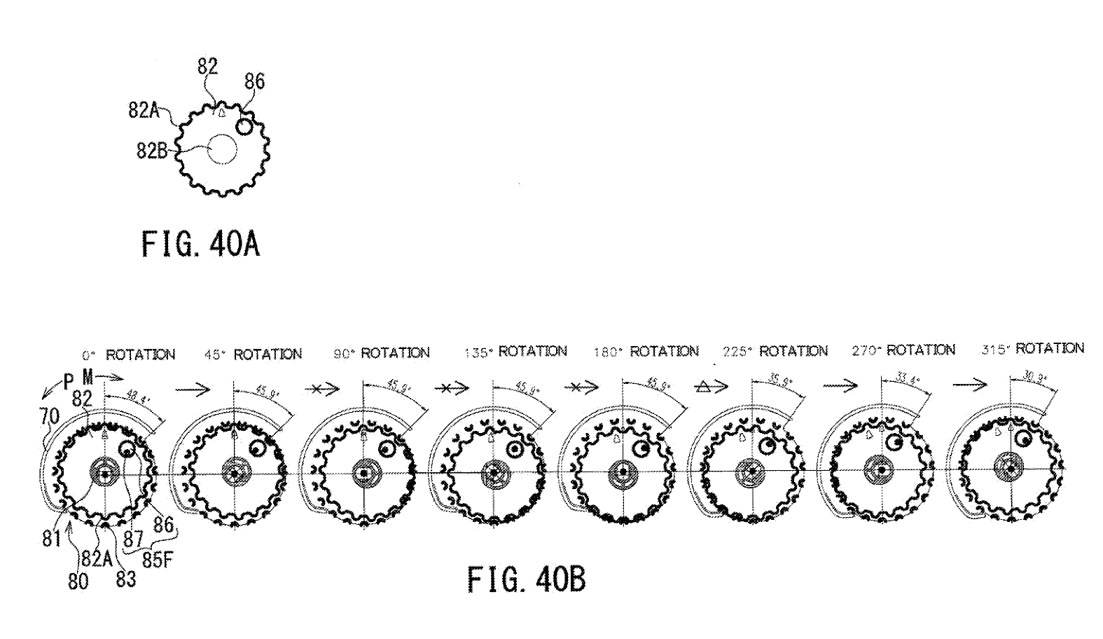

FIGS. 40A to 43B illustrate comparison examples of the transmission mechanism 85, and illustrate apart of the deceleration mechanism 80 and the control member 70 in the same way as that in FIGS. 27A and 27B.

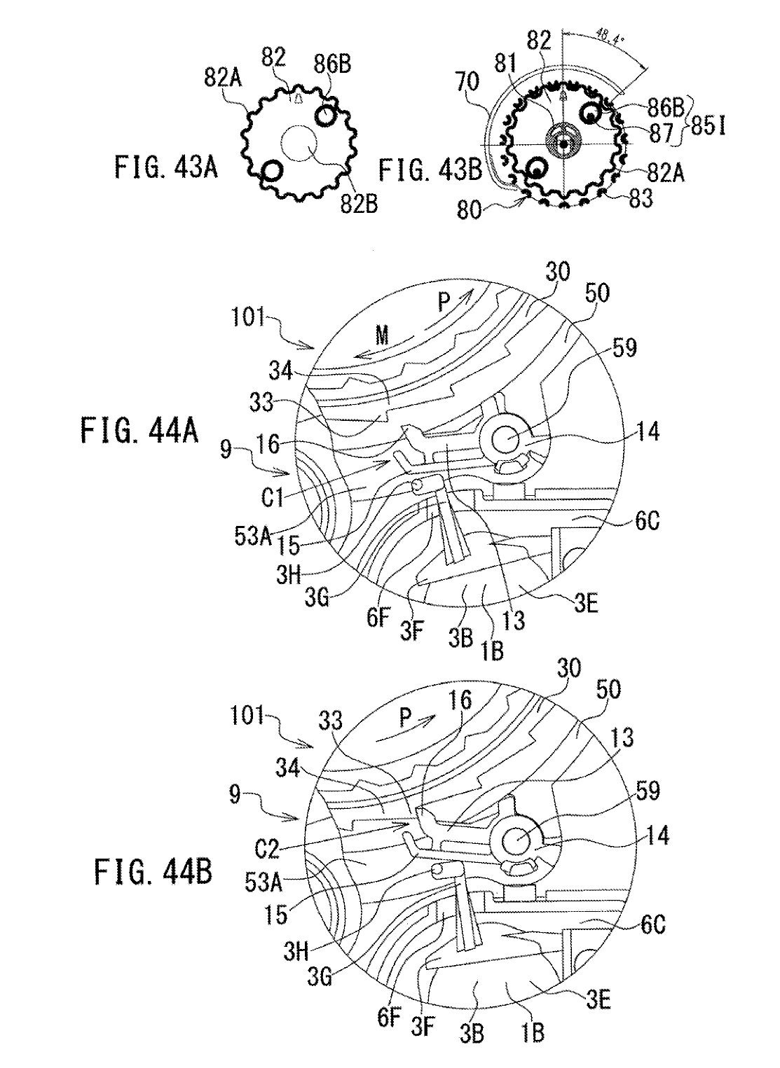

In transmission mechanisms 85F to 85H illustrated in FIGS. 40B to 42B, the rotation of the rotational gear 82 is not correctly transmitted to the control member 70 while the rotational gear 82 is rotating, and thus a transmission abnormality occurs at a position of an arrow marked with an “x” sign or a triangle sign in each drawing. Furthermore, in a transmission mechanism 85I illustrated in FIG. 43B, the rotation of the rotational gear 82 and the control member 70 is disturbed. Therefore, in the transmission mechanisms 85F to 85I, the control member 70 cannot be rotated by correctly interlocking with the rotation of the winding drum 10.

Specifically, as illustrated in FIG. 40B, the transmission mechanism 85F includes one pair of transmission round hole 86 and transmission protrusion 87. While the eccentric member 81 rotates from 45 degrees to 180 degrees in the winding direction M, the transmission protrusion 87 separates away from the inner circumference (transmission portion) of the transmission round hole 86. As a result, the transmission protrusion 87 is not pressed by the transmission portion of the transmission round hole 86, and thus the rotation of the control member 70 is stopped. Subsequently, while the eccentric member 81 rotates from 180 degrees to 225 degrees in the winding direction M, the control member 70 rotates by 10 degrees including an angle under suspension in the drawing-out direction P.

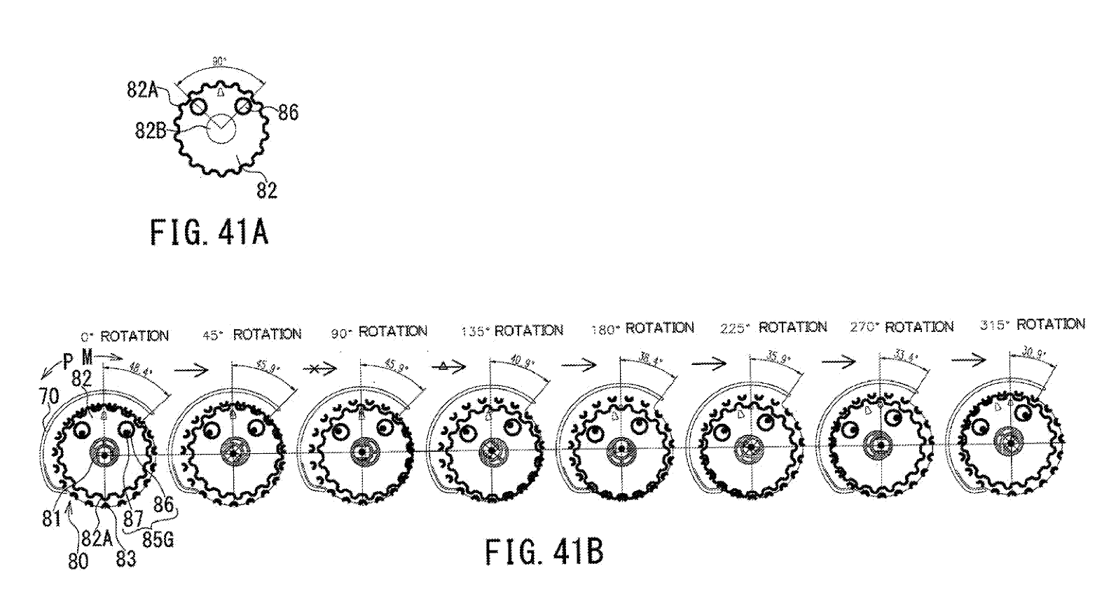

As illustrated in FIG. 41B, the transmission mechanism 85G includes two pairs of transmission round hole 86 and transmission protrusion 87 arranged with interval larger than 180 degrees. While the eccentric member 81 rotates from 45 degrees to 90 degrees in the winding direction M, the transmission protrusion 87 separates away from the inner circumference of the transmission round hole 86. As a result, the transmission protrusion 87 is not pressed by the transmission portion of the transmission round hole 86, and thus the rotation of the control member 70 is stopped. Subsequently, while the eccentric member 81 rotates from 90 degrees to 135 degrees in the winding direction M, the control member 70 rotates by 5 degrees including an angle under suspension in the drawing-out direction P.

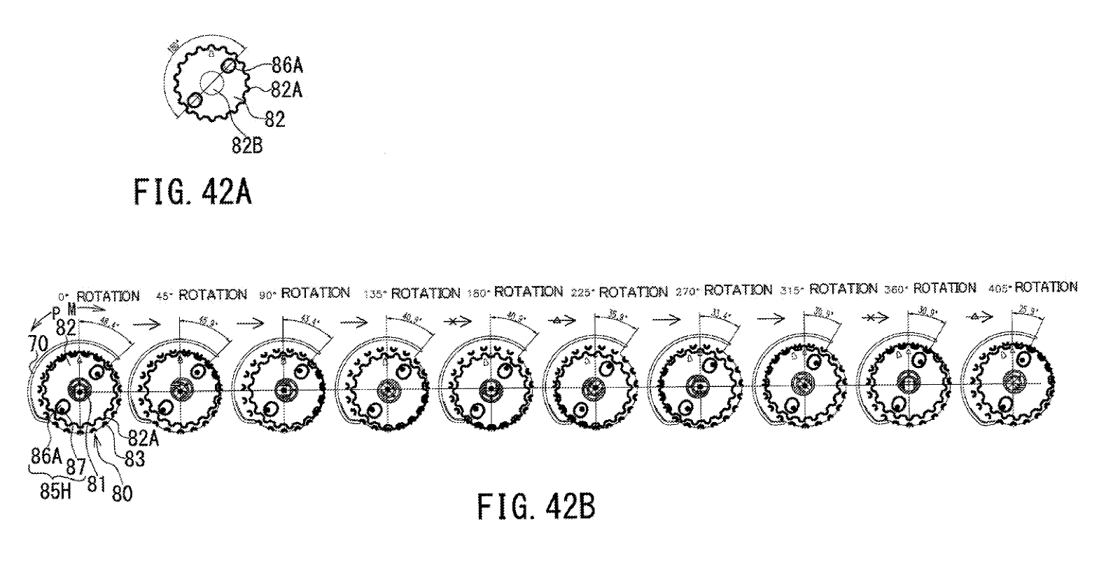

As illustrated in FIG. 42B, the transmission mechanism 85H includes two pairs of transmission hole 86A and transmission protrusion 87 arranged with equal angular interval (180 degrees intervals). The transmission hole 86A is formed in a rectangle having round corners, and includes two semicircle portions and two straight line portions. An inner diameter of a semicircle portion of the transmission hole 86A has the same dimension as that of the inner diameter of the transmission round hole 86 illustrated in FIGS. 27A and 27B. While the eccentric member 81 rotates from 135 degrees to 180 degrees in the winding direction M, and while the eccentric member 81 rotates from 315 degrees to 360 degrees in the winding direction M, the transmission protrusion 87 separates away from the inner circumference of the transmission hole 86A. As a result, the transmission protrusion 87 is not pressed by the transmission portion of the transmission hole 86A, and thus the rotation of the control member 70 is stopped. Furthermore, while the eccentric member 81 rotates from 180 degrees to 225 degrees in the winding direction M, and while the eccentric member 81 rotates from 360 degrees to 405 degrees in the winding direction M, the control member 70 rotates by 5 degrees including an angle under suspension in the drawing-out direction P.

As illustrated in FIG. 43B, the transmission mechanism 85I includes two pairs of transmission hole 86B and transmission protrusion 87 arranged with equal angular interval (180 degrees intervals). The transmission hole 86B is formed in an oval shape. A long diameter of the transmission hole 86B has the same dimension as that of a diameter of the transmission round hole 86 illustrated in FIGS. 27A and 27B, and a short diameter of the transmission hole 86B has a dimension smaller than that of the diameter of the transmission round hole 86 illustrated in FIGS. 27A and 27B. In the transmission mechanism 85I, when the deceleration mechanism 80 is assembled, each of two transmission protrusions 87 comes into contact with the inner circumference of the transmission hole 86B so as to disturb a movement of the rotational gear 82. The rotation of the rotational gear 82 and the control member 70 is disturbed by the two pairs of transmission hole 86B and transmission protrusion 87.

In the retractor 1 of the first embodiment (refer to FIG. 24), the transmission round hole 86 is formed in the rotational gear 82, and the transmission protrusion 87 is formed on the control member 70. On the other hand, the transmission round hole 86 may not be formed in the rotational gear 82 but may be formed in the control member 70. In this case, the plurality of transmission round holes 86 is formed in the control member 70 with 180 degrees or less intervals in the circumferential direction concentric with the axis U4 of the control member 70. Furthermore, the plurality of transmission protrusions 87 is formed on the rotational gear 82 with 180 degrees or less intervals in the circumferential direction concentric with the axis U3 of the rotational gear 82. The plurality of transmission round holes 86 and the plurality of transmission protrusions 87 are formed so as to satisfy conditions of the transmission round hole 86 and the transmission protrusion 87 described above.

When the rotational gear 82 rotates, each of the plurality of transmission protrusions 87 smoothly moves in the transmission round hole 86. At this time, at least one of the plurality of transmission protrusions 87 is maintained in a state of being in contact with the inner circumference (transmission portion) of the transmission round hole 86. In addition, the plurality of transmission protrusions 87 presses the inner circumference of the transmission round hole 86 while moving along and being in contact with the inner circumference of the transmission round hole 86, to thereby always transmit the rotation of the rotational gear 82 to the control member 70. While the rotational gear 82 is rotating, the inner circumference of the transmission round hole 86 is pressed in the rotational direction of the rotational gear 82 by the transmission protrusion 87 with a half portion (range of 180 degrees) (transmission portion) positioned forward in the rotational direction of the rotational gear 82.

As described above, the plurality of transmission round holes 86 is formed in one of the rotational gear 82 and the control member 70 with 180 degrees or less intervals in the circumferential direction concentric with the axis of one of the rotational gear 82 and the control member 70. On the other hand, the plurality of transmission protrusions 87 is formed on the other of the rotational gear 82 and the control member 70 with 180 degrees or less intervals in the circumferential direction concentric with the axis of the other of the rotational gear 82 and the control member 70, and when the rotational gear 82 rotates, each of the plurality of transmission protrusions 87 moves in the transmission round hole 86. In the transmission mechanism 85, the inner circumference of the transmission round hole 86 and the outer circumference of the transmission protrusion 87 come into contact with each other to thereby transmit the rotation of the rotational gear 82 to the control member 70.

### Second Embodiment

Next, a retractor of a second embodiment, which is partly different from the retractor 1 of the first embodiment, will be described. Basically, the retractor of the second embodiment is formed in the same way as the retractor 1 of the first embodiment, and exerts an effect similar to that of the retractor 1 of the first embodiment. Therefore, hereinafter, items different from the items that has been already described will be described, and the items that has been already described will be omitted. Furthermore, since differences between the retractor of the first embodiment and that of the second embodiment are only the switch mechanism 60 and the acceleration sensor 3B (first acceleration detection mechanism 1B), only the switch mechanism 60 and the acceleration sensor 3B will be described as to the retractor of the second embodiment.

In the case where the retractor is mounted to a backrest of the seat, and when the backrest is reclined, the retractor may be leaned to thereby move the inertia mass body 3E of the acceleration sensor 3B (refer to FIGS. 21A and 21B). By the movement described above, in the same way as in the case where the acceleration sensor 3B detects the acceleration of the vehicle, the locking mechanism 9 is operated by the acceleration sensor 3B, and then the webbing 2 cannot be drawn from the retractor. At this time, when the seat belt is mounted to the seat where nobody sits, the backrest is fixed by the webbing 2 and is prevented from being brought up. In the retractor of the second embodiment, the control member 70 of the switch mechanism 60 controls the operation of the locking mechanism 9 caused by the acceleration sensor 3B to thereby prevent the backrest from being fixed by the webbing 2.

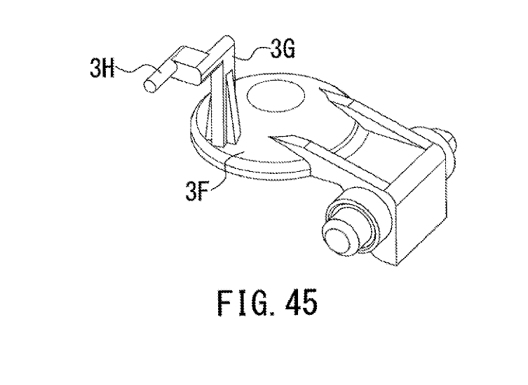

FIGS. 44A and 44B illustrate the acceleration sensor 3B provided in a retractor 101 of the second embodiment, and in the same way as that in FIGS. 21A and 21B, a part of the acceleration sensor 3B and the periphery of the meshing pawl 13 are illustrated. FIG. 45 is a perspective view of the sensor lever 3F of the acceleration sensor 3B.

As illustrated in FIGS. 44A and 44B, in the same way as the retractor 1 of the first embodiment, when the acceleration sensor 3B detects the acceleration of the vehicle, the inertia mass body 3E moves to thereby move the sensor lever 3F and the lock claw 3G upward (refer to FIG. 44B). The meshing pawl 13 is pressed upward by the lock claw 3G to thereby move from the non-mesh position C1 to the mesh position C2. With this movement, the meshing pawl 13 meshes with the teeth 33 of the ratchet wheel 34 to thereby operate the locking mechanism 9.

Furthermore, the acceleration sensor 3B includes a restricting portion 3H at a leading end of the lock claw 3G. The restricting portion 3H restricts an operation of the acceleration sensor 3B to maintain the acceleration sensor 3B in a state where the acceleration sensor 3B does not operate the locking mechanism 9 (non-operation state) (refer to FIG. 44A). In the non-operation state, the lock claw 3G is arranged at a position away from the meshing pawl 13 (below the meshing pawl 13), and the meshing pawl 13 is arranged at the non-mesh position C1. The restricting portion 3H protrudes toward the mechanism cover 6A (refer to FIGS. 13 and 14) from the lock claw 3G to thereby penetrate through the mechanism cover 6A.

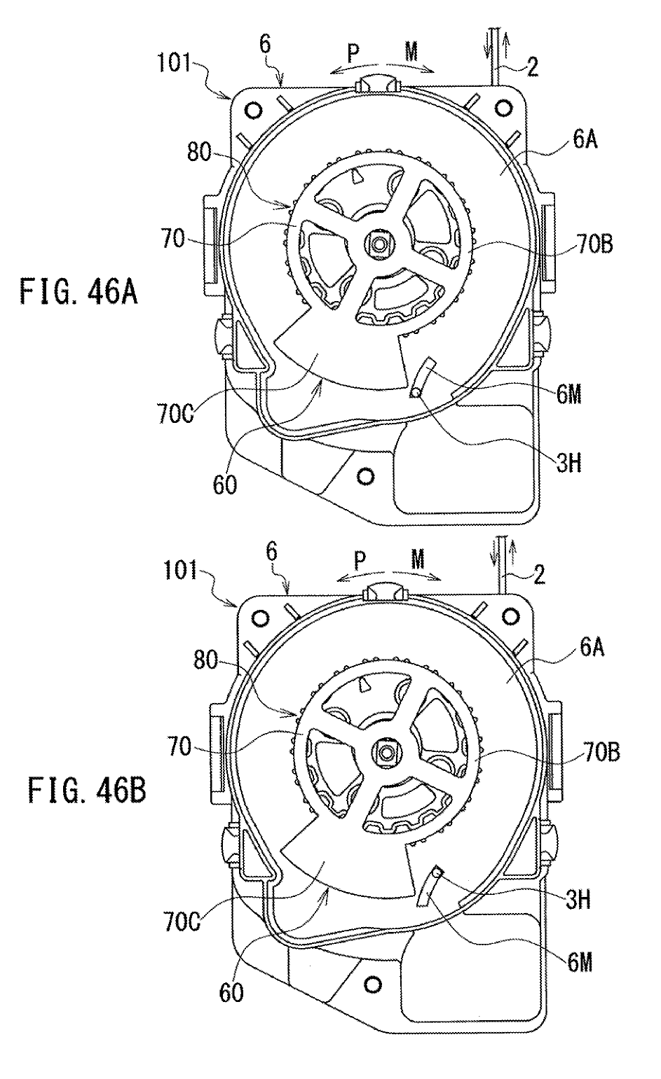

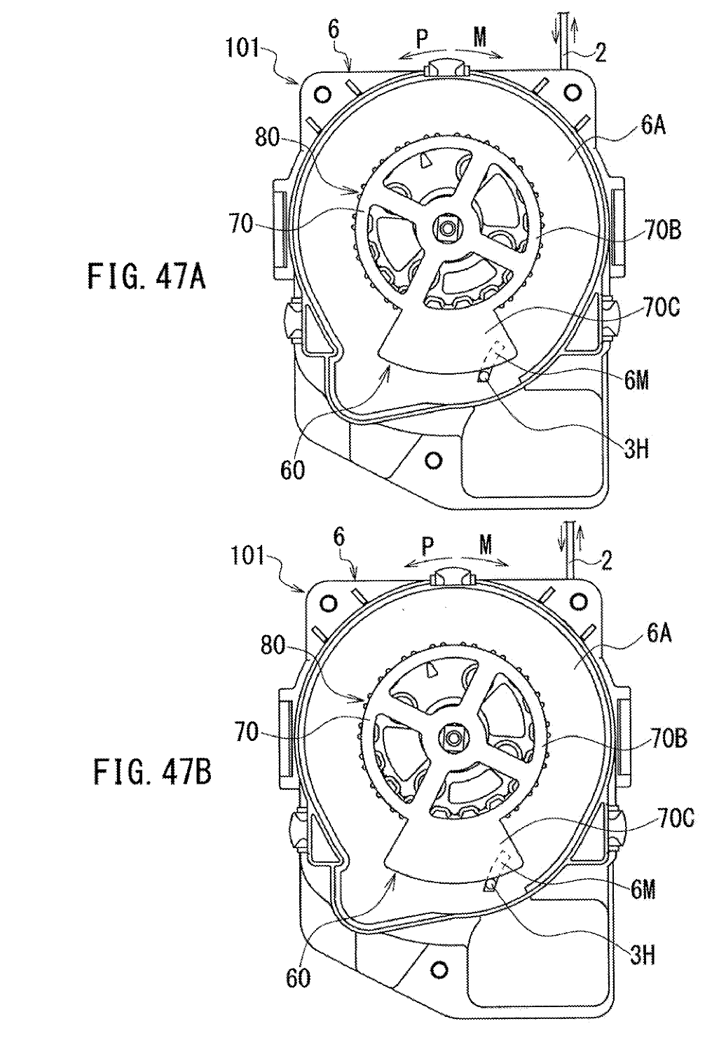

FIGS. 46A to 47B are side views of the mechanism cover unit 6, and in the same way as that in FIG. 30, the mechanism cover 6A and the switch mechanism 60 are illustrated.

As illustrated in FIGS. 46A to 47B, the restricting portion 3H of the acceleration sensor 3B is inserted into a through opening 6M formed in the mechanism cover 6A, and moves in the through opening 6M. When the acceleration sensor 3B does not operate the locking mechanism 9, the restricting portion 3H is positioned at a lower end portion of the through opening 6M (refer to FIG. 46A). Furthermore, when the acceleration sensor 3B detects the acceleration of the vehicle, in the through opening 6M, the restricting portion 3H moves upward up to an upper end portion of the through opening 6M by the upward movement of the sensor lever 3F and the lock claw 3G (refer to FIG. 46B). By this movement, the locking mechanism 9 is operated.

The switch mechanism 60 includes the deceleration mechanism 80 and the control member 70. In the same way as that in the first embodiment, the deceleration mechanism 80 rotates the control member 70 at a decelerated speed than that of the winding drum 10. The control member 70 includes a circular portion 70B and a stop portion 70C in a fan-like shape for stopping the restricting portion 3H. The stop portion 70C protrudes outward in the radial direction of the control member 70 from the circular portion 70B, and the control member 70 rotates to move the stop portion 70C to an opening position and a closing position. At the opening position (refer to FIGS. 46A and 46B), the stop portion 70C does not overlap with an entire through opening 6M to thereby open the entire through opening 6M. At the closing position (FIGS. 47A and 47B), the stop portion 70C overlaps with a predetermined portion (portion except for the lower end portion) of the through opening 6M to thereby close the predetermined portion thereof. The restricting portion 3H protrudes from the through opening 6M up to a position where the restricting portion 3H comes into contact with the stop portion 70C.

When the restricting portion 3H is positioned at the lower end position of the through opening 6M, the control member 70 rotates to move the stop portion 70C from the opening position to the closing position (refer to FIGS. 47A and 47B). While the stop portion 70C is at the closing position, the restricting portion 3H is in contact with the stop portion 70C, and thus the restricting portion 3H is prevented from moving upward and the restricting portion 3H is stopped by the stop portion 70C. As a result, the restricting portion 3H restricts the operation of the acceleration sensor 3B to thereby maintain the acceleration sensor 3B in the non-operation state (refer to FIG. 44A). Furthermore, a state of the retractor 101 is maintained in a blocking state where the operation of the locking mechanism 9 caused by the acceleration sensor 3B is blocked.

The control member 70 rotates to move the stop portion 70C from the closing position to the opening position (refer to FIGS. 46A and 46B). While the stop portion 70C is at the opening position, the restricting portion 3H freely moves in the through opening 6M without being in contact with the stop portion 70C. As a result, the restricting portion 3H does not restrict the operation of the acceleration sensor 3B, and when the vehicle encounters an emergency, the acceleration sensor 3B operates the locking mechanism 9 (refer to FIGS. 46B, 44B). Furthermore, the state of the retractor 101 is maintained in the ELR state where the locking mechanism 9 is operated by the acceleration sensor 3B. As described above, the switch mechanism 60 controls the state of the retractor 101 by the rotating control member 70 to thereby switch the state thereof between the ELR state and the blocking state.

When the winding of the webbing 2 onto the winding drum 10 has been completed, the stop portion 70C is arranged at the closing position, and the state of the retractor 101 is in the blocking state. From the state described above, when the webbing 2 is drawn out from the winding drum 10 by the predetermined drawing-out length, the stop portion 70C moves to the opening position and the switch mechanism 60 switches the state of the retractor 101 from the blocking state to the ELR state. Therefore, when the occupant wears the seat belt, the state of the retractor 101 is switched to the ELR state.

When the webbing 2 is wound onto the winding drum 10 in the ELR state, the switch mechanism 60 switches the state of the retractor 101 from the ELR state to the blocking state. Namely, while the webbing 2 is being wound onto the winding drum 10, the switch mechanism 60 switches the state of the retractor 101 from the ELR state to the blocking state. Therefore, even when the backrest is reclined, the acceleration sensor 3B does not operate the locking mechanism 9, to thereby prevent the backrest from being fixed by the webbing 2 as described above. Furthermore, until the drawing-out length of the webbing 2 drawn out from the winding drum 10 becomes the predetermined drawing-out length, the state of the retractor 101 is maintained in the blocking state.

Also in performing a switch action by the switch mechanism 60 as described above, in the same way as that in the first embodiment, the control member 70 can be rotated by correctly interlocking with the rotation of the winding drum 10, by using the eccentric member 81. Therefore, the switch mechanism 60 can correctly switch the state of the retractor 101. Note that the switch mechanism 60 of the first embodiment and that of the second embodiment may be combined with each other, and in this case, one control member 70 (or two control members 70) switches the state of the retractor to the ELR state, the ALR state, and the blocking state.

### REFERENCE SYMBOLS

1 retractor
1A support body
1B first acceleration detection mechanism
1C second acceleration detection mechanism
2 webbing
3 housing unit
3A protector
3B acceleration sensor
3C sensor cover
4 winding drum unit
5 pretensioner unit
6 mechanism cover unit
6A mechanism cover
6B first housing portion
6C second housing portion
6D drum support portion
6E insertion hole
6F opening
6G fixed protrusion
6H outside face
6I first rotational shaft
6J second rotational shaft
6K through opening
6L stopper
7 winding spring unit
8 ratchet gear
8A ratchet teeth
9 locking mechanism
9A movable pawl
10 winding drum
11 torsion bar
12 wire
13 meshing pawl
14 mounting portion
15 reception portion
16 mesh tooth
20 housing
21 back-plate portion
22 first side wall portion
23 second side wall portion
24 fixed plate
25 bracket
26 first opening portion
26A pawl housing portion
27 second opening portion
30 locking gear
31 shaft hole
32 gear shaft portion
33 teeth
34 ratchet wheel
35 arm support portion
36 support pin
37 stopper
40 locking arm
41, 42 end portion
43 through hole
45 sensor spring
50 clutch
51 inner wall
52 clutch gear
53 outer wall
54 center hole
55 elastically-deforming portion
56 movable protrusion
57 guide portion
58 guide hole
59 pawl support portion
60 switch mechanism
61 operation member
62 arrangement member
63 urging means
64 displacement mechanism
65 rotation means
70 control member
71 center hole
72 outer circumferential portion
73 outer edge convex portion
74 first maintaining portion
75 changing portion
76 movement portion
77 second maintaining portion
78 release portion
79 terminal portion
80 deceleration mechanism
81 eccentric member
82 rotational gear
83 fixed teeth
84 fixed gear
85 transmission mechanism
86 transmission round hole
87 transmission protrusion
101 retractor
M winding direction
P drawing-out direction

1. A seat belt retractor comprising:
a winding drum configured to wind a webbing;
a support body configured to rotatably support the winding drum in a winding direction and a drawing-out direction of the webbing;
a control member configured to rotate relative to the winding drum about an axis of the winding drum; and
a deceleration mechanism configured to transmit rotation of the winding drum to the control member so as to rotate the control member at a decelerated speed than that of the winding drum,
wherein the deceleration mechanism includes:
an eccentric member configured to rotate eccentrically together with the winding drum;
a plurality of fixed teeth arranged in a circular shape concentric with the axis of the winding drum and fixed to the support body;
a rotational gear provided inside of the plurality of fixed teeth and configured to rotate at a decelerated speed than that of the winding drum by the eccentric member and the plurality of fixed teeth; and
a transmission mechanism configured to transmit rotation of the rotational gear to the control member,
wherein the rotational gear includes outer circumferential teeth having a smaller number of teeth than that of the plurality of fixed teeth, and is rotatably supported by the eccentric member in a state where a rotational center of the rotational gear is eccentric with respect to the axis of the winding drum, and sequentially meshes with each of the fixed teeth and rotates, while being moved along the plurality of fixed teeth by rotation of the eccentric member, and
the transmission mechanism includes:
a plurality of transmission round holes formed in one of the rotational gear and the control member with 180 degrees or less intervals in a circumferential direction thereof, and a plurality of transmission protrusions in a post-like shape formed on the other of the rotational gear and the control member with 180 degrees or less intervals in a circumferential direction thereof, and respectively moving in the transmission round hole when the rotational gear rotates, and
an inner circumference of the transmission round hole and an outer circumference of the transmission protrusion come into contact with each other to transmit the rotation of the rotational gear to the control member.

2. The seat belt retractor according to claim 1,
wherein positions of the plurality of transmission round holes and positions of the plurality of transmission protrusions are aligned with each other in a state where the axis of the rotational gear and the axis of the control member are aligned with each other; and
wherein each of the plurality of transmission protrusions is arranged in the transmission round hole and moves therein.

3. The seat belt retractor according to claim 1,
wherein a track of a center of the transmission protrusion moving while being in contact with the inner circumference of the transmission round hole is shaped in a circle having a same diameter as that of a circular track of the axis of the rotational gear moving along the plurality of fixed teeth.

4. The seat belt retractor according to claim 1,
wherein the plurality of transmission round holes has a same inner diameter, and is arranged with equal angular interval in a circumferential direction of a same circle concentric with the axis of the one of the rotational gear and the control member; and
wherein the plurality of transmission protrusions is formed in a columnar shape having a same outer diameter and is arranged with equal angular interval in a circumferential direction of a same circle concentric with the axis of the other of the rotational gear and the control member.

5. The seat belt retractor according to claim 1, further comprising:
a locking mechanism configured to stop the rotation of the winding drum in the drawing-out direction;
an acceleration detection mechanism configured to, when a vehicle encounters an emergency, detect an acceleration of the vehicle or an acceleration of the drawing-out of the webbing drawn out from the winding drum to operate the locking mechanism; and
switching means configured to control a state of the retractor by rotation of the control member to thereby switch the state of the retractor between an emergency locking retractor state where the locking mechanism is operated by the acceleration detection mechanism and an automatic locking retractor state where the locking mechanism is constantly operated.

6. The seat belt retractor according to claim 5,
wherein the control member is configured to rotate corresponding to a drawing-out length of the webbing drawn out from the winding drum, and a winding length of the webbing wound onto the winding drum to thereby control the state of the retractor; and
wherein the switching means is configured to switch the state of the retractor from the emergency locking retractor state to the automatic locking retractor state when the webbing is drawn out from the winding drum by a predetermined drawing-out length, and switch the state of the retractor from the automatic locking retractor state to the emergency locking retractor state when the webbing is wound onto the winding drum by a predetermined winding length in the automatic locking retractor state.

7. The seat belt retractor according to claim 1, further comprising:
a locking mechanism configured to stop the rotation of the winding drum in the drawing-out direction;
an acceleration detection mechanism configured to, when a vehicle encounters an emergency, detect an acceleration of the vehicle to thereby operate the locking mechanism;
switching means configured to control a state of the retractor by rotation of the control member to thereby switch the state of the retractor between an emergency locking retractor state where the locking mechanism is operated by the acceleration detection mechanism and a blocking state where an operation of the locking mechanism caused by the acceleration detection mechanism is blocked.

8. The seat belt retractor according to claim 7,
wherein the control member is configured to rotate corresponding to a drawing-out length of the webbing drawn out from the winding drum, and a winding length of the webbing wound onto the winding drum to thereby control the state of the retractor; and
wherein the switching means is configured to switch the state of the retractor from the blocking state to the emergency locking retractor state when the webbing is drawn out from the winding drum by a predetermined drawing-out length, and switch the state of the retractor from the emergency locking retractor state to the blocking state when the webbing is wound onto the winding drum in the emergency locking retractor state.
